(19) United States
(12) Patent Application Publication
(10) Pub. No.: US 2025/0326685 A1
(43) Pub. Date: Oct. 23, 2025

(54) UNIFORM OPTICAL COATINGS DISPOSED ON 3D SUBSTRATES

(71) Applicant: CORNING INCORPORATED, CORNING, NY (US)

(72) Inventors: Ming-Huang Huang, Ithaca, NY (US); Jin Sung Jeon, Asan-si (KR); Chang-gyu Kim, Suwon-si (KR); Hoon Kim, Seongnam-Si (KR); Carlo Anthony Kosik Williams, Painted Post, NY (US); Changweon Song, Asan-si (KR)

(21) Appl. No.: 19/177,309

(22) Filed: Apr. 11, 2025

Related U.S. Application Data
(60) Provisional application No. 63/636,259, filed on Apr. 19, 2024.

(51) Int. Cl. C03C 17/36; C03C 17/09; C03C 17/245; C03C 17/34

(52) U.S. Cl. CPC C03C 17/3657; C03C 17/09; C03C 17/245; C03C 17/3417; C03C 2217/213; C03C 2217/214; C03C 2217/22; C03C 2217/734

(57) ABSTRACT

A coated article, comprising: a substrate having a major surface, the major surface comprising a first portion and a second portion, wherein a first axis that is normal to the first portion of the major surface is not equal to a second axis that is normal to the second portion of the major surface, and the angle between the first axis and the second axis is at least 40 degrees; and an optical coating disposed on at least the first portion and the second portion of the major surface; wherein the optical coating at the first and second portions has at least one of: a physical thickness uniformity of less than 10%, single side light reflectances of less than 1% at all wavelengths between 500 nm and 800 nm; and a hardness of at least 7 GPa at indentation depths of 50-250 nm.

### CROSS-REFERENCE TO RELATED APPLICATION

This application claims the benefit of priority under 35 U.S.C. § 119 of U.S. Provisional Application Ser. No. 63/636,259 filed on Apr. 19, 2024, the content of which is relied upon and incorporated herein by reference in its entirety.

### FIELD

The disclosure relates generally to coated articles, and more particularly to optical coatings disposed on three-dimensional (3D) substrates.

### BACKGROUND

Cover articles are often used to protect sensitive components within electronic products, to provide a user interface for input and/or display, and/or many other functions. Such electronic products include mobile devices, such as smart phones, MP3 players, and computer tablets. Cover articles also include architectural articles, transportation articles (e.g., articles used in automotive applications, trains, aircraft, sea craft, etc.), appliance articles, or any article that requires some transparency, scratch-resistance, abrasion resistance, or any combination thereof.

Disposing an optical coating on a cover article can be desirable so as to reduce glare or to provide other desired optical features. While many such cover articles can be flat, there may be aesthetic, functional, or other reasons that favor the production of a cover article having a 3D shape (e.g., non-planar, curved, etc.). Disposing an optical coating on such 3D substrates presents various challenges, including difficulty in producing a uniform optical coating while still achieving desired mechanical and optical properties. If the optical coating has a variation in thickness across the surface of the 3D substrate, for example, the optical and/or mechanical properties of the optical coating will not be uniform across the surface, leading to undesired optical and/or mechanical abnormalities that are unacceptable in cover articles for electronic products.

Thus there exists a need in the art for improved optical coatings on non-planar substrates. This disclosure is directed towards these, as well as other, goals.

### SUMMARY

The disclosure relates, in various aspects, to a coated article, comprising:

a substrate having a major surface, the major surface comprising a first portion and a second portion, wherein a first axis that is normal to the first portion of the major surface is not equal to a second axis that is normal to the second portion of the major surface, and the angle between the first axis and the second axis is at least 40 degrees; and an optical coating disposed on at least the first portion and the second portion of the major surface, the optical coating having an inner surface facing the substrate and an outer surface opposite the inner surface;

wherein:

the optical coating at the first and second portions has a physical thickness uniformity of less than 10%, the physical thickness uniformity calculated as [t_max−t_min)/(t_max+t_min)]×100, wherein t_max is a maximum physical thickness of the optical coating measured at the first and second portions along the first and second axes, respectively, and t_min is a minimum physical thickness of the optical coating measured at the first and second portions along the first and second axes, respectively;

the coated article at the first and second portions has a first single side light reflectance and a second single side light reflectance, respectively, as measured from the outer surface of the optical coating at an incident angle of 5 degrees relative to the first and second axes, respectively, that are less than 1% at all wavelengths between 500 nm and 800 nm; and the coated article at at least one of the first and second portions has a hardness of at least 7 GPa at indentation depths of 50-250 nm as measured from the outer surface of the optical coating at the first and second portions along the first and second axes, respectively, by a Berkovich Indenter Hardness Test.

The disclosure relates, in various aspects, to a coated article, comprising:
a substrate having a major surface, the major surface comprising a first portion and a second portion, wherein a first axis that is normal to the first portion of the major surface is not equal to a second axis that is normal to the second portion of the major surface, and the angle between the first axis and the second axis is at least 40 degrees; and
an optical coating disposed on at least the first portion and the second portion of the major surface, the optical coating having an inner surface facing the substrate and an outer surface opposite the inner surface;
wherein:
the optical coating at the first and second portions has a physical thickness uniformity of less than 10%, the physical thickness uniformity calculated as [(t_max−t_min)/(t_max+t_min)]×100, wherein t_max is a maximum physical thickness of the optical coating measured at the first and second portions along the first and second axes, respectively, and t_min is a minimum physical thickness of the optical coating measured at the first and second portions along the first and second axes, respectively;
the optical coating at the first and second portions has a physical thickness of 100 nm to 1000 nm;
the optical coating comprises alternating layers of at least one high refractive index (RI) layer and at least one low RI layer;
the at least one high RI layer comprises SiᵤAlᵥOₓN_{y}, Ta₂O₅, Nb₂O₅, AlN, Si₃N₄, AlOₓN_{y}, SiOₓN_{y}, HfO₂, TiO₂, ZrO₂, Y₂O₃, Al₂O₃, MoO₃, diamond-like carbon, or any combination thereof, wherein subscripts “u,” “v,” “x,” and “y” are independently selected from 0 to 1; and the at least one low RI layer comprises SiO₂, Al₂O₃, GeO₂, SiO, AlOₓN_{y}, SiOₓNᵤ, SiAlₓO_{y}, SiᵤAlᵥOₓN_{y}, MgO, MgAl₂O₄, MgF₂, BaF₂, CaF₂, DyF₃, YbF₃, CeF₃, AlF₃, or any combination thereof, wherein subscripts “u,” “v,” “x,” and “y” are independently selected from 0 to 1.

The disclosure relates, in various aspects, to a method of making a coated article, the method comprising depositing the optical coating on the major surface of the substrate.

Additional features and advantages of the disclosure will be set forth in the detailed description which follows, and in part will be readily apparent to those skilled in the art from that description or recognized by practicing the aspects as described herein, including the detailed description which follows, the claims, as well as the appended drawings.

It is to be understood that both the foregoing general description and the following detailed description are merely exemplary and are intended to provide an overview or framework for understanding the nature and character of the disclosure and claims. The accompanying drawings are included to provide a further understanding of the disclosure and are incorporated into and constitute a part of this specification. The drawings illustrate various aspects of the disclosure and together with the description serve to explain the principles and operations of the various aspects.

### BRIEF DESCRIPTION OF THE DRAWINGS

The following detailed description can be further understood when read in conjunction with the following drawings. Whenever possible, the same reference numerals will be used throughout the drawings to refer to the same or like parts. It is to be understood that the figures are not drawn to scale and the size of each depicted component or the relative size of one component to another is not intended to be limiting.

FIG. 1 is a cross-sectional side view of a coated article, according to one or more aspects described herein.

FIGS. 2-8 are cross-sectional side view of coated articles, according to one or more aspects described herein.

FIG. 9A is a plan view of an exemplary electronic device incorporating any of the coated articles disclosed herein.

FIG. 9B is a perspective view of the exemplary electronic device of FIG. 9A.

FIG. 10 is a schematic diagram of a setup for coating substrates using ALD, according to one or more aspects described herein.

FIGS. 11A and 11B are schematic depictions of the pulse/purge cycling of an ALD process to produce a layer of ZrO₂+Al₂O₃ nanolaminate (FIG. 11A) and a layer of SiO₂ (FIG. 11B), according to one or more aspects described herein.

FIG. 12 is a graph depicting single side light reflectance of various coated articles.

FIG. 13A is a graph depicting single side light reflectance at various angles of a quartz rod coated with an optical coating using ALD.

FIG. 13B is a graph depicting a zoomed in region of FIG. 13A.

FIG. 14A is a graph depicting single side light reflectance at various angles of a hemisphere substrate coated with an optical coating using ALD.

FIG. 14B is a graph depicting a zoomed in region of FIG. 14A.

FIG. 15A is a graph depicting single side light reflectance at various angles of a quartz rod coated with an optical coating using PVD.

FIG. 15B is a graph depicting a zoomed in region of FIG. 15A.

FIG. 16A is a graph depicting single side light reflectance at various angles of a hemisphere substrate coated with an optical coating using PVD.

FIG. 16B is a graph depicting a zoomed in region of FIG. 16A.

FIG. 17 is a schematic diagram depicting the angular positions on a quartz rod or hemisphere substrate where single side light reflectance measurements are made.

FIG. 18 is a graph showing physical thickness at various measurement angles (see FIG. 17) calculated using commercially available Essential Macleod software using reflectance data from FIGS. 13-16.

FIG. 19 is a graph showing hardness vs. displacement for the layered structures of Tables 1 and 2.

FIG. 20 is a graph showing steel wool abrasion test results for bare glass substrate, the same substrate coated with ALD of Table 1, and the same substrate coated with PVR (sputter, Table 2).

FIG. 21 are images showing Cs-8 abrasion test results for bare glass substrate, the same substrate coated with ALD of Table 1, and the same substrate coated with PVR (Table 2).

FIG. 22 is a schematic of a layer of an optical coating, in which the layer is a ZrO₂+Al₂O₃ nanolaminate.

FIG. 23 is a graph depicting surface roughness (Ra) of ZrO₂/Al₂O₃ nanolaminate films with thickness of about 50 nm as a function of Al₂O₃ unit cycle.

FIG. 24 is a graph showing refractive index at 550 nm of a ZrO₂/Al₂O₃ nanolaminate as a function of unit cycles of ZrO₂/(Al₂O₃+ZrO₂) (including pure ZrO₂ when ZrO₂/(Al₂O₃+ZrO₂) equals 1.00).

FIG. 25 is a graph showing hardness vs. depth for a coated article with a coating comprising SiO₂.

FIG. 26 is a graph showing scratch resistance of a coated article comprising a coating comprising SiO₂ in terms of ASCE.

FIGS. 27A-27B are reflectance curves from ALD SiO₂ films cylindrical surfaces coated at two different temperatures.

FIG. 28 shows physical thickness distribution on the round surface of a half quartz rod substrate as measured from cross-sectional analysis of SEM images.

FIG. 29 is a schematic representation of a top down view of an ALD chamber that can be used to coat a 3D article.

### DETAILED DESCRIPTION

In the following description, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other.

Where a range of numerical values is recited herein, comprising upper and lower values, unless otherwise stated in specific circumstances, the range is intended to include the endpoints thereof, and all integers and fractions within the range. Further, when an amount, concentration, or other value or parameter is given as a range, one or more ranges, or a list of upper values and lower values, this is to be understood as specifically disclosing all ranges formed from any pair of any upper range limit or value and any lower range limit or value, regardless of whether such pairs are separately disclosed.

If the term “about” is used in describing a value or an end-point of a range, the disclosure should be understood to include the specific value or end-point referred to. As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. It is noted that the terms “substantially” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Thus, for example, a glass that is “substantially free” of any specific component (e.g., Al₂O₃, MgO, or any other component) is one in which the component is not actively added or batched into the glass, but may be present in small amounts as a contaminant (e.g., less than 1000, 500, 400, 300, 200, or 100 ppm), or, if actively added or batched, is present in an amount less than 1 wt. % (e.g., or can be specified to be less than 0.5 wt. %, 0.1 wt. %, or 0.05 wt. %.), based on total amount of the glass (moles or mass for ppm, and mass for wt. %).

As used herein, the term “ion-exchangeable” means that a glass has a composition such that it is capable of undergoing chemical strengthening by way of ion exchange. For example, a glass having an appropriate structure and containing lithium can undergo ion exchange in a molten salt bath containing sodium and/or potassium so as to replace a portion of the lithium with sodium and/or potassium. Similarly, a glass having an appropriate structure and containing sodium can undergo ion exchange in a molten salt bath containing potassium so as to replace a portion of the sodium with potassium. As is known in the art, replacing smaller alkali ions in glass with larger alkali ions results in a compressive stress in the glass, thereby strengthening the glass. An “appropriate structure” in the glass is one that allows such ion exchange to take place so as to result in a compressive stress and associated strengthening of the glass.

Herein, glass compositions are expressed in terms of wt. % amounts of particular components included therein on an oxide bases unless otherwise indicated. Any component having more than one oxidation state may be present in a glass composition in any oxidation state. However, concentrations of such component are expressed in terms of the oxide in which such component is at its lowest oxidation state unless otherwise indicated.

As used herein, “uniformity” can be applied to and calculated for any property herein, such as refractive index, extinction coefficient, physical thickness, transmittance, opaqueness, single side light reflectance, and so forth. Uniformity is, in colloquial terms, a measure of how uniform a coating's property is at two or more portions of the coating by measuring such property of the coating at each of the two or more portions, determining the maximum (P_max) and minimum (P_min) property among each measurement at the two or more portions, and then inputting such determined P_max and P_min values into the following equation: [(P_max−P_min)/(P_max+P_min)]×100, which is expressed as a percent, thereby resulting in a numerical value for the uniformity of the property with respect to the two or more portions of the coating.

As used herein. “physical thickness uniformity” is, in colloquial terms, a measure of how uniform a coating's physical thickness is at two or more portions of the coating by measuring the physical thickness of the coating at each of the two or more portions, determining the maximum (t_max) and minimum (t_min) physical thicknesses among each measurement at the two or more portions, and then inputting such determined t_max and t_min values into the following equation: [(t_max−t_min)/(t_max+t_min)]×100, which is expressed as a percent, thereby resulting in a numerical value for the physical thickness uniformity with respect to the two or more portions of the coating. For example, if it is desired to determine the physical thickness uniformity among four portions of a coating (t_1, t_2, t_3, and t_4), the physical thicknesses at each portion is t_1=283 nm, t_2=301 nm, t_3=295 nm, and t_4=291 nm, the t_max is 301 nm and the t_min is 283. Inputting these values into the equation above results in a physical thickness uniformity of 3.08% among the four portions.

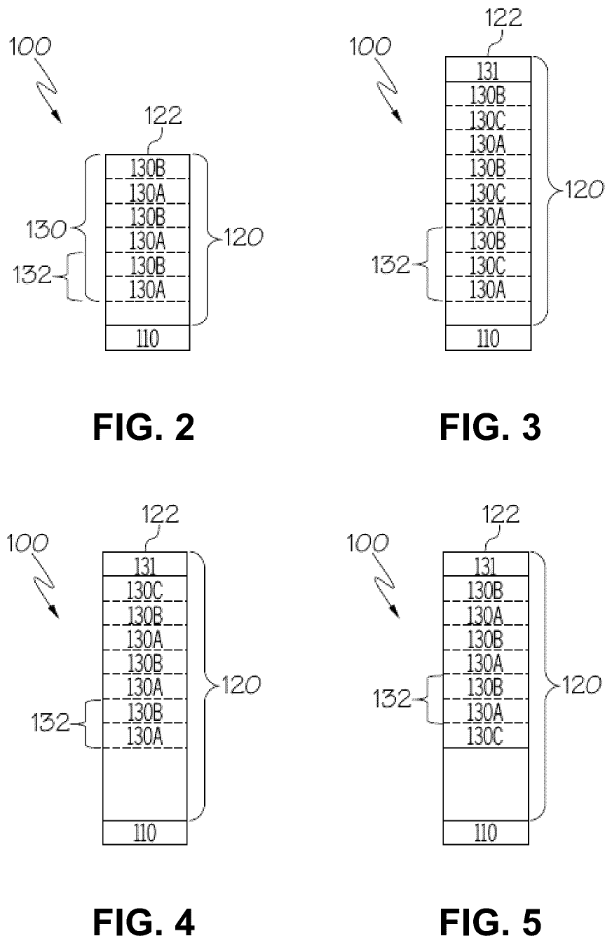

As used herein, “single side light reflectance” means reflectance measured from the outer surface of a coated article while removing any reflections from an uncoated back surface of the coated article, such as through using index-matching oils on the back surface coupled to an absorber, or other known methods. For example, referring to FIGS. 2-8, single side light reflectance is measured at the anti-reflective surface 122 only (e.g., when removing any reflections from an uncoated back surface of the article (the bottom of substate 110), such as through using index-matching oils on the back surface coupled to an absorber, or other known methods).

As used herein, a “nanolaminate” means a layer that contains relatively thinner sublayers (e.g., about 0.1-5 nm) that separate relatively thicker sublayers (e.g., about 5-100 nm), in which the thinner and thicker sublayers repeat in an alternating pattern. By way of example, a nanolaminate containing Al₂O₃ and ZrO₂ contains thinner amorphous Al₂O₃ layers with a thickness of, for example, 0.1-5 nm (or any other thickness disclosed herein), that alternate with thicker ZrO₂ layers with a thickness of, for example, 5-50 nm (or any other thickness disclosed herein), such that the overall thickness of the nanolaminate is, for example, 10-100 nm, or any other layer thickness disclosed elsewhere herein.

As used herein, the term “dispose” includes coating, depositing and/or forming a material onto a surface using any known method in the art. The disposed material may constitute a layer, as defined herein. The phrase “disposed on” includes the instance of forming a material onto a surface such that the material is in direct contact with the surface and also includes the instance where the material is formed on a surface, with one or more intervening material(s) between the disposed material and the surface. The intervening material(s) may constitute a layer, as defined herein.

As used herein, the term “alternating,” when used in reference to alternating high refractive index and low refractive index layers, and similar terminology, includes arrangements of high refractive index (“H”) and low refractive index (“L”) layers as follows: (1) a structure comprising L/H/L/H in which each layer is in direct contact; (2) a structure comprising L/L/H/L/H or H/H/L/H/L in which each layer is in direct contact where there are repeat L/L or H/H layers but there nevertheless is an alternation of high and low index layers considering all layers present in an optical coating; and (3) any aforementioned structure further comprising one or more intervening (I) layers, such as an organic or other type of layer, such as H/L/I/L/H/L/H or H/L/I/H/H/H/L/I/H/L in which there is nevertheless an alternation of high and low index layers considering all layers present in an optical coating. By way of further example, alternating H and L layers can include the following arrangements: (a) H/L/H/L/H. (b) L/H/H/L/H/L, (c) H/L/L/H/H/H/L/H/L. (d) H/L/I/H/L/H, and (c) L/H/I/H/H/L/H/L, in which “I” is an intervening layer. However, in some aspects, as will be clear from context, the optical coatings disclosed herein may be defined to be limited to a particular type of alternating structure, such as only those with a strict alternation of H and L layers without any repeat layers abutting one another (such as H/H or L/L) and/or such as only those that exclude any intervening layers like organic layers. In an optical coating, any of the H layers may be the same or different, any of the L layers may be the same or different, and it is contemplated that any of such H and/or L layers can be specified to be the same or different in the context of any disclosure herein.

As used herein, the terms “film” and “coating” are used interchangeably herein without any intended difference in meaning unless clearly indicated otherwise by explicit wording or context.

Described herein are coated articles that comprise optical coatings over non-linear substrates. In aspects the optical coatings have substantially uniform physical thicknesses even on non-linear substrates. Non-linear substrates may have non-uniform physical thicknesses of optical coatings when, for example, line-of-sight coating methods are employed, such as physical vapor deposition (PVD), sputtering, and other similar methods; however, it is desirable to produce uniform optical coatings on non-linear substrates so as to have desired optical and hardness properties. Accordingly, it is desirable to employ methods that do not rely on line-of-sight methods when preparing such uniform optical coatings. Atomic layer deposition (ALD) is one example of a method that, unlike physical vapor deposition (PVD), provides coatings that generally are independent of on line-of-sight from the coating source.

In aspects, disclosed herein are optical hardcoatings on complex 3D substrates, i.e., non-planar substrates, in which the coating has uniform optical and mechanical properties.

Anti-reflection products are available for various applications, including mobile consumer electronics and automotive interiors, but such products typically are limited to 2D and 2.5D substrates. As substrate designs are evolving to include complex 3D curved shapes (non-planar substrates), standard sputter deposition techniques will be challenged to produce uniform thicknesses to realize desired optical and mechanical performance at every point on the curved surface. This disclosure describes paths to address this and other challenges or limitations.

Disclosed herein in some aspects are coated articles comprising a substrate, such as a glass or glass-ceramic substrate, in which the coated article can be optically transparent or opaque and with a shape ranging from flat to 3D round with optical coating having optical and/or physical thickness properties within +10%, within +5%, or even within +2% (or any other percentage disclosed herein) uniformity at any or all points across the entire surface. In aspects, the optical coating also has good mechanical properties, excellent hardness (e.g., >7 GPa or >9 GPa), which is comparable or slightly better than the bare (i.e., uncoated) glass substrate that was employed. In aspects, the optical coating may comprise a single or multilayer optical interference film composed of SiO₂, SiOₓN_{y}, AlN, Si₃N₄, SiₓO_{y}F_{z}, AlF₃, TiO₂, Al₂O₃, HfO₂, Nb₂O₅ ZrO₂, or any combination thereof (or any other material disclosed herein). In aspects, the optical coating properties exhibiting <10%, <5%, <2%, etc. uniformity may include uniformity with respect to the refractive index, extinction coefficient, physical thickness, single side light reflectance, or any combination thereof.

Aspects of the disclosure will now be discussed with reference to the figures, which illustrate various aspects of the articles, devices, and methods disclosed herein. The following general description is intended to provide an overview of the disclosure, structures, and methods, and various aspects will be more specifically discussed throughout the disclosure with reference to the non-limiting depicted aspects, all of these aspects being interchangeable with one another within the context of the disclosure.

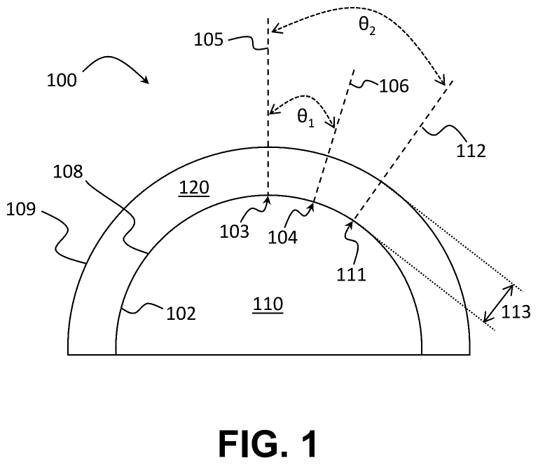

FIG. 1 is a coated article 100 according to various aspects of the disclosure. In particular, in some aspects, coated article 100 comprises a substrate 110 (e.g., a substrate that is non-planar, three-dimensional, etc.) having major surface 102. The major surface 102 comprises a first portion 103 and a second portion 104, wherein a first axis 105 that is normal to the first portion 103 of the major surface 102 is not equal to a second axis 106 that is normal to the second portion 104 of the major surface 102, and the angle θ₁ between the first axis 105 and the second axis 106 is at least X degrees, in which X can be 20, 25, 30, 35, 40, 45, 50, 55, 60, 65, 75, 80, 85, 90, etc. Although first axis 105 is depicted as being at the apex of the coated article, the first axis 105 could be located anywhere on the major surface 102 provided any required angle between the first axis 105 and second axis 106 is met. An optical coating 120 is disposed on at least the first portion 103 and the second portion 104 of the major surface 102, the optical coating 120 having an inner surface 108 facing the substrate 110 and an outer surface 109 opposite the inner surface 108. In FIG. 1, major surface 102 abuts the inner surface 108 of the optical coating, but other aspects are contemplated where one or more additional layers are present therebetween, such as one or more bonding layers. In some aspects, the major surface 102 further comprises a third portion 111, a third axis 112 that is normal to the third portion 111 of the major surface 102 which is not equal to the first axis 105 or second axis 106, and the angle θ₂ between the third axis 112 and the first axis 105 is at least Y degrees, in which Y is 20, 25, 30, 35, 40, 45, 50, 55, 60, 65, 75, 80, 85, 90, etc. Note that FIG. 1 is a schematic drawing intended to convey concepts. As such, FIG. 1 is not drawn to scale and should not be regarded to convey precise dimensions or angles. While FIG. 1 depicts a cross section of a hemispherical substrate and coating, various other curved or 3D-shaped substrates, or even flat substrates, can be employed as well, including where the major surface 102 is mostly flat (parallel to the bottom of the substrate) and portions 104 and/or 111 are curved at the edges, such as in the case of a cover glass for an electronic device that has a mostly flat major surface and curved edges at the periphery.

In some aspects, the angle between any two axes, such as between the first axis and the second axis, the first axis and the third axis, the first axis and a fourth axis, the second axis and the third axis, and so forth, can be any suitable angle (degrees), such as at least 20, at least 25, at least 30, at least 35, at least 40, at least 45, at least 50, at least 55, at least 60, at least 65, at least 70, at least 75, at least 80, at least 85, at least 90, at least 95, at least 100, at least 105, at least 110, at least 115, at least 120, at least 125, at least 130, at least 135, at least 140, at least 145, at least 150, at least 155, at least 160, at least 165, at least 170, at least 175, at least 180, 180 or less, 175 or less, 170 or less, 165 or less, 160 or less, 155 or less, 150 or less, 145 or less, 140 or less, 135 or less, 130 or less, 125 or less, 120 or less, 115 or less, 110 or less, 105 or less, 100 or less, 95 or less, 90 or less, 85 or less, 80 or less, 75 or less, 70 or less, 65 or less, 60 or less, 55 or less, 50 or less, 45 or less, 40 or less, 35 or less, 30 or less, 25 or less, or 20 or less, or any range formed from any two of the foregoing endpoints. For example, in some aspects, suitable ranges for the angle between any two axes can include 20-180, 20-150, 20-120, 20-90, 20-80, 20-75, 20-60, 20-45, 20-30, 30-180, 30-150, 30-120, 30-90, 30-85, 30-75, 30-60, 30-45, 45-180, 45-160, 45-130, 45-100, 45-90, 45-80, 45-75, 45-60, 45-50, 60-180, 60-175, 60-160, 60-145, 60-120, 60-100, 60-90, 60-75, 75-180, 75-150, 75-140, 75-130, 75-100, 75-90, 75-85, 75-80, 75-180, 75-160, 75-140, 75-120, 75-100, 75-90, 90-180, 90-160, 90-140, 90-120, 90-100, 100-180, 100-160, 100-140, 100-120, 120-180, 120-160, 120-140, 140-180, 140-160, or 160-180. In some aspects, there can be any suitable number of axes that can be used to describe a surface here (e.g., a major surface), such as first, second, third, fourth, fifth, sixth, seventh, eighth, and ninth axes, and so forth, and the angles described herein can be applied to any two of the foregoing axes to describe the angle therebetween. For example, in some aspects, the angle between the first and second axes is at least 40 degrees, and the angle between the first and third axes is at least 60 degrees. In some aspects, the angel between the first axis and the second axis is at least 75 degrees or at least 180 degrees. In some aspects, the angle between the first and second axes is at least 40 degrees and the angle between the first and third axes is at least 70 degrees. In some aspects, there are first, second, third, fourth, fifth, and sixth axes, and the angle between each sequential axis (i.e., first to second, second to third, and so forth) is 15 degrees, and the physical thickness uniformity of the optical coating among such six axes is, for example, less than 5%, or any other value specified elsewhere herein.

In some aspects, the first, second, and/or third portion (or any other portion) is located in a concave portion of the major surface. For example, in some aspects, such a concave portion can be a depression or trench in the major surface. In some aspects, the first, second, and/or third portion (or any other portion) is located in a convex portion of the major surface. For example, in some aspects, such a convex portion can be as depicted in FIG. 1 or in similar configurations.

In some aspects, referring still to FIG. 1, the optical coating 120 of the coated article 100 at the first 103 and second 104 portions has a physical thickness uniformity of less than 10%, the physical thickness uniformity calculated as [(t_max−t_min)/(t_max+t_min)]×100, wherein t_max is a maximum physical thickness of the optical coating 120 measured at the first 103 and second 104 portions along the first 105 and second 106 axes, respectively, and t_min is a minimum physical thickness of the optical coating 120 measured at the first 103 and second 104 portions along the first 105 and second 106 axes, respectively. Similarly, in some aspects the optical coating 120 at the first 103, second 104, and third 111 portions has a physical thickness uniformity of less than 25%, the physical thickness uniformity calculated as [(t_max−t_min)/(t_max+t_min)]×100, wherein t_max is a maximum physical thickness of the optical coating 120 measured at the first 103, second 104, and third 111 portions along the first 103, second 104, and third 111 axes, respectively, and t_min is a minimum physical thickness of the optical coating 120 measured at the first 103, second 104, and third 111 portions along the first, second, and third axes, respectively. The physical thickness of the optical coating 120 measured at the third portion 111 along the third axis 112 is depicted as physical thickness 113. Although the physical thickness of the optical coating 120 at the first 103 and second 104 portions as measured along the first 105 and second 106 axes, respectively, is not explicitly called out as a feature in FIG. 1 in the same way as has been done for physical thickness 113, the same concepts apply.

In some aspects, the physical thickness uniformity (%), as defined elsewhere herein, among any two or more portions of a coating (e.g., optical coating), can be less than 25, less than 20, less than 15, less than 10, less than 9, less than 8, less than 7, less than 6, less than 5, less than 4.5, less than 4, less than 3.5, less than 3, less than 2.5, less than 2, less than 1.5, less than 1, less than 0.5, less than 0.3, at least 0.1, at least 0.3, at least 0.5, at least 1, at least 1.5, at least 2, at least 2.5, at least 3, at least 3.5, at least 4, at least 4.5, at least 5, at least 6, at least 7, at least 8, at least 9, at least 10, at least 15, at least 20, or any combination of any two of the foregoing endpoints. For example, the physical thickness uniformity (%) can be 0.1-25, 0.1-15, 0.1-10, 0.1-5, 0.1-4.5, 0.1-4, 0.1-3.5, 0.1-3, 0.1-2.5, 0.1-2, 0.1-1.5, 0.1-1, 0.1-0.5, 0.1-0.3, 0.3-25, 0.3-10, 0.3-8, 0.3-6, 0.3-5, 0.3-4.5, 0.3-4, 0.3-3.5, 0.3-3, 0.3-2.5, 0.3-2, 0.3-1.5, 0.3-1, 0.3-0.5, 0.5-25, 0.5-15, 0.5-10, 0.5-9, 0.5-8, 0.5-6, 0.5-5, 0.5-4.5, 0.5-4, 0.5-3.5, 0.5-3, 0.5-2.5, 0.5-2, 0.5-1.5, 0.5-1, 1-25, 1-20, 1-15, 1-10, 1-9, 1-8, 1-7, 1-6, 1-5, 1-4.5, 1-4, 1-3.5, 1-3, 1-2.5, 1-2, 1-1.5, 1.5-25, 1.5-15, 1.5-10, 1.5-5, 1.5-4.5, 1.5-4, 1.5-3.5, 1.5-3, 1.5-2.5, 1.5-2, 2-25, 2-15, 2-10, 2-8, 2-5, 2-4.5, 2-4, 2-3.5, 2-3, 2-2.5, 2.5-25, 2.5-20, 2.5-15, 2.5-10, 2.5-9, 2.5-8, 2.5-7, 2.5-6, 2.5-5, 2.5-4.5, 2.5-4, 2.5-3.5, 3-25, 3-15, 3-10, 3-8, 3-7, 3-5, 5-25, 5-20, 5-15, 5-10, 5-9, 5-8, 5-7, 5-6, 6-25, 6-15, 6-10, 6-8, 6-7, 8-25, 8-20, 8-15, 8-10, 10-25, 10-15, 15-20, or 15-25. In some aspects, physical thickness measurements are performed at X portions of the coating, in which X is at least 2, at least 3, at least 4, at least 5, at least 6, at least 7, at least 8, at least 9, at least 10, 11 or less, 10 or less, 9 or less, 8 or less, 7 or less, 6 or less, 5 or less, 4 or less, 3 or less, 2 or less, or any range formed from any two of the foregoing endpoints, such as 2-10, 4-10, 2-45, 8-10, and so forth. The angle between each of the axes that are normal to the major surface of the substrate, as described elsewhere herein with reference to FIG. 1, can be any suitable angle, as described elsewhere herein.

In some aspects, the uniformity (%), as defined elsewhere herein, of any specified property (e.g., refractive index, extinction coefficient, transmittance, single side light reflectance, etc.) among any two or more portions of a coating (e.g., optical coating), can be less than 25, less than 20, less than 15, less than 10, less than 9, less than 8, less than 7, less than 6, less than 5, less than 4.5, less than 4, less than 3.5, less than 3, less than 2.5, less than 2, less than 1.5, less than 1, less than 0.5, less than 0.3, less than 0.1, at least 0.1, at least 0.3, at least 0.5, at least 1, at least 1.5, at least 2, at least 2.5, at least 3, at least 3.5, at least 4, at least 4.5, at least 5, at least 6, at least 7, at least 8, at least 9, at least 10, at least 15, at least 20, or any combination of any two of the foregoing endpoints. For example, the uniformity (%) can be 0.1-25, 0.1-15, 0.1-10, 0.1-5, 0.1-4.5, 0.1-4, 0.1-3.5, 0.1-3, 0.1-2.5, 0.1-2, 0.1-1.5, 0.1-1, 0.1-0.5, 0.1-0.3, 0.3-25, 0.3-10, 0.3-8, 0.3-6, 0.3-5, 0.3-4.5, 0.3-4, 0.3-3.5, 0.3-3, 0.3-2.5, 0.3-2, 0.3-1.5, 0.3-1, 0.3-0.5, 0.5-25, 0.5-15, 0.5-10, 0.5-9, 0.5-8, 0.5-6, 0.5-5, 0.5-4.5, 0.5-4, 0.5-3.5, 0.5-3, 0.5-2.5, 0.5-2, 0.5-1.5, 0.5-1, 1-25, 1-20, 1-15, 1-10, 1-9, 1-8, 1-7, 1-6, 1-5, 1-4.5, 1-4, 1-3.5, 1-3, 1-2.5, 1-2, 1-1.5, 1.5-25, 1.5-15, 1.5-10, 1.5-5, 1.5-4.5, 1.5-4, 1.5-3.5, 1.5-3, 1.5-2.5, 1.5-2, 2-25, 2-15, 2-10, 2-8, 2-5, 2-4.5, 2-4, 2-3.5, 2-3, 2-2.5, 2.5-25, 2.5-20, 2.5-15, 2.5-10, 2.5-9, 2.5-8, 2.5-7, 2.5-6, 2.5-5, 2.5-4.5, 2.5-4, 2.5-3.5, 3-25, 3-15, 3-10, 3-8, 3-7, 3-5, 5-25, 5-20, 5-15, 5-10, 5-9, 5-8, 5-7, 5-6, 6-25, 6-15, 6-10, 6-8, 6-7, 8-25, 8-20, 8-15, 8-10, 10-25, 10-15, 15-20, or 15-25. In some aspects, property measurements are performed at X portions of the coating, in which X is at least 2, at least 3, at least 4, at least 5, at least 6, at least 7, at least 8, at least 9, at least 10, 11 or less, 10 or less, 9 or less, 8 or less, 7 or less, 6 or less, 5 or less, 4 or less, 3 or less, 2 or less, or any range formed from any two of the foregoing endpoints, such as 2-10, 4-10, 2-45, 8-10, and so forth. The angle between each of the axes that are normal to the major surface of the substrate, as described elsewhere herein with reference to FIG. 1, can be any suitable angle, as described elsewhere herein. For example, the uniformity of single side light reflectance measured at three portions of the coating can be, for example, less than 1%, less than 0.5%, less than 0.1%, 0.1-0.3%, or any other the other uniformity values disclosed herein.

In some aspects, referring again to FIG. 1, the coated article 100 at the first 103 and second 104 portions has a first single side light reflectance and a second single side light reflectance, respectively, as measured from the outer surface 109 of the optical coating 120 at an incident angle of 5 degrees (not depicted) relative to the first 105 and second 106 axes, respectively, that are less than 1% at all wavelengths between 500 nm and 800 nm. Similarly, in some aspects, the coated article 100 at the third portion 111 has a third single side light reflectance as measured from the outer surface 109 of the optical coating 120 at an incident angle of 5 degrees (not depicted) relative to the third axis that is less than 1% at all wavelengths between 500 nm and 800 nm.

In some aspects, the coated article at any specified portion thereof (e.g., at the outer surface of the optical coating where the relevant axis that is normal to the relevant portion of the major surface of the substrate intersects the outer surface of the optical coating) can have a single side light reflectance as measured from the outer surface of the optical coating at an incident angle of 5 degrees relative to any specified axis herein (e.g., first, second, third, or fourth axes, etc.) that can be less than 1%, less than 0.9%, less than 0.8%, less than 0.7%, less than 0.6%, less than 0.5%, less than 0.4%, less than 0.3%, less than 0.2%, less than 0.1%, or less than 0.05% at all wavelengths between 500 nm and 800 nm, or at only a specified portion of wavelengths between 500 nm and 800 nm. For example, in some aspects, the single side light reflectance is less than any specified percentage herein between wavelengths (nm) of 450-800, 450-775, 450-750, 450-725, 450-700, 450-675, 450-650, 450-625, 450-600, 450-575, 450-550, 450-525, 450-500, 450-475, 475-800, 475-775, 475-750, 475-725, 475-700, 475-675, 475-650, 475-625, 475-600, 475-575, 475-550, 475-525, 475-500, 500-800, 500-775, 500-750, 500-725, 500-700, 500-675, 500-650, 500-625, 500-600, 500-575, 500-550, 500-525, 525-800, 525-775, 525-750, 525-725, 525-700, 525-675, 525-650, 525-625, 525-600, 525-575, 525-550, 550-800, 550-775, 550-750, 550-725, 550-700, 550-675, 550-650, 550-625, 550-600, 550-575, 575-800, 575-775, 575-750, 575-725, 575-700, 575-675, 575-650, 575-625, 575-600, 600-800, 600-775, 600-750, 600-725, 600-700, 600-675, 600-650, 600-625, 625-800, 625-775, 625-750, 625-725, 625-700, 625-675, 625-650, 650-800, 650-775, 650-750, 650-725, 650-700, 650-675, 675-800, 675-775, 675-750, 675-725, 675-700, 700-800, 700-775, 700-750, 700-725, 725-800, 725-775, 725-750, 750-800, 750-775, or 775-800. In some aspects, there is a minimal single side light reflectance than can be greater than 0%, greater than 0.05%, greater than 0.1%, or greater than 0.2%, which can be paired with any of the upper limit single side light reflectance values described herein, and which can be specified for any of the wavelengths described herein.

In some aspects, referring still to FIG. 1, the coated article 100 at at least one of the first 103 and second 104 portions has a hardness of at least 7 GPa at indentation depths of 50-250 nm as measured from the outer surface 109 of the optical coating 120 at the first 103 and second 104 portions along the first 105 and second 106 axes, respectively, by a Berkovich Indenter Hardness Test. Similarly, the coated article 100 at the third portion 111 has a hardness of at least 7 GPa at indentation depths of 50-250 nm as measured from the outer surface 109 of the optical coating 120 at the third portion 111 along the third axis 112 by a Berkovich Indenter Hardness Test.

The optical coating 120 and/or the coated article 100 may be described in terms of a hardness measured by a Berkovich Indenter Hardness Test. As used herein, the “Berkovich Indenter Hardness Test” includes measuring the hardness of a material on a surface thereof by indenting the surface with a diamond Berkovich indenter. The Berkovich Indenter Hardness Test includes indenting the anti-reflective surface 122 of the coated article 100, also termed herein the outer surface 109 of the optical coating. (see FIGS. 1-8), or the surface of any one or more of the layers in the optical coating 120, with the diamond Berkovich indenter to form an indent to an indentation depth in the range from about 50 nm to about 1000 nm (or the entire thickness of the optical coating 120 or layer thereof, whichever is less) and measuring the maximum hardness from this indentation along the entire indentation depth range or a segment of this indentation depth (e.g., in the range from about 50 nm to about 600 nm, e.g., at an indentation depth of 100 nm or greater, or at any other indentation depth disclosed herein, etc.), generally using the methods set forth in Oliver, W. C.: Pharr, G. M., “An improved technique for determining hardness and elastic modulus using load and displacement sensing indentation experiments,” J. Mater. Res., Vol. 7, No. 6, 1992, 1564-1583; and Oliver, W. C.; Pharr, G. M., “Measurement of Hardness and Elastic Modulus by Instrument Indentation: Advances in Understanding and Refinements to Methodology,” J. Mater. Res., Vol. 19, No. 1, 2004, 3-20, the salient portions of which are incorporated by reference within this disclosure in their entirety. As used herein unless otherwise specified, “hardness” refers to a maximum hardness, and not an average hardness, and unless otherwise specified “hardness” refers to the hardness as measured by the Berkovich Indenter Hardness Test.

Typically, in nanoindentation measurement methods (such as by using a Berkovich indenter) of a coating that is harder than the underlying substrate, the measured hardness may appear to increase initially due to development of the plastic zone at shallow indentation depths and then increases and reaches a maximum value or plateau at deeper indentation depths. Thereafter, hardness begins to decrease at even deeper indentation depths due to the effect of the underlying substrate. Where a substrate having an increased hardness compared to the coating is utilized, the same effect can be seen; however, the hardness increases at deeper indentation depths due to the effect of the underlying substrate.

The indentation depth range and the hardness values at certain indentation depth range(s) can be selected to identify a particular hardness response of the optical film structures and layers thereof, described herein, without the effect of the underlying substrate. When measuring hardness of the optical film structure (when disposed on a substrate) with a Berkovich indenter, the region of permanent deformation (plastic zone) of a material is associated with the hardness of the material. During indentation, an elastic stress field extends well beyond this region of permanent deformation. As indentation depth increases, the apparent hardness and modulus are influenced by stress field interactions with the underlying substrate. The substrate influence on hardness occurs at deeper indentation depths (i.e., typically at depths greater than about 10% of the optical film structure or layer thickness). Moreover, a further complication is that the hardness response requires a certain minimum load to develop full plasticity during the indentation process. Prior to that certain minimum load, the hardness shows a generally increasing trend.

At small indentation depths (which also may be characterized as small loads) (e.g., up to about 50 nm), the apparent hardness of a material appears to increase dramatically versus indentation depth. This small indentation depth regime does not represent a true metric of hardness but instead, reflects the development of the aforementioned plastic zone, which is related to the finite radius of curvature of the indenter. At intermediate indentation depths, the apparent hardness approaches maximum levels. At deeper indentation depths, the influence of the substrate becomes more pronounced as the indentation depths increase.

Generally, maximum indentation hardness is determined by more factors than just the composition of the top surface of the article or similarity in the identity of individual layers (as opposed to precise arrangement and thicknesses of layers). For example, with regard to materials having thin film coatings, indentation hardness is affected by a number of factors, including the composition of the substrate, the composition of the top-most layer, and the composition and arrangement of the coating layers between the top-most layer and the substrate. For thin film coatings, the thickness of the coating is also an important factor in measuring the indentation hardness. A nanoindenter interacts mechanically with an interaction volume (i.e., a stress field) that extends a certain distance away from the tip of the nanoindenter. Generally, the hardness of a thin film coating is most accurately extracted from indentation depths corresponding to about 30-40% of the thickness of the coating, to minimize the effects of the mechanical properties of the substrate on the measured hardness of the thin film coating. For example, given a thin film coating with a total coating physical thickness of 300 nm, a more accurate measurement of the coating hardness is extracted from a nanoindentation depth of about 90-120 nm. Accordingly, any maximum hardness value disclosed herein can made in reference to a nanoindentation depth of 30-40% of the optical coating thickness (e.g., any coated article herein can have a maximum hardness of X GPa at an indentation depth of Y of the optical coating physical thickness, where X is any hardness disclosed herein and Y is an indentation depth range calculated by multiplying any indentation depth or depth range herein by 30% and by 40% to result in a range representing 30-40% of the coating).

In some aspects, the coated articles herein can have a hardness (GPa) at any specified portion thereof (e.g., first portion, second portion, third portion, etc.), at a depth of 50-250 nm (or any other depth specified herein), as measured from the outer surface of the optical coating along the relevant axis, of at least 7, at least 7.5, at least 8, at least 8.5, at least 9, at least 9.5, at least 10, at least 10.5, at least 11, at least 11.5, 12 or less, 11.5 or less, 11 or less, 10.5 or less, 10 or less, 9.5 or less, 9 or less, 8.5 or less, 8 or less, 7.5 or less, or 7 or less, or any range formed from any two of the aforementioned endpoints. For example, in some aspects, the hardness can be 7-12, 7-11, 7-10, 7-9, 7-8.5, 7-8, 7.5-12, 7.5-10.5, 7.5-9, 8-12, 8-11.5, 8-10.5, 8-10, 8-9, 8.5-12, 8.5-11, 8.5-10.5, 8.5-9.5, 9-12, 9-11, 9-10.5, 9-10, 9.5-12, 9.5-11, 9.5-10, 10-12, 10-11, 10.5-12, 10.5-11.5, 10.5-11, 11-12, 11-11.5, or 11.5-12 at indentation depths of 50-250 nm (or any other depth specified herein). For example, in some aspects, such hardness values can be measured at indentation depths (nm) of 50-250, 50-225, 50-200, 50-175, 50-150, 50-125, 50-100, 50-75, 75-250, 75-225, 75-200, 75-175, 75-150, 75-125, 75-100, 100-250, 100-225, 100-200, 100-175, 100-150, 100-125, 125-250, 125-225, 125-200, 125-175, 125-150, 150-250, 150-225, 150-200, 150-175, 175-250, 175-225, 175-200, 200-250, 200-225, or 225-250, or at any specific depth (nm), such as 50, 75, 100, 125, 150, 175, 200, 225, 250, 275, 300, 325, 350, 375, 400, 425, 450, 475, 500, 525, 550, or any range formed from any two such points. Any hardness and any depth disclosed herein can be combined to express a hardness value at a given depth, such as a hardness of at least 9 GPa at an indentation depth of 100 nm, a hardness of at least 8 GPa at an indentation depth of 500 nm, and so forth.

Aspects of the disclosure also include coated articles 100 in FIGS. 1-8 having a range of part surface angles (part surface curvature) that are combined with an optical coating 120 in which the optical coating 120 is designed to have a uniform physical thickness and have other desired properties such as good hardness (e.g., greater than 7 GPa), reflectance, color, and color shift with viewing angle over the entire surface of the article 100, including a portion or all of the curved regions (e.g., at first 103, second 104, and third 111 portions in FIG. 1 as viewed along the first 105, second 106, and third 112 axes, respectively). In some aspects, as a result of uniform physical thickness, coated articles 100 have low single side light reflectance and other desirable properties (e.g., hardness, transmittance, color, etc.) over surface curvature angles from 0 to 90 degrees (e.g., the angles between the first axis 105 and the second axis 106, or between the first axis 105 and the third axis 111). While FIGS. 2-8 schematically depict planar substrates, such figures should be considered to also represent non-planar such as shown in FIG. 1. In this regard, FIGS. 2-8 are depicted as planar to simplify the conceptual teachings of the respective figures.

In some aspects, the optical coating 120 includes at least one layer of at least one material. As used herein, the term “layer” may include a single layer (e.g., SiO₂) or may include one or more sub-layers (e.g., a layer that is a ZrO₂/Al₂O₃ nanolaminate). Each such sub-layer may be in direct contact with another sub-layer. The sub-layers may be formed from the same material or two or more different materials. In one or more alternative aspects, such sub-layers may have intervening layers of different materials disposed therebetween. In one or more aspects, a layer may include one or more contiguous and uninterrupted layers and/or one or more discontinuous and interrupted layers (i.e., a layer having different materials formed adjacent to one another). A layer or sub-layers may be formed by any known method in the art, including discrete deposition or continuous deposition processes. In one or more aspects, the layer may be formed using only continuous deposition processes, or, alternatively, only discrete deposition processes.

In some aspects, the physical thickness of the optical coating 120 or the anti-reflective coating 130 may be any suitable physical thickness in the direction normal to the surface on which it is disposed. For example, in some aspects, the physical thickness (nm) of the optical coating 120 or anti-reflective coating 130 in the direction normal to the deposition surface (e.g., along the first axis 105 at the first portion 103) is at least 50, at least 100, at least 150, at least 200, at least 250, at least 300, at least 350, at least 400, at least 450, at least 500, at least 550, at least 600, at least 650, at least 700, at least 750, at least 800, at least 850, at least 900, at least 950, at least 1000, at least 1100, at least 1200, at least 1300, at least 1400, at least 1500, at least 1600, at least 1700, at least 1800, at least 1900, at least 2000, 2000 or less, 1900 or less, 1800 or less, 1700 or less, 1600 or less, 1500 or less, 1400 or less, 1300 or less, 1200 or less, 1100 or less, 1000 or less, 950 or less, 900 or less, 850 or less, 800 or less, 750 or less, 700 or less, 650 or less, 600 or less, 550 or less, 500 or less, 450 or less, 400 or less, 350 or less, 300 or less, 250 or less, 200 or less, 150 or less, 100 or less, 50 or less, or any range formed there any two of the foregoing endpoints. For example, in some aspects, the physical thickness (nm) of the optical coating 120 or the anti-reflective coating 130 is 50-2000, 50-1800, 50-1600, 50-1500, 50-1400, 50-1100, 50-1000, 50-800, 50-650, 50-450, 50-400, 50-350, 50-300, 50-250, 50-200, 50-150, 50-100, 100-2000, 100-1700, 100-1500, 100-1200, 100-1000, 100-850, 100-750, 100-700, 100-600, 100-500, 100-450, 100-400, 100-350, 100-300, 100-250, 100-200, 150-2000, 150-1900, 150-1700, 150-1600, 150-1400, 150-1100, 150-950, 150-800, 150-750, 150-600, 150-500, 150-450, 150-400, 150-350, 150-300, 150-250, 150-200, 200-2000, 200-1600, 200-1200, 200-900, 200-800, 200-750, 200-650, 200-550, 200-500, 200-450, 200-400, 200-350, 200-300, 250-2000, 250-1600, 250-1000, 250-950, 250-900, 250-750, 250-650, 250-500, 250-450, 250-400, 250-350, 300-2000, 300-1900, 300-1600, 300-1200, 300-1100, 300-1000, 300-950, 300-750, 300-650, 300-600, 300-550, 300-500, 300-450, 300-400, 350-2000, 350-1200, 350-1000, 350-850, 350-750, 350-600, 350-550, 350-500, 350-450, 350-400, 400-2000, 400-1000, 400-600, 500-2000, 500-1500, 500-1200, 500-1000, 500-900, 500-850, 500-750, 500-650, 500-600, 600-2000, 600-1500, 600-1000, 700-2000, 700-1500, 700-1400, 700-1300, 700-1000, 900-2000, 900-1500, 900-1300, 900-1100, 1000-2000, 1000-1600, 1000-1400, 1000-1200, 1200-2000, 1200-1800, 1200-1600, 1200-1400, 1400-2000, 1400-1800, 1400-1600, 1600-2000, 1600-1800, or 1800-2000.

Referring to FIG. 2, the optical coating 120 may include an anti-reflective coating 130, which may include a plurality of layers (130A. 130B). In one or more aspects, the anti-reflective coating 130 may include a period 132 comprising two or more layers. In some aspects, the optical coating 120 comprises at least one low RI layer 103A and at least one high RI layer 130B. In one or more aspects, the two or more layers may be characterized as having different refractive indices from each another. In some aspects, the period 132 includes a low RI layer 130A and a high RI layer 130B.

As used herein, the terms “low RI layer” and “high RI layer” refer to the relative values of the refractive index (“RI”) of layers of an optical coating of a coated article according to the disclosure (i.e., low RI layer <high RI layer). Hence, low RI layers have refractive index values that are less than the refractive index values of high RI layers. Further, as used herein. “low RI layer” and “low index layer” are interchangeable with the same meaning. Likewise. “high RI layer” and “high index layer” are interchangeable with the same meaning. In some aspects, the difference in the refractive index of a low RI layer and a high RI layer may be at least 0.01, at least 0.05, at least 0.1, at least 0.2, at least 0.3, at least 0.4, at least 0.5, at least 0.6, at least 0.7, at least 0.8, at least 0.9, at least 1, at least 1.1, at least 1.2, 1.2 or less, 1.1 or less, 1 or less, 0.9 or less, 0.8 or less, 0.7 or less, 0.6 or less, 0.5 or less, 0.4 or less, 0.3 or less, 0.2 or less, 0.1 or less, or 0.05 or less, or any range formed from any two of the foregoing endpoints. For example, in some aspects, the difference in refractive indices of a low RI layer and a high RI layer is 0.01-1.2, 0.01-1, 0.01-0.8, 0.01-0.6, 0.01-0.4, 0.01-0.3, 0.01-0.2, 0.01-0.1, 0.01-0.05, 0.05-1.2, 0.05-1.1, 0.05-1, 0.05-1.8, 0.05-1.5, 0.05-1.3, 0.05-1, 0.05-0.8, 0.05-0.4, 0.05-0.2, 0.05-0.1, 0.1-1.2, 0.1-1, 0.1-0.8, 0.1-0.6, 0.1-0.4, 0.1-0.2, 0.2-1.2, 0.2-1.1, 0.2-1, 0.2-0.8, 0.2-0.7, 0.2-0.4, 0.2-0.3, 0.3-1.2, 0.3-1.1, 0.3-0.7, 0.3-0.6, 0.3-0.4, 0.4-1.2, 0.4-1.1, 0.4-1, 0.4-0.8, 0.4-0.6, 0.4-0.5, 0.5-1.2, 0.5-1, 0.5-0.8, 0.5-0.6, 0.6-1.2, 0.6-1.1, 0.6-1, 0.6-0.9, 0.6-0.7, 0.7-1.2, 0.7-1, 0.7-0.8, 0.8-1.2, 0.8-1.1, 0.8-1, 0.8-0.9, 0.9-1.2, 0.9-1.1, 0.9-1, 1-1.2, 1-1.1, or 1.1-1.2. Unless otherwise specified, the refractive indices disclosed herein are at 550 nm.

Referring again to FIG. 2, the anti-reflective coating 130 may include a plurality of periods 132. A single period 132 may include a low RI layer 130A and a high RI layer 130B, such that when a plurality of periods 132 are provided, the low RI layer 130A (designated for illustration herein as “L”) and the high RI layer 130B (designated for illustration herein as “H”) alternate in the following sequence of layers: L/H/L/H or H/L/H/L, such that the low RI layer 130A and the high RI layer 130B appear to alternate along the physical thickness of the optical coating 120 in the direction normal to the underlying major surface of the substrate 110. Any H can be the same as or different from any other H, and any L can be the same as or different from any other L. In the example in FIG. 2, the anti-reflective coating 130 includes three periods 132. In some aspects, the anti-reflective coating 130 may include up to twenty-five periods 132 (also referred herein as “N” periods, in which N is an integer). For example, in some aspects, the anti-reflective coating 130 may include N periods, in which N is at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 21, at least 22, at least 223, at least 24, at least 25, 25 or less, 24 or less, 23 or less, 22 or less, 21 or less, 20 or less, 19 or less, 18 or less, 17 or less, 16 or less, 15 or less, 14 or less, 13 or less, 12 or less, 11 or less, 10 or less, 9 or less, 8 or less, 7 or less, 6 or less, 5 or less, 4 or less, 3 or less, 2 or less, or any range formed from any two of the foregoing endpoints. For example, in some aspects, the number of periods N can be 2-25, 2-24, 2-22, 2-19, 2-17, 2-13, 2-10, 2-9, 2-8, 2-7, 2-6, 2-5, 2-4, 2-3, 3-25, 3-20, 3-16, 3-14, 3-12, 3-10, 3-9, 3-8, 3-7, 3-6, 3-5, 3-4, 4-25, 4-22, 4-19, 4-18, 4-16, 4-13, 4-12, 4-11, 4-10, 4-9, 4-8, 4-7, 4-6, 4-5, 5-25, 5-20, 5-19, 5-15, 5-12, 5-10, 5-9, 5-8, 5-7, 5-6, 6-25, 6-21, 6-19, 6-17, 6-13, 6-11, 6-9, 6-8, 6-7, 7-25, 7-21, 7-20, 7-19, 7-15, 7-14, 7-11, 7-10, 7-9, 7-8, 8-25, 8-24, 8-22, 8-20, 8-18, 8-17, 8-15, 8-14, 8-12, 8-11, 8-10, 8-9, 9-25, 9-21, 9-19, 9-18, 9-17, 9-16, 9-11, 9-10, 10-25, 10-21, 10-19, 10-17, 10-15, 10-13, 10-12, 10-11, 11-25, 11-20, 11-18, 11-16, 11-14, 11-12, 12-25, 12-24, 12-22, 12-20, 12-16, 12-14, 14-25, 14-24, 14-22, 14-20, 14-18, 14-16, 16-25, 16-24, 16-22, 16-20, 16-18, 18-d25, 18-24, 18-22, 18-20, 20-25, 20-24, 20-22, or 22-25.

Referring to FIG. 3, the anti-reflective coating 130 may include an additional capping layer 131, which may include a lower refractive index material than the high RI layer 130B. In some aspects, the period 132 may include one or more third layers 130C, as shown in FIG. 3. The third layer(s) 130C may have a low RI, a high RI or a medium RI. In some aspects, the third layer(s) 130C may have the same RI as the low RI layer 130A or the high RI layer 130B. In other aspects, the third layer(s) 130C may have a medium RI that is between the RI of the low RI layer 130A and the RI of the high RI layer 130B. Alternatively, the third layer(s) 130C may have a refractive index greater than the second high RI layer 130B. The third layer 130C may be provided in the optical coating 120 in the following exemplary configurations: L_{third layer}/H/L/H/L; H_{third layer}/L/H/L/H; L/H/L/H/L_{third layer}; H/L/H/L/H_{third layer}; L_{third layer}/H/L/H/L/H_{third layer}; H_{third layer}/L/H/L/H/L_{third layer}; L_{third layer}/L/H/L/H; H_{third layer}/H/L/H/L; H/L/H/L/L_{third layer}; L/H/L/H/H_{third layer}; L_{third layer}/L/H/L/H/H_{third layer}; H_{third layer}//H/L/H/L/L_{third layer}; L/M_{third layer}/H/L/M/H; H/M/L/H/M/L; M/L/H/L/M; as well as other combinations. In these configurations, “L” without any subscript refers to a low RI layer and “H” without any subscript refers to a high RI layer. Any H can be the same as or different from any other H, and any L can be the same as or different from any other L. Reference to “L_{third layer}” refers to a third layer having a low RI, “H_{third layer}” refers to a third layer having a high RI and “M” refers to a third layer having a medium RI, all such RIs being relative to the low RI layer and the high RI layer. Any H_{third layer} can be the same as or different from any other H_{third layer}, and any L_{third layer} can be the same as or different from any other L_{third layer}.

As used herein, the terms “low RI”, “high RI” and “medium RI” refer to the relative values for the RI to another (e.g., low RI<medium RI<high RI). In one or more aspects, the term “low RI” when used with the low RI layer or with the third layer, includes a range from 1.3 to 1.7, or 1.3 to 1.75 (e.g., 1.3-1.75, 1.3-1.7, 1.3-1.65, 1.3-1.6, 1.3-1.55, 1.3-1.5, 1.3-1.45, 1.3-1.4, 1.3-1.35, 1.35-1.75, 1.35-1.7, 1.35-1.65, 1.35-1.6, 1.35-1.55, 1.35-1.5, 1.35-1.45, 1.35-1.4, 1.4-1.75, 1.4-1.7, 1.4-1.65, 1.4-1.6, 1.4-1.55, 1.4-1.5, 1.4-1.45, 1.45-1.75, 1.45-1.7, 1.45-1.65, 1.45-1.6, 1.45-1.55, 1.45-1.5, 1.5-1.75, 1.5-1.7, 1.5-1.65, 1.5-1.6, 1.5-1.55, 1.55-1.75, 1.55-1.7, 1.55-1.65, 1.55-1.6, 1.6-1.75, 1.6-1.7, 1.6-1.65, 1.65-1.75, 1.65-1.7, or 1.7-1.75). In one or more aspects, the term “high RI” when used with the high RI layer or with the third layer, includes a range from about 1.7 to about 2.6 (e.g., about 1.85 or greater, or 1.7-2.6, 1.7-2.55, 1.7-2.5, 1.7-2.45, 1.7-2.4, 1.7-2.35, 1.7-2.3, 1.7-2.25, 1.7-2.2, 1.7-2.15, 1.7-2.1, 1.7-2.05, 1.7-2, 1.7-1.95, 1.7-1.9, 1.7-1.85, 1.7-1.8, 1.7-1.75, 1.75-2.6, 1.75-2.55, 1.75-2.5, 1.75-2.45, 1.75-2.4, 1.75-2.35, 1.75-2.3, 1.75-2.25, 1.75-2.2, 1.75-2.15, 1.75-2.1, 1.75-2.05, 1.75-2, 1.75-1.95, 1.75-1.9, 1.75-1.85, 1.75-1.8, 1.8-2.6, 1.8-2.55, 1.8-2.5, 1.8-2.45, 1.8-2.4, 1.8-2.35, 1.8-2.3, 1.8-2.25, 1.8-2.2, 1.8-2.15, 1.8-2.1, 1.8-2.05, 1.8-2, 1.8-1.95, 1.8-1.9, 1.8-1.85, 1.85-2.6, 1.85-2.55, 1.85-2.5, 1.85-2.45, 1.85-2.4, 1.85-2.35, 1.85-2.3, 1.85-2.25, 1.85-2.2, 1.85-2.15, 1.85-2.1, 1.85-2.05, 1.85-2, 1.85-1.95, 1.85-1.9, 1.9-2.6, 1.9-2.55, 1.9-2.5, 1.9-2.45, 1.9-2.4, 1.9-2.35, 1.9-2.3, 1.9-2.25, 1.9-2.2, 1.9-2.15, 1.9-2.1, 1.9-2.05, 1.9-2, 1.9-1.95, 1.95-2.6, 1.95-2.55, 1.95-2.5, 1.95-2.45, 1.95-2.4, 1.95-2.35, 1.95-2.3, 1.95-2.25, 1.95-2.2, 1.95-2.15, 1.95-2.1, 1.95-2.05, 1.95-2, 2-2.6, 2-2.55, 2-2.5, 2-2.45, 2-2.4, 2-2.35, 2-2.3, 2-2.25, 2-2.2, 2-2.15, 2-2.1, 2-2.05, 2.05-2.6, 2.05-2.55, 2.05-2.5, 2.05-2.45, 2.05-2.4, 2.05-2.35, 2.05-2.3, 2.05-2.25, 2.05-2.2, 2.05-2.15, 2.05-2.1, 2.1-2.6, 2.1-2.55, 2.1-2.5, 2.1-2.45, 2.1-2.4, 2.1-2.35, 2.1-2.3, 2.1-2.25, 2.1-2.2, 2.1-2.15, 2.15-2.6, 2.15-2.55, 2.15-2.5, 2.15-2.45, 2.15-2.4, 2.15-2.35, 2.15-2.3, 2.15-2.25, 2.15-2.2, 2.2-2.6, 2.2-2.55, 2.2-2.5, 2.2-2.45, 2.2-2.4, 2.2-2.35, 2.2-2.3, 2.2-2.25, 2.25-2.6, 2.25-2.55, 2.25-2.5, 2.25-2.45, 2.25-2.4, 2.25-2.35, 2.25-2.3, 2.3-2.6, 2.3-2.55, 2.3-2.5, 2.3-2.45, 2.3-2.4, 2.3-2.35, 2.35-2.6, 2.35-2.55, 2.35-2.5, 2.35-2.45, 2.35-2.4, 2.4-2.6, 2.4-2.55, 2.4-2.5, 2.4-2.45, 2.45-2.6, 2.45-2.55, 2.45-2.5, 2.5-2.6, 2.5-2.55, or 2.55-2.6). In some aspects, the term “medium RI” when used with the third layer, includes a range from 1.55 to 1.8 (e.g., 1.55-1.8, 1.55-1.75, 1.55-1.7, 1.55-1.65, 1.55-1.6, 1.6-1.8, 1.6-1.75, 1.6-1.7, 1.6-1.65, 1.65-1.8, 1.65-1.75, 1.65-1.7, 1.7-1.8, 1.7-1.75, or 1.75-1.8). In some instances, the ranges for low RI, high RI, and medium RI may overlap; however, in most instances, the layers of the anti-reflective coating 130 have the general relationship regarding RI of: low RI<medium RI<high RI.

In one or more aspects, the term “medium RI”, when used with the medium RI layers 130C, includes a refractive index range from 1.55 to 1.80, 1.56 to 1.80, 1.6 to 1.75, and all indices within these ranges (such as the ranges specified elsewhere herein). In one or more aspects, the term “high RI”, when used with the high RI layers 130B and/or scratch-resistant layer 150, can include a refractive index range of greater than 1.80, greater than 1.90, from about 1.8 to about 2.5, from about 1.8 to about 2.3, or from about 1.90 to about 2.5, and all indices between these ranges (such as the ranges specified elsewhere herein). Further, in a specific implementation, the medium RI layer(s) of the coated article 100 of the disclosure, may include a refractive index range from 1.55 to 1.90 or 1.55 to 1.80, and all values between these ranges (such as the ranges specified elsewhere herein), which may overlap in refractive index with the high RI layers 130B (e.g., as having a refractive index of greater than 1.80) of the optical film structure 120 or may not overlap in refractive index with the high RI layers 130B (e.g., as having a refractive index of greater than 1.90). In one or more aspects, the difference in the refractive index of each of the low RI layers 130A (and/or capping layer 131), the medium RI layers 130C, and/or the high RI layers 130B (and/or scratch-resistant layer 150) may be about 0.01 or greater, about 0.05 or greater, about 0.1 or greater, or even about 0.2 or greater (or any of the ranges specified elsewhere herein for the differences between low and high RIs, which can be applied here as differences between low and medium RIs, or between medium and high RIs).

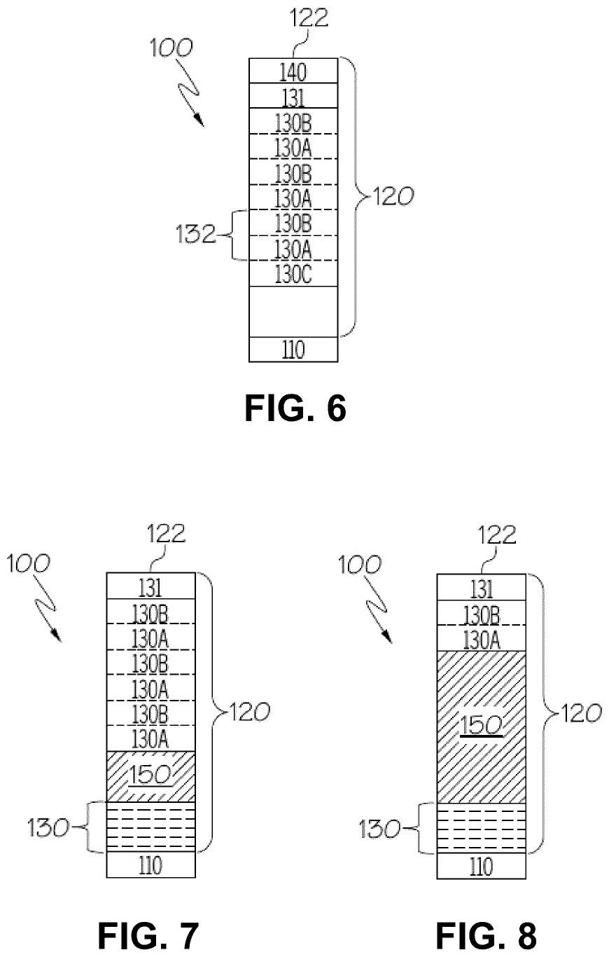

In some aspects, the third layer(s) 130C may be provided as a separate layer from a period 132 and may be disposed between the period 132 or plurality of periods 132 and the capping layer 131, as shown in FIG. 4. The third layer(s) may also be provided as a separate layer from a period 132 and may be disposed between the substrate 110 and the plurality of periods 132, as shown in FIG. 5. The third layer(s) 130C may be used in addition to an additional coating 140 instead of the capping layer 131 or in addition to the capping layer 131, as shown in FIG. 6. In some implementations, a third layer(s) 130C (not shown) is disposed adjacent to the scratch-resistant layer 150 or the substrate 110 in the configurations depicted in FIG. 7 and FIG. 8.

In some aspects, materials suitable for use in the anti-reflective coating 130 include: SiO₂, Al₂O₃, GeO₂, SiO, AlOₓN_{y}, AlN, SiNx, SiOₓN_{y}, SiᵤAlᵥOₓN_{y}, Ta₂O₅, Nb₂O₅, TiO₂, ZrO₂, TiN, MgO, MgF₂, BaF₂, CaF₂, SnO₂, HfO₂, Y₂O₃, MoO₃, DyF₃, YbF₃, YF₃, CeF₃, polymers, fluoropolymers, plasma-polymerized polymers, siloxane polymers, silsesquioxanes, polyimides, fluorinated polyimides, polyetherimide, polyethersulfone, polyphenylsulfone, polycarbonate, polyethylene terephthalate, polyethylene naphthalate, acrylic polymers, urethane polymers, polymethylmethacrylate, other materials cited below as suitable for use in a scratch-resistant layer, other materials known in the art, or any combination thereof. Some examples of suitable materials for use in the low RI layer include SiO₂, Al₂O₃, GeO₂, SiO, AlOₓN_{y}, SiOₓNᵤ, SiAlₓO_{y}, SiᵤAlᵥOₓN_{y}, MgO, MgAl₂O₄, MgF₂, BaF₂, CaF₂, DyF₃, YbF₃, CeF₃, AlF₃, or any combination thereof, wherein subscripts “u.” “v,” “x,” and “y” are independently selected from 0 to 1 and are chosen so as to have an appropriate stoichiometry. In some aspects, the nitrogen content of the materials for use in the low RI layer may be minimized (e.g., in materials such as Al₂O₃ and MgAl₂O₄). Some examples of suitable materials for use in the high RI layer include SiᵤAlᵥOₓN_{y}, Ta₂O₅, Nb₂O₅, AlN, Si₃N₄, AlOₓN_{y}, SiOₓN_{y}, HfO₂, TiO₂, ZrO₂, Y₂O₃, Al₂O₃, MoO₃, diamond-like carbon, or any combination thereof, wherein subscripts “u,” “v,” “x,” and “y” are independently selected from 0 to 1 and are chosen so as to have an appropriate stoichiometry. In some aspects, optical coatings herein comprise alternating layers of high refractive index and low refractive index materials. In some aspects, at least one high RI layer comprises ZrO₂, and at least one low RI layer comprises SiO₂. In some aspects, at least one high RI layer comprises ZrO₂ and Al₂O₃, and at least one low RI layer comprises SiO₂. In some aspects, the high RI layer or the medium RI layer can be a nanolaminate of ZrO₂ and Al₂O₃, as described elsewhere herein. For example, in some aspects, at least one high RI layer comprises a nanolaminate comprising ZrO₂ and Al₂O₃, in which the nanolaminate comprises alternating layers of Al₂O₃ and ZrO₂, and the Al₂O₃ layers in the nanolaminate are thinner than the ZrO₂ layers in the nanolaminate.

In examples, the high RI layer may also be a high hardness layer or a scratch-resistant layer, and the high RI materials listed above may also comprise high hardness or scratch resistance. The oxygen content of the materials for the high RI layer and/or the scratch-resistant layer may be minimized, especially in SiNx or AlNₓ materials. AlOₓN_{y} materials may be considered to be oxygen-doped AlNₓ, that is they may have an AlNₓ crystal structure (e.g. wurtzite) and need not have an AlON crystal structure. Exemplary AlOₓN_{y} high RI materials may comprise from 0 atom % to 20 atom % oxygen, or from 5 atom % to 15 atom % oxygen, while including 30 atom % to 50 atom % nitrogen. Exemplary SiᵤAlᵥOₓN_{y} high RI materials may comprise from 10 atom % to 30 atom % or from 15 atom % to 25 atom % silicon, from 20 atom % to 40 atom % or from 25 atom % to 35 atom % aluminum, from 0 atom % to 20 atom % or from 1 atom % to 20 atom % oxygen, and from 30 atom % to 50 atom % nitrogen. The foregoing materials may be hydrogenated up to 30% by weight. Exemplary SiᵤOₓN_{y} high RI materials may comprise from 45 atom % to 50 atom % silicon, 45 atom % to 50 atom % nitrogen, and 3 atom % to 10 atom % oxygen. In further implementations, the SiᵤOₓN_{y} high RI materials may comprise from 45 atom % to 50 atom % silicon, 35 atom % to 50 atom % nitrogen, and 3 atom % to 20 atom % oxygen. Where a material having a medium refractive index is desired, some aspects may utilize AlN and/or SiOₓN_{y}. The hardness of the second high RI layer and/or the scratch-resistant layer may be characterized specifically, including as measured by the Berkovich Indenter Hardness Test at specified indentation depths as described elsewhere herein. In some cases, the high RI layer 130B material may be deposited as a single layer and may be characterized as a scratch-resistant layer (e.g., scratch-resistant layer 150 depicted in FIGS. 7 and 8, and further described below), and this single layer may have a thickness between 100 nm and 5000 nm (or any other thickness described elsewhere herein).

In some aspects, the high RI layer can be a nanolaminate of ZrO₂ and Al₂O₃, in which thinner amorphous Al₂O₃ layers with a thickness of about 0.1-5 nm alternate in the nanolaminate with thicker ZrO₂ layers with a thickness of 5-50 nm, such that the overall thickness of the nanolaminate is, for example, 5-100 nm, or any other layer thickness disclosed elsewhere herein. Without wishing to be bound by theory, it is believed that the thin amorphous Al₂O₃ layers suppress or prevent crystallization of the ZrO₂ layer. This allows the optical film to, for example, benefit from the optical and hardness properties of ZrO₂ without the ZrO₂ crystallizing, which ZrO₂ crystallization can cause an undesired increase in surface roughness and optical issues. In addition, it is believed that in a nanolaminate such as ZrO₂/Al₂O₃ the refractive index of this nanolaminate is a function of the amount of each component in the nanolaminate. For example, as the thickness of Al₂O₃ increases relative to ZrO₂, the refractive index of the nanolaminate shifts lower, from around that of pure ZrO₂ (about 2.2), to 2.18 or 2.19 in a nanolaminate with an ALD cycle ratio of 100/5 (ZrO₂/Al₂O₃), to 2.18 in a nanolaminate with an ALD cycle ratio of 100/10 (ZrO₂/Al₂O₃).

In one or more aspects, at least one of the layer(s) of the anti-reflective coating 130 may include a specific optical thickness range. As used herein, the term “optical thickness” is determined by the product of the physical thickness and the intensity attenuation coefficient of a layer. In one or more aspects, at least one of the layers of the anti-reflective coating 130 may include an optical thickness in the range from about 2 nm to about 200 nm, from about 10 nm to about 100 nm, from about 15 nm to about 100 nm, from about 15 to about 500 nm, or from about 15 to about 5000 nm. In some aspects, all of the layers in the anti-reflective coating 130 may each have an optical thickness in the range from about 2 nm to about 200 nm, from about 10 nm to about 100 nm, from about 15 nm to about 100 nm, from about 15 nm to about 500 nm, or from about 15 nm to about 5000 nm. In some cases, at least one layer of the anti-reflective coating 130 has an optical thickness of about 50 nm or greater. In some cases, each of the low RI layers have an optical thickness in the range from about 2 nm to about 200 nm, from about 10 nm to about 100 nm, from about 15 nm to about 100 nm, from about 15 nm to about 500 nm, or from about 15 nm to about 5000 nm. In other cases, each of the high RI layers have an optical thickness in the range from about 2 nm to about 200 nm, from about 10 nm to about 100 nm, from about 15 nm to about 100 nm, from about 15 nm to about 500 nm, or from about 15 nm to about 5000 nm. In yet other cases, each of the third layers have an optical thickness in the range from about 2 nm to about 200 nm, from about 10 nm to about 100 nm, from about 15 nm to about 100 nm, from about 15 nm to about 500 nm, or from about 15 nm to about 5000 nm.

In some aspects, the top-most air-side layer may comprise a high RI layer 130B (see FIG. 2) that also exhibits high hardness. In some aspects, an additional coating 140 (see FIG. 6 and its corresponding description below) may be disposed on top of this top-most air-side high RI layer (e.g., the additional coating may include a surface modifying material as described elsewhere herein, such as a low-friction coating, an oleophobic coating, an easy-to-clean coating, or any combination thereof). The addition of a low RI layer having a very low thickness (e.g., about 10 nm or less, about 5 nm or less, or about 2 nm or less) has minimal influence on the optical performance when added to the top-most air-side layer comprising a high RI layer. The low RI layer having a very low thickness may include SiO₂, an oleophobic or low-friction layer, or a combination of SiO₂ and an oleophobic material. Exemplary low-friction layers may include diamond-like carbon, and such materials (or one or more layers of the optical coating) may exhibit a coefficient of friction less than 0.4, less than 0.3, less than 0.2, or even less than 0.1.

In one or more aspects, the anti-reflective coating 130 may be disposed over the scratch-resistant layer 150 (see, e.g., FIGS. 7 and 8). It has been discovered that limiting the thickness of the anti-reflective coating 130 over the scratch-resistance layer 150 may improve hardness. In one or more aspects, the anti-reflective coating 130 disposed over the scratch resistant layer 150 may have a physical thickness of about 1000 nm or less, 900 nm or less, 800 nm or less, 700 nm or less, 600 nm or less, 500 nm or less, or even 400 nm or less, or any other physical thickness disclosed elsewhere herein (e.g., as specified for the optical coating 120 or the anti-reflective coating 130).

In some aspects, the physical thickness of an individual RI layer (e.g., low RI layer, medium RI layer, or high RI layer) can be characterized. In some aspects, the physical thickness (nm) of an individual RI layer, as measured normal to the major surface of the substrate on which it is disposed, can be 5-200, 5-180, 5-160, 5-150, 5-140, 5-120, 5-100, 5-80, 5-60, 5-40, 5-20, 5-10, 10-200, 10-180, 10-160, 10-150, 10-140, 10-120, 10-100, 10-80, 10-60, 10-40, 10-20, 20-200, 20-180, 20-160, 20-150, 20-140, 20-120, 20-100, 20-80, 20-60, 20-40, 40-200, 40-180, 40-160, 40-150, 40-140, 40-120, 40-100, 40-80, 40-60, 60-200, 60-180, 60-160, 60-150, 60-140, 60-120, 60-100, 60-80, 80-200, 80-180, 80-160, 80-150, 80-140, 80-120, 80-100, 100-200, 100-180, 100-160, 100-150, 100-140, 100-120, 120-200, 120-180, 120-160, 120-150, 120-140, 140-200, 140-180, 140-160, 140-150, 150-200, 150-180, 150-160, 160-200, 160-180, or 180-200. Each individual RI layer can have the same or different physical thickness of any other individual RI layer, and the physical thicknesses of each individual RI layer as specified herein can be combined in any manner to describe an optical coating or anti-reflective coating. For example, in some aspects, a layered structure can be created from the disclosures herein as follows: L1/H1/L2/H2/L3/H3/L4, in which L1 is 5-40 nm, H1 is 10-40 nm, L2 is 20-80 nm, H2 is 40-80 nm, L3 is 5-20 nm, H3 is 40-100 nm, and L4 is 80-140 nm. Any other constructions can be prepared from the disclosures herein. In some aspects, the physical thickness of an individual RI layer can be 5-150 nm.

In some aspects, the combined physical thickness (nm) of the low RI layers can be at least 75, at least 100, at least 125, at least 150, at least 175, at least 200, at least 225, at least 250, at least 275, at least 300, at least 325, at least 350, at least 375, at least 400, at least 500, at least 600, at least 700, at least 800, at least 900, at least 1000, 1000 or less, 900 or less, 800 or less, 700 or less, 600 or less, 500 or less, 400 or less, 375 or less, 350 or less, 325 or less, 300 or less, 275 or less, 250 or less, 225 or less, 200 or less, 175 or less, 150 or less, 125 or less, 100 or less, or any range formed from any two of the foregoing endpoints. For example, in some aspects, the combined physical thickness (nm) of the low RI layers can be 75-1000, 75-900, 75-800, 75-700, 75-600, 75-500, 75-400, 75-300, 75-275, 75-250, 75-225, 75-200, 75-175, 75-150, 75-125, 75-100, 100-1000, 100-800, 100-600, 100-400, 100-375, 100-325, 100-275, 100-250, 100-225, 100-200, 100-175, 100-150, 100-125, 125-1000, 125-900, 125-800, 125-600, 125-500, 125-300, 125-275, 125-250, 125-225, 125-200, 125-175, 125-150, 150-1000, 150-800, 150-600, 150-400, 150-300, 150-275, 150-250, 150-225, 150-200, 150-175, 175-1000, 175-600, 175-400, 175-375, 175-350, 175-325, 175-300, 175-275, 175-250, 175-225, 175-200, 200-1000, 200-900, 200-800, 200-700, 200-600, 200-500, 200-400, 200-300, 200-275, 200-250, 200-225, 225-1000, 225-900, 225-700, 225-400, 225-375, 225-300, 225-275, 225-250, 250-1000, 250-800, 250-400, 250-375, 250-325, 250-300, 250-275, 275-1000, 275-800, 275-600, 275-400, 275-350, 275-325, 275-300, 300-1000, 300-900, 300-700, 300-600, 300-500, 300-400, 300-375, 300-350, 300-325, 325-1000, 325-900, 325-800, 325-700, 325-600, 325-500, 325-400, 400-1000, 400-800, 400-600, 400-500, 500-1000, 500-800, 500-700, 500-600, 600-1000, 600-900, 600-800, 600-700, 700-1000, 700-900, 700-800, 800-1000, 800-900, or 900-1000. For example, in some aspects, the combined physical thickness of the low RI layers is 100-300 nm. In some aspects, the low RI layer comprises SiO₂ and the combined physical thickness of all SiO₂ layers is 100-300 nm. The combined physical thickness is the calculated combination of the thicknesses of the individual low RI layer(s) in the optical coating 120 or anti-reflective coating 130, even when there are intervening high RI layer(s) or other layer(s).

In some aspects, the combined physical thickness (nm) of the high RI layers can be at least 75, at least 100, at least 125, at least 150, at least 175, at least 200, at least 225, at least 250, at least 275, at least 300, at least 325, at least 350, at least 375, at least 400, at least 500, at least 600, at least 700, at least 800, at least 900, at least 1000, 1000 or less, 900 or less, 800 or less, 700 or less, 600 or less, 500 or less, 400 or less, 375 or less, 350 or less, 325 or less, 300 or less, 275 or less, 250 or less, 225 or less, 200 or less, 175 or less, 150 or less, 125 or less, 100 or less, or any range formed from any two of the foregoing endpoints. For example, in some aspects, the combined physical thickness (nm) of the high RI layers can be 75-1000, 75-900, 75-800, 75-700, 75-600, 75-500, 75-400, 75-300, 75-275, 75-250, 75-225, 75-200, 75-175, 75-150, 75-125, 75-100, 100-1000, 100-800, 100-600, 100-400, 100-375, 100-325, 100-275, 100-250, 100-225, 100-200, 100-175, 100-150, 100-125, 125-1000, 125-900, 125-800, 125-600, 125-500, 125-300, 125-275, 125-250, 125-225, 125-200, 125-175, 125-150, 150-1000, 150-800, 150-600, 150-400, 150-300, 150-275, 150-250, 150-225, 150-200, 150-175, 175-1000, 175-600, 175-400, 175-375, 175-350, 175-325, 175-300, 175-275, 175-250, 175-225, 175-200, 200-1000, 200-900, 200-800, 200-700, 200-600, 200-500, 200-400, 200-300, 200-275, 200-250, 200-225, 225-1000, 225-900, 225-700, 225-400, 225-375, 225-300, 225-275, 225-250, 250-1000, 250-800, 250-400, 250-375, 250-325, 250-300, 250-275, 275-1000, 275-800, 275-600, 275-400, 275-350, 275-325, 275-300, 300-1000, 300-900, 300-700, 300-600, 300-500, 300-400, 300-375, 300-350, 300-325, 325-1000, 325-900, 325-800, 325-700, 325-600, 325-500, 325-400, 400-1000, 400-800, 400-600, 400-500, 500-1000, 500-800, 500-700, 500-600, 600-1000, 600-900, 600-800, 600-700, 700-1000, 700-900, 700-800, 800-1000, 800-900, or 900-1000. For example, in some aspects, the combined physical thickness of the high RI layers is 75-200 nm. In some aspects, the high RI layer comprises a nanolaminate of ZrO₂ and Al₂O₃, and the combined physical thickness of all such nanolaminates is 75-200 nm. The combined physical thickness is the calculated combination of the thicknesses of the individual high RI layer(s) in the optical coating 120 or anti-reflective coating 130, even when there are intervening low RI layer(s) or other layer(s).

In some aspects, the combined physical thickness of the low RI layers may be, as a percentage of the total physical thickness of the optical coating 120 or anti-reflective coating 130, at least 40%, at least 45%, at least 50%, at least 55%, at least 60%, at least 65%, at least 70%, at least 75%, 80% or less, 75% or less, 70% or less, 65% or less, 60% or less, 55% or less, 50% or less, 45% or less, or any range formed from any two of the foregoing endpoints. For example, the percentage of combined physical thickness of the low RI layers as a percentage of total physical thickness of the optical coating 120 or anti-reflective coating 130 can be 40-80, 40-75, 40-70, 40-65, 40-60, 40-55, 40-50, 40-45, 45-80, 45-75, 45-70, 45-65, 45-60, 45-55, 45-50, 50-80, 50-75, 50-70, 50-65, 50-60, 50-55, 55-80, 55-75, 55-70, 55-65, 55-60, 60-80, 60-75, 60-70, 60-65, 65-80, 65-75, 65-70, 70-80, 70-75, or 75-80. Conversely, the combined physical thickness of the high RI layers as a percentage of the total physical thickness of the optical coating 120 or anti-reflective coating 130 can be calculated by subtracting each end point above from 100% to get a new range (e.g., if the percentage of low RI layers is 40-70%, then the percentage of high RI layers would be 30-60%).

In some aspects, the coated article 100 may be substantially optically clear and transparent. In such aspects, the coated article may exhibit an average light transmittance over the optical wavelength regime (i.e., at all wavelengths between 400-700 nm) of about 85% or greater, about 86% or greater, about 87% or greater, about 88% or greater, about 89% or greater, about 90% or greater, about 91% or greater, about 92% or greater, about 93% or greater, about 94% or greater, about 95% or greater, about 96% or greater, about 97% or greater, about 98% or greater, or about 99% or greater.

In some aspects, the coated articles 100 may exhibit a first-surface (i.e., through one of the primary surfaces of the substrate 110, reflected color with a D65 illuminant, as given by V (a*2+b*2), of less than 10, less than 8, less than 6, less than 4, less than 3, or even less than 2, as measured at normal incidence, from 0 to 10 degrees, or over all incidence angles from 0 to 90 degrees. For example, the transparent articles 100 can exhibit a reflected color of less than 10, 9, 8, 7, 6, 5, 4, 3.75, 3.5, 3.25, 3, 2.75, 2.5, 2.25, 2, 1.9, 1.8, 1.7, 1.6, 1.5, 1.4, 1.3, 1.2, 1.1, 1, or even lower, as measured at normal incidence, from 0 to 10 degrees, or over all incidence angles from 0 to 90 degrees.

In some aspects, the coated article 100 may include one or more additional coatings 140 disposed on the outer surface of the optical coating, such as on the anti-reflective coating, as shown in FIG. 6. In one or more aspects, the additional coating may include a surface-modifying layer. As used herein, “surface-modifying layer” refers to a layer that is characterized by changing a physical property or other behavior of the coated article. For example, a surface-modifying layer can modify one or more of a water contact angle, an oleic contact angle, a visibility of a fingerprint (e.g., simulated fingerprint), and/or an ability to remove a fingerprint (e.g., by wiping). In some aspects, the surface-modifying layer can be an anti-fingerprint coating, a fingerprint-hiding coating, an easy-to-clean coating, or any combination thereof.

In some aspects, the surface-modifying layer can be an anti-fingerprint coating. Throughout the disclosure, a surface-modifying layer is an “anti-fingerprint” coating if the surface-modifying layer on a substrate or coated article can reduce the visibility of, reduce a color shift of, and/or reduce droplet formation of fingerprint oil disposed thereon relative to the substrate or coated article without the surface-modifying layer. As used herein, the visibility of a fingerprint refers to an absolute value of a difference in brightness (e.g., CIELAB L* value) for a portion of the anti-fingerprint coating with the fingerprint oil and another portion of the anti-fingerprint coating without the fingerprint oil. As used herein, the color shift of the substrate refers to a difference in measured color as √((a₁*−a₂*) 2+ (b₁*−b₂*)²), where a* refers to CIELAB a* values, b* refers to CIELAB b* values, subscript 1 refers to a portion of the anti-fingerprint coating without fingerprint oil, and subscript 2 refers to a portion of the anti-fingerprint coating with fingerprint oil. An anti-fingerprint coating can reduce droplet formation, which can increase a visibility and/or color shift of fingerprint oil, by being oleophilic, as defined below. Additionally, the anti-fingerprint coating can enable the removal of aqueous material (e.g., water droplets, sweat droplets) from the coating, for example, by being hydrophobic, as defined below. In further aspects, the anti-fingerprint coating can exhibit an (e.g., as-formed) water contact angle from 90° to 120°, an (e.g., as-formed) oleic acid contact angle of 40° or less, and a coefficient of friction of 0.25 or less. In further aspects, the anti-fingerprint coating can be substantially free and/or free of fluorine. In aspects, a diiodomethane contact angle of an anti-fingerprint coating (e.g., as-formed) can be about 60° or more, about 62° or more, about 65° or more, about 80° or less, about 75° or less, about 73° or less, or about 70° or less. In aspects, a diiodomethane contact angle of an anti-fingerprint coating (e.g., as-formed) can range from about 60° to about 80°, from about 62° to about 75°, from about 65° to about 72°, or any range or subrange therebetween. In aspects, an anti-fingerprint coating can be oleophilic. In aspects, a hexadecane contact angle and/or an oleic acid contact angle of an anti-fingerprint coating (e.g., as-formed) can be about 45° or less, about 40° or less, about 30° or less, about 25° or less, about 20° or less, or the anti-fingerprint coating can wet hexadecane and/or oleic acid. In further aspects, the anti-fingerprint coating (e.g., as formed) wets hexadecane and/or oleic acid. Providing a low diiodomethane contact angle (e.g., about 60° or less) and/or a low hexadecane contact angle (e.g., about 30° or less) can reduce the visibility and/or color shift associated with fingerprints by enabling fingerprint oil to be dispersed across the anti-fingerprint coating rather than beading up into pronounced droplets.

In some aspects, the surface-modifying layer can be a fingerprint-hiding coating. Throughout the disclosure, a “fingerprint-hiding coating” can reduce the visibility of and/or reduce a color shift of fingerprint oil disposed on a substrate or coated article relative to a substrate or coated article without the surface-modifying layer. As used herein, the visibility of a fingerprint refers to an absolute value of a difference in brightness (e.g., CIELAB L* value) for a portion of the fingerprint-hiding coating with the fingerprint oil and another portion of the fingerprint-hiding coating without the fingerprint oil. As used herein, the color shift of the glass-based substrate refers to a difference in measured color as √((a₁*−a₂*) 2+(b₁*−b₂*)²), where a* refers to CIELAB a* values, b* refers to CIELAB b* values, subscript 1 refers to a portion of the fingerprint-hiding coating without fingerprint oil, and subscript 2 refers to a portion of the fingerprint-hiding coating with fingerprint oil. Specifically, the fingerprint-hiding coating can cause fingerprint oil to spread out over the surface of the fingerprint-hiding coating. Reducing the thickness of fingerprint oil droplets and/or increasing an area of fingerprint-hiding coating covered by the fingerprint oil can decrease a color shift and/or visibility associated with the fingerprint oil. Fingerprint-hiding coatings that can be oleophilic are to be contrasted with other coatings (e.g., anti-fingerprint coatings) that can reduce droplet formation by being oleophobic. Additionally, the fingerprint-hiding coating can enable the removal of aqueous material (e.g., water droplets, sweat droplets) from the coating, for example, by being hydrophobic, as discussed herein. In further aspects, the fingerprint-hiding coating can exhibit an (e.g., as-formed) water contact angle from 90° to 120°, an (e.g., as-formed) oleic acid contact angle of 40° or less, and a coefficient of friction of 0.25 or less. In further aspects, the fingerprint-hiding coating can be a fluorine-containing material. Alternatively, in further aspects, the fingerprint-hiding coating can be substantially free and/or free of fluorine. In further aspects, the finger-hiding coating can exhibit a hexadecane contact angle of 20° or less (or wet hexadecane) and/or a diiodomethane contact angle of 60° or more.

In some aspects, the surface-modifying layer can be an easy-to-clean coating. Throughout the disclosure, a surface-modifying layer is an “easy-to-clean” coating if the surface-modifying layer on a substrate or coated article can repel material and/or facilitate removal of material disposed thereon relative to the substrate or coated article without the surface-modifying layer. As used herein, an ability to repel material is determined based on a contact angle with higher contact angles associated with greater repulsion. As used herein, an ability to remove material is measured by wiping the material disposed on the surface (e.g., of a coated article or substrate) with a cheesecloth (see details from the Cheesecloth Abrasion Test with the modification that the material is disposed on the surface before wiping) and the visibility of the material is monitored. A decreased visibility (e.g., fewer wiping cycles to achieve a predetermined reduction is visibility) is associated with a surface-modifying layer facilitating removal of material disposed thereon. In further aspects, the easy-to-clean coating can exhibit an (e.g., as-formed) water contact angle from 90° to 120°, an (e.g., as-formed) oleic acid contact angle of 50° or more, and a coefficient of friction of 0.25 or less. In further aspects, the easy-to-clean coating can be a fluorine-containing material. Alternatively, in further aspects, the easy-to-clean coating can be substantially free and/or free of fluorine. In aspects, a diiodomethane contact angle of an easy-to-clean coating (e.g., as-formed) can be about 60° or more, about 62° or more, about 65° or more, about 80° or less, about 75° or less, about 73° or less, or about 70° or less. In aspects, a diiodomethane contact angle of an easy-to-clean coating (e.g., as-formed) can range from about 60° to about 80°, from about 62° to about 75°, from about 65° to about 72°, or any range or subrange therebetween. In aspects, the easy-to-clean coating can be oleophilic. In aspects, a hexadecane contact angle of the easy-to-clean coating (e.g., as-formed) can be about 45° or less, about 40° or less, about 30° or less, about 25° or less, about 20° or less, or the easy-to-clean coating can wet hexadecane. In further aspects, the easy-to-clean coating (e.g., as formed) wets hexadecane. Providing a low diiodomethane contact angle (e.g., about 60° or less) and/or a low hexadecane contact angle (e.g., about 30° or less) can reduce the visibility and/or color shift associated with fingerprints by enabling fingerprint oil to be dispersed across the surface-modifying layer rather than beading up into pronounced droplets. In some aspects, an example of a suitable easy-to-clean coating is described in U.S. patent application Ser. No. 13/690,904, entitled “Process for Making of Glass Articles with Optical and Easy-to-Clean Coatings,” filed on Nov. 30, 2012, and published as U.S. Patent Application Publication No. 2014/0113083 on Apr. 24, 2014, the salient portions of each are incorporated by reference herein in their entirety. The easy-to-clean coating may have a thickness in the range from about 5 nm to about 50 nm and may include known materials such as fluorinated silanes or any of those listed elsewhere herein. The easy-to-clean coating may alternately or additionally comprise a low-friction coating or surface treatment. Exemplary low-friction coating materials may include diamond-like carbon, silanes (e.g. fluorosilanes), phosphonates, alkenes, and alkynes. In some embodiments, the easy-to-clean coating may have a thickness in the range from about 1 nm to about 40 nm, from about 1 nm to about 30 nm, from about 1 nm to about 25 nm, from about 1 nm to about 20 nm, from about 1 nm to about 15 nm, from about 1 nm to about 10 nm, from about 5 nm to about 50 nm, from about 10 nm to about 50 nm, from about 15 nm to about 50 nm, from about 7 nm to about 20 nm, from about 7 nm to about 15 nm, from about 7 nm to about 12 nm or from about 7 nm to about 10 nm, and all ranges and sub-ranges therebetween.

In some aspects, the additional coating 140 may include a scratch-resistant layer or layers. In some aspects, the additional coating 140 includes a combination of easy-to-clean material and scratch-resistant material. In one example, the combination includes an easy-to-clean material and diamond-like carbon. Such additional coatings 140 may have a thickness in the range from about 5 nm to about 20 nm, or any other thickness disclosed herein. In some aspects, the constituents of the additional coating 140 may be provided in separate layers. For example, the diamond-like carbon may be disposed as a first layer and the easy-to clean material can be disposed as a second layer on the first layer of diamond-like carbon. The thicknesses of the first layer and the second layer may be in the ranges provided above for the additional coating. For example, the first layer of diamond-like carbon may have a thickness of about 1 nm to about 50 nm, about 1 nm to about 20 nm, from about 4 nm to about 15 nm (or more specifically about 10 nm), or any other thickness disclosed herein, and the second layer of easy-to-clean material may have a thickness of about 1 nm to about 10 nm (or more specifically about 6 nm). The diamond-like coating may include tetrahedral amorphous carbon (Ta-C), Ta-C:H, and/or a-C—H.

As mentioned herein, in some aspects the optical coating 120 may include a scratch-resistant layer 150, which may be disposed between the anti-reflective coating 130 and the substrate 110. In some aspects, the scratch-resistant layer 150 is disposed between the layers of the anti-reflective coating 130 (such as the scratch-resistant layer 150 as shown in FIGS. 7 and 8). The two sections of the anti-reflective coating 130 (i.e., a first section disposed between the scratch-resistant layer 150 and the substrate 110, and a second section disposed on the scratch-resistant layer) may have a different thickness from one another or may have essentially the same thickness as one another. The layers of the two sections of the anti-reflective coating 130 may be the same in composition, order, thickness and/or arrangement as one another or may differ from one another. In addition, the layers of the two sections of the anti-reflective coating 130 may comprise the same number of periods 132 (N) or the number of periods 132 in each of these sections may differ from one another (see periods 132 shown in FIGS. 2-6 and described earlier). In addition, one or more optional layers 130C (not shown) can be disposed in either or both of the two sections (e.g., directly on the substrate 110, at the top of the first anti-reflective coating 130 section in contact with the scratch-resistant layer 150, at the bottom of the second anti-reflective coating 130 section in contact with the scratch-resistant layer 150, and/or at the bottom of the second anti-reflective coating in contact with the substrate 110).

In some aspects, exemplary materials used in the scratch-resistant layer 150 (or the scratch-resistant layer used as an additional coating 140) may include an inorganic carbide, nitride, oxide, diamond-like material, or combination of these. Examples of suitable materials for the scratch-resistant layer 150 include metal oxides, metal nitrides, metal oxynitride, metal carbides, metal oxycarbides, and/or combinations thereof. Exemplary metals include B, Al, Si, Ti, V, Cr, Y, Zr, Nb, Mo, Sn, Hf, Ta and W. Specific examples of materials that may be utilized in the scratch-resistant layer 150 or coating may include Al₂O₃, AlN, AlOₓN_{y}, Si₃N₄, SiOₓN_{y}, SiᵤAlᵥOₓN_{y}, diamond, diamond-like carbon, SiₓC_{y}, SiₓO_{y}C_{z}, ZrO₂, TiOₓN_{y} and combinations thereof. The scratch-resistant layer 150 may also comprise nanocomposite materials, or materials with a controlled microstructure to improve hardness, toughness, or abrasion/wear resistance. For example, the scratch-resistant layer 150 may comprise nanocrystallites in the size range from about 5 nm to about 30 nm. In some aspects, the scratch-resistant layer 150 may comprise transformation-toughened zirconia, partially stabilized zirconia, or zirconia-toughened alumina. In some aspects, the scratch-resistant layer 150 exhibits a fracture toughness value greater than about 1 MPa√m and simultaneously exhibits a hardness value greater than about 7 GPa (or any other fracture toughness and/or hardness value described elsewhere herein).

In some aspects, the scratch-resistant layer 150 may include a single layer (as shown in FIGS. 7 and 8), or multiple sub-layers or single layers that exhibit a refractive index gradient. Where multiple layers are used, such layers form a scratch-resistant coating. For example, a scratch-resistant layer 150 may include a compositional gradient of SiᵤAlᵥOₓN_{y} where the concentration of any one or more of Si, Al, O and N are varied to increase or decrease the refractive index. The refractive index gradient may also be formed using porosity. Such gradients are more fully described in U.S. patent application Ser. No. 14/262,224, entitled “Scratch-Resistant Articles with a Gradient Layer”, filed on Apr. 28, 2014, and now issued as U.S. Pat. No. 9,703,011 on Jul. 11, 2017, the salient portions of each are hereby incorporated by reference in their entirety.

In some aspects, the scratch-resistant layer 150 may have a physical thickness from about 200 nm to about 5000 nm. In some aspects, the scratch-resistant layer 150 has a physical thickness from about 200 nm to about 5000 nm, from about 200 nm to about 3000 nm, from about 500 nm to about 5000 nm, from about 500 nm to 3000 nm, from about 500 nm to about 2500 nm, from about 1000 nm to about 4000 nm, from about 1500 nm to about 4000 nm, from about 1500 nm to about 3000 nm, and all thickness values between these thicknesses. For example, the physical thickness of the scratch-resistant layer 150 can be 200 nm, 300 nm, 400 nm, 500 nm, 600 nm, 700 nm, 800 nm, 900 nm. 1000 nm, 1100 nm, 1200 nm, 1300 nm, 1400 nm, 1500 nm, 1600 nm, 1700 nm, 1800 nm, 1900 nm. 2000 nm, 2100 nm, 2200 nm, 2300 nm, 2400 nm, 2500 nm, 2600 nm, 2700 nm, 2800 nm, 2900 nm, 3000 nm, 3500 nm, 4000 nm, 4500 nm, 5000 nm, and all physical thickness sub-ranges and thickness values between the foregoing physical thicknesses.

In some aspects, depicted in FIG. 8, the optical coating 120 may comprise a scratch-resistant layer 150 that is integrated as a high RI layer, and one or more low RI layers 130A and high RI layers 130B may be positioned over the scratch-resistant layer 150, with an optional capping layer 131 positioned over the low RI layers 130A and high RI layers 130B, where the capping layer 131 comprises a low RI material. The scratch-resistant layer 150 may be alternately defined as the thickest hard layer or the thickest high RI layer in the overall optical coating 120 or in the overall coated article 100. Without being bound by theory, it is believed that the coated article 100 may exhibit increased hardness at indentation depths when a relatively thin amount of material is deposited over the scratch-resistant layer 150. However, the inclusion of low RI and high RI layers over the scratch-resistant layer 150 may enhance the optical properties of the coated article 100. In some aspects, relatively few layers (e.g., only 1, 2, 3, 4, or 5 layers) may positioned over the scratch-resistant layer 150 and these layers may each be relatively thin in terms of physical thickness (e.g., less than 100 nm, less than 75 nm, less than 50 nm, or even less than 25 nm). In other aspects, a larger quantity of layers (e.g., 3 to 15 layers) may be positioned over the scratch-resistant layer 150 and each of these layers may also be relatively thin in terms of physical thickness (e.g., less than 200 nm, less than 175 nm, less than 150 nm, less than 125 nm, less than 100 nm, less than 75 nm, less than 50 nm, and even less than 25 nm). In some aspects of the structure depicted in FIG. 8, the anti-reflective coating 130 may include a period 132 comprising four periods 132 above the scratch-resistant layer 150, four periods 132 below the scratch-resistant layer (i.e., N=8), a layer 130C disposed adjacent to the scratch-resistant layer 150 or substrate 110 (not shown), and a capping layer 131 (as shown in FIG. 8). In some aspects of the structure depicted in FIG. 8, the anti-reflective coating 130 may include a period 132 comprising five periods 132 above the scratch-resistant layer 150, five periods 132 below the scratch-resistant layer (i.e., N=8), a layer 130C disposed adjacent to the scratch-resistant layer 150 or substrate 110 (not shown), and a capping layer 131 (as shown in FIG. 8).

In some aspects, the layers deposited over the scratch-resistant layer 150 (i.e., on the air side of the scratch-resistant layer 150) may have a total physical thickness (i.e., in combination) of less than or equal to about 1000 nm, less than or equal to about 500 nm, less than or equal to about 450 nm, less than or equal to about 400 nm, less than or equal to about 350 nm, less than or equal to about 300 nm, less than or equal to about 250 nm, less than or equal to about 225 nm, less than or equal to about 200 nm, less than or equal to about 175 nm, less than or equal to about 150 nm, less than or equal to about 125 nm, less than or equal to about 100 nm, less than or equal to about 90 nm, less than or equal to about 80 nm, less than or equal to about 70 nm, less than or equal to about 60 nm, or even less than or equal to about 50 nm. Other suitable physical thicknesses are disclosed elsewhere herein and can be applied here to describe the combined physical thickness of the layers deposited over the scratch-resistant layer 150.

According to some aspects, the number the total amount of the plurality of low RI layers, high RI layers, and the scratch-resistant layer may range from 4 to 50 layers, 4 to 20 layers, 4 to 10 layers, 6 to 50 layers, 6 to 40 layers, 6 to 30 layers, 6 to 28 layers, 6 to 26 layers, 6 to 24 layers, 6 to 22 layer, 6 to 20 layers, 6 to 18 layers, 6 to 16 layers, and 6 to 14 layers, and all ranges of layers and amounts of layers between the foregoing values.

In some aspects, the substrate 110 may include an organic material, an inorganic material, or a combination thereof. In some aspects, the substrate may include an amorphous substrate (e.g., glass), a crystalline substrate (e.g., ceramic), or a combination thereof (e.g., glass-ceramic). Accordingly, in some aspects, substrate 110 comprises a glass-based material, a glass-ceramic material, and/or a ceramic-based material. As used herein, “glass-based” includes both glasses and glass-ceramics, wherein glass-ceramics have one or more crystalline phases and an amorphous, residual glass phase. A glass-based material (e.g., glass-based substrate) may comprise an amorphous material (e.g., glass) and optionally one or more crystalline materials (e.g., ceramic). Exemplary glass-based materials may be an alkali-free glass and/or comprise a low content of alkali metals (e.g., R₂O of about 10 mol % or less, wherein R₂O comprises Li₂O Na₂O, and K₂O). As used herein, “ceramic-based” includes both ceramics and glass-ceramics, wherein glass-ceramics have one or more crystalline phases and an amorphous, residual glass phase. In aspects, ceramic-based materials can comprise one or more oxides, nitrides, oxynitrides, carbides, borides, and/or silicides. In some aspects, the substrate 110 may be formed from man-made materials and/or naturally occurring materials (e.g., quartz, polymers, etc.). For example, in some instances, the substrate 110 may be characterized as organic and may specifically be polymeric. Examples of suitable polymers include, without limitation: thermoplastics including polystyrene (PS) (including styrene copolymers and blends), polycarbonate (PC) (including copolymers and blends), polyesters (including copolymers and blends, including polyethyleneterephthalate and polyethyleneterephthalate copolymers), polyolefins (PO) (e.g., polypropylene, polyethylene, etc.) and cyclicpolyolefins (cyclic-PO), polyvinylchloride (PVC), acrylic polymers including polymethyl methacrylate (PMMA) (including copolymers and blends), thermoplastic urethanes (TPU), polyetherimide (PEI) and blends of these polymers with each other. Other exemplary polymers include epoxy, styrenic, phenolic, melamine, and silicone resins. In some aspects, when the substrate comprises glass, any suitable glass composition can be employed. One example of a suitable glass composition includes 61-75 mol. % SiO₂; 7-15 mol. % Al₂O₃; 0-12 mol. % B₂O₃; 9-21 mol. % Na₂O; 0-4 mol. % K₂O; and 0-7 mol. % MgO; however, generally any other suitable glass-based substrate may be employed.

In some aspects, the substrate 110 may specifically exclude polymeric, plastic and/or metal materials (i.e., be substantially free of one or more of such materials). The substrate 110 may be characterized as alkali-including substrates (i.e., the substrate includes one or more alkalis). In one or more aspects, the substrate 110 exhibits a refractive index in the range from about 1.45 to about 1.55.

In some aspects, suitable substrates 110 may exhibit an elastic modulus (or Young's modulus) in the range from about 30 GPa to about 120 GPa. In some instances, the elastic modulus of the substrate may be in the range from about 30 GPa to about 110 GPa, from about 30 GPa to about 100 GPa, from about 30 GPa to about 90 GPa, from about 30 GPa to about 80 GPa, from about 30 GPa to about 70 GPa, from about 40 GPa to about 120 GPa, from about 50 GPa to about 120 GPa, from about 60 GPa to about 120 GPa, from about 70 GPa to about 120 GPa, and all ranges and sub-ranges therebetween.

In some aspects, the amorphous substrate may include glass, which may be strengthened or non-strengthened. Examples of suitable glass include soda lime glass, alkali aluminosilicate glass, alkali containing borosilicate glass and alkali aluminoborosilicate glass. In some variants, the glass may be free of Li₂O. In some aspects, the substrate 110 may include crystalline substrates such as glass ceramic substrates (which may be strengthened or non-strengthened) or may include a single crystal structure, such as sapphire. In some aspects, the substrate 110 includes an amorphous base (e.g., glass) and a crystalline cladding (e.g., sapphire layer, a polycrystalline alumina layer and/or or a spinel (MgAl₂O₄) layer).

In some aspects, the substrate 110 of any aspect may have a hardness that is less than the hardness of the overall coated article 100, or may have a hardness that is more than the hardness of the overall coated article 100, in each case as measured by the Berkovich Indenter Hardness Test described herein.

In some aspects, the substrate 110 may be substantially optically clear and transparent. In such aspects, the substrate may exhibit an average light transmittance over the optical wavelength regime (i.e., at all wavelengths between 400-700 nm) of about 85% or greater, about 86% or greater, about 87% or greater, about 88% or greater, about 89% or greater, about 90% or greater, about 91% or greater, about 92% or greater, about 93% or greater, about 94% or greater, about 95% or greater, about 96% or greater, about 97% or greater, about 98% or greater, or about 99% or greater. In one or more aspects, the substrate 110 may be opaque or exhibit an average light transmittance over the optical wavelength regime of less than about 10%, less than about 9%, less than about 8%, less than about 7%, less than about 6%, less than about 5%, less than about 4%, less than about 3%, less than about 2%, less than about 1%, or less than about 0.5%. In some aspects, these light transmittance values may be a total transmittance (taking into account transmittance on both major surfaces of the substrate) or may be observed on a single side of the substrate (i.e., on the anti-reflective surface 122 only, without taking into account the opposite surface). Unless otherwise specified, the average reflectance or transmittance of the substrate alone is measured at an incident illumination angle of 0 degrees relative to the substrate major surface 112 (however, such measurements may be provided at incident illumination angles of 45 degrees or 60 degrees). The substrate 110 may optionally exhibit a color, such as white, black, red, blue, green, yellow, orange etc.

In some aspects, the physical thickness of the substrate 110 may vary along one or more of its dimensions for aesthetic and/or functional reasons. For example, the edges of the substrate 110 may be thicker or thinner as compared to more central regions of the substrate 110, and/or one or more central region of the substrate 110 may be thicker or thinner as compared to the edges. The length, width and physical thickness dimensions of the substrate 110 may also vary according to the application or use of the coated article 100.

In some aspects, a substrate 110 may be strengthened to form a strengthened substrate. As used herein, the term “strengthened substrate” may refer to a substrate that has been chemically strengthened, for example through ion-exchange of larger ions in the substrate surface for smaller ions in, for example, a molten salt bath. However, other strengthening methods known in the art, such as thermal tempering, or utilizing a mismatch of the coefficient of thermal expansion between portions of the substrate to create compressive stress and central tension regions, may be utilized to form strengthened substrates.

In some aspects, the coated articles disclosed may be employed for protection and/or covers of displays, lenses, camera lenses, sensors, and/or light source components within or otherwise part of electronic devices, along with protection of other components (e.g., buttons, speakers, microphones, etc.). These articles with a protective function employ an optical coating disposed on a substrate such that the coated article exhibits a combination of high hardness, high damage resistance and desirable optical properties, including low single side light reflectance.

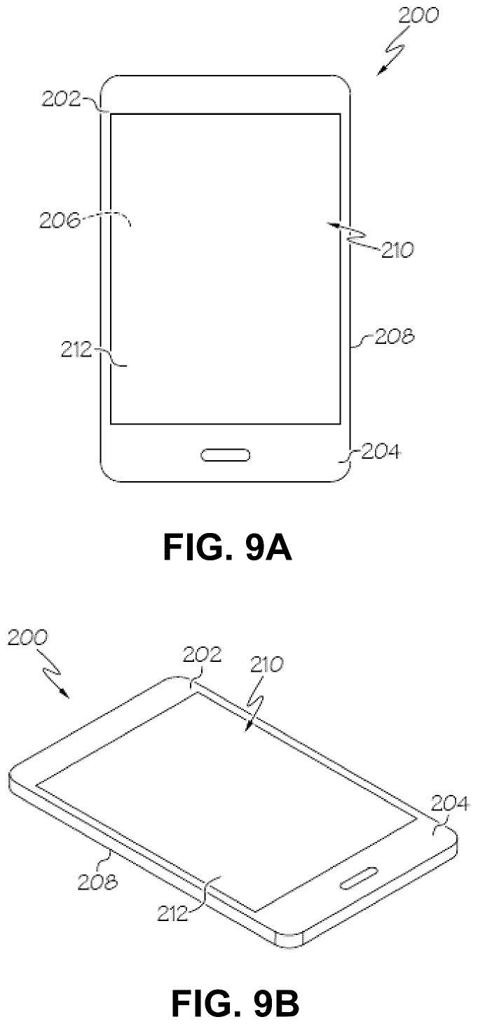

In some aspects, the coated articles disclosed herein may be incorporated into another article such as an article with a display (or display articles) (e.g., consumer electronics, including mobile phones, tablets, computers, navigation systems, and the like), architectural articles, transportation articles (e.g., automobiles, trains, aircraft, sea craft, etc.), appliance articles, or any article that requires some transparency, scratch-resistance, abrasion resistance or a combination thereof. An exemplary article incorporating any of the coated articles disclosed herein is shown in FIGS. 9A and 9B. Specifically, FIGS. 9A and 9B show a consumer electronic device 200 including a housing 202 having front 204, back 206, and side surfaces 208; electrical components (not shown) that are at least partially inside or entirely within the housing and including at least a controller, a memory, and a display 210 at or adjacent to the front surface of the housing; and a cover 212 at or over the front surface of the housing such that it is over the display. In some aspects, at least a portion of at least one of the front surface 204, the back surface 206, the cover 212, and the housing 202 may include any of the coated articles 100 described herein. In some aspects, a coated article herein can form a curved cover glass, for example, a curved cover glass having a flat major surface in the center thereof and at least one curved edge at the periphery thereof.

Referring again to FIG. 1, in some aspects the outer surfaces 109 of the optical coating at the first 105 and/or second 106 axes have, in a 2×2 μm square sample area centered on the relevant axis (e.g., first, second, third, or fourth axis, etc.), an average surface roughness Ra value (nm) of 3 or less, 2.5 or less, 2 or less, 1.5 or less, 1 or less, 0.5 or less, at least 0.5, at least 1, at least 1.5, at least 2, at least 2.5, at least 3, or any range formed from any two of the foregoing endpoints. For example, the average surface roughness Ra value (nm) at the can be 0.5-3, 0.5-2.5, 0.5-2, 0.5-1.5, 0.5-1, 1-3, 1-2.5, 1-2, 1-1.5, 1.5-3, 1.5-2.5, 1.5-2, 2-3, 2-2.5, or 2.5-3. In some aspects the outer surfaces 109 of the optical coating at the first 105 and/or second 106 axes have, in a 2×2 μm square sample area centered on the relevant axis, an average surface roughness Rq value (nm) of 3 or less, 2.5 or less, 2 or less, 1.5 or less, 1 or less, 0.5 or less, at least 0.5, at least 1, at least 1.5, at least 2, at least 2.5, at least 3, or any range formed from any two of the foregoing endpoints. For example, the average surface roughness Ra value (nm) at the can be 0.5-3, 0.5-2.5, 0.5-2, 0.5-1.5, 0.5-1, 1-3, 1-2.5, 1-2, 1-1.5, 1.5-3, 1.5-2.5, 1.5-2, 2-3, 2-2.5, or 2.5-3. Ra and Rq surface roughnesses are measured using atomic force microscopy (AFM) in a 2×2 μm square sample area centered on the relevant axis using standard software supplied with the AFM instrument.

In some aspects, after subjecting the outer surface of the optical coating to an abrasion test at positions where the first and second axes intersect with the outer surface of the optical coating, the outer surface at the positions has a water contact angle of at least X degrees, wherein the abrasion test comprises subjecting the outer surface at the positions to steel wool comprising a 1000 g load. 15 mm stroke length, 60 cycles/min, and 3500 cycles, in which X (in degrees) is at least 90, at least 95, at least 100, at least 105, at least 110, at least 115, at least 120, at least 130, at least 140, at least 150, at least 160, 160 or less, 150 or less, 140 or less, 130 or less, 120 or less, 115 or less, 110 or less, 105 or less, 100 or less, 95 or less, or any range formed from any two of the foregoing endpoints. For example, in some aspects, the water contact angle (degrees) can be 90-160, 90-150, 90-140, 90-130, 90-120, 90-115, 90-110, 90-105, 90-100, 90-95, 95-160, 95-150, 95-140, 95-130, 95-120, 95-115, 95-110, 95-105, 95-100, 100-160, 100-150, 100-140, 100-130, 100-120, 100-115, 115-160, 115-150, 115-140, 115-130, 115-120, 120-160, 120-150, 120-140, 120-130, 130-160, 130-150, 130-140, 140-160, 140-150, or 150-160. Water contact angle is measured using standard equipment and methods known in the art.

In some aspects, after subjecting the outer surface of the optical coating to CS-8 abrasion test at positions where the first and second axes intersect with the outer surface of the optical coating, the outer surface at the positions has a ASCE of less than Y %, wherein the CS-8 abrasion test comprises subjecting the outer surface at the positions to steel wool comprising a 350 g load, 50 mm stroke length, 60 cycles/min, and 1500 cycles, and in which Y % is less than 0.5, less than 0.4, less than 0.3, less than 0.2, less than 0.1, less than 0.08, less than 0.06, less than 0.04, less than 0.02, less than 0.01, at least 0.01, at least 0.02, at least 0.04, at least 0.06, at least 0.08, at least 0.1, at least 0.2, at least 0.3, at least 0.4, at least 0.5, or any range formed from any two of the foregoing endpoints. For example, in some aspects, Y % can be 0.01-0.5, 0.01-0.4, 0.01-0.3, 0.01-0.2, 0.01-0.1, 0.01-0.08, 0.01-0.06, 0.01-0.04, 0.01-0.02, 0.02-0.5, 0.02-0.4, 0.02-0.3, 0.02-0.2, 0.02-0.1, 0.02-0.08, 0.02-0.06, 0.02-0.04, 0.04-0.5, 0.04-0.4, 0.04-0.3, 0.04-0.2, 0.04-0.1, 0.04-0.08, 0.04-0.06, 0.06-0.5, 0.06-0.4, 0.06-0.3, 0.06-0.2, 0.06-0.1, 0.06-0.08, 0.08-0.5, 0.08-0.4, 0.08-0.3, 0.08-0.2, 0.08-0.1, 0.1-0.5, 0.1-0.4, 0.1-0.3, 0.1-0.2, 0.2-0.5, 0.2-0.4, 0.2-0.3, 0.3-0.5, 0.3-0.4, or 0.4-0.5. As used herein, the CS-8 abrasion test employs a commercially available CS-8 material, which comprises a rubber matrix with an alumina fine grain particle embedded therein, at the load, stroke length, cycle frequency, and cycle count specified herein. Specular component excluded (SCE) is measured before the CS-8 abrasion test and then after the CS-8 abrasion test, and a percentage change between the before and after is then calculated (“ASCE”). SCE is a measure of diffuse reflection off of the surface of the coated article, as measured using a Konica-Minolta CM700D with a 6 mm diameter aperture. Abrasion-induced damage increases the surface roughness leading to the increase in diffuse reflection (i.e., higher ASCE values). Lower ASCE values indicates less severe damage, indicative of improved abrasion resistance.

In some aspects, the optical coating 120 of curved (i.e., 3D, non-planar, etc.) coated article 100 can be formed by any suitable method. Methods of making a coated article 100 including depositing the optical coating on a major surface 102 of the substrate 110. In some aspects, the depositing comprises plasma, optionally wherein the plasma comprises oxygen plasma. For example, in some aspects, the optical coating 120 is formed by a method that does not exhibit any line-of-sight coating effects, as line-of-sight methods typically lead to coatings having a non-uniform physical thickness. In this regard, surfaces of the article directly facing the line-of-sight targets will receive more deposited material (resulting in a thicker coating), while surfaces of the article tilted at some angle relative to the line-of-sight targets (e.g., its curved surfaces) will generally receive less material, resulting in a thinner coating. This results in a coating that has physical thickness non-uniformity. To avoid such line-of-sight effects, suitable non-line-of-sight coating methods can be employed, such as, for example, atomic layer deposition (ALD), chemical vapor deposition (CVD), or a combination thereof. Plasma enhanced atomic layer deposition (PEALD) is a specific type of ALD process that can be employed. While the deposition rate of an ALD process is slower than physical vapor deposition (PVD) and chemical vapor deposition (CVD), and the choice of coating material is limited due to the limitation of the gaseous precursors, optical coatings produced using non-line-of-sight processes such as ALD produce excellent coating uniformity on curved surfaces. ALD can provide good film conformality and uniformity even for deep vias and trenches with high aspect ratios, due at least in part to the distinct characteristics of precursor separation and sequential supply. With processes such as PVD, there is a difference in thickness depending on the working distance, and it is relatively difficult to adjust the growth rate. Also, the thickness uniformity for PVD is not good on a substrate with a curved surface, and in some aspects a high aspect ratio.

In ALD-type deposition processes, one or more gaseous precursors are introduced to a chamber containing the substrate to be coated, and such precursors react and deposit on the substrate surface in a uniform manner one atomic layer at a time. In some aspects, suitable gaseous precursors comprise diisopropylamino trisilylamine (ORTHRUS, commercially available from Air Liquide), tetrakis(ethylmethylamido)zirconium(IV) (TEMAZr), trimethylamine, bis-diethylamino silane, tris(dimethylamino)silane, di-isopropylamino silane, bis(tertiarybutylamino) silane, tetraethyl orthosilicate, tetrakis(ethylmethylamino) zirconium, cyclopentadienyl tris(dimethylamino) zirconium, tri-methyl aluminum (TMA), or any combination thereof. Precursors are selected so as to achieve a desired layer composition, such as a layer of SiO₂, a layer of Al₂O₃, a layer of ZrO₂, and so forth. By way of example, ORTHRUS and O₂ plasma provide a SiO₂ layer, TMA and O₂ plasma provide a Al₂O₃ layer, and TEMAZr and O₂ plasma provide a ZrO₂ layer. In some aspects, the one or more gaseous precursors are introduced in a carrier gas. In some aspects, the carrier gas comprises nitrogen, argon, or a combination thereof.

In some aspects, the temperature of the coating process can be performed at any suitable temperature. In some aspects, the temperature (° C.) is 320 or less, 300 or less, 280 or less, 260 or less, 240 or less, 220 or less, 200 or less, 180 or less, 160 or less, 140 or less, 120 or more, 140 or more, 160 or more, 180 or more, 200 or more, 220 or more, 240 or more, 260 or more, 280 or more, 300 or more, or any combination of two or more of the foregoing endpoints. For example, in some aspects, the temperature (° C.) is 120-320, 120-300, 120-280, 120-260, 120-240, 120-220, 120-200, 120-180, 120-160, 120-140, 140-320, 140-300, 140-280, 140-260, 140-240, 140-220, 140-200, 140-180, 140-160, 160-320, 160-300, 160-280, 160-260, 160-240, 160-220, 160-200, 160-180, 180-320, 180-300, 180-280, 180-260, 180-240, 180-220, 180-200, 200-320, 200-300, 200-280, 200-260, 200-240, 200-220, 220-320, 220-300, 220-280, 220-260, 220-240, 240-320, 240-300, 240-280, 240-260, 260-320, 260-300, 260-280, 280-320, 280-300, or 300-320. In some aspects, keeping the temperature lower, such as less than 300° C., or even less than 260° C., is especially useful for substrates that lose intrinsic properties at higher temperatures (e.g., loss of chemical strengthening characteristics, change of Young's modulus, and so forth).

In some aspects, precursors gases and plasma are directed through a metal mesh positioned between the plasma source and the substrate so as to prevent the plasma from being directly applied to the substrate to protect thin film coatings from plasma damage.

In some aspects, the depositing comprises alternately depositing at least one high RI layer and at least one low RI layer on the major surface of the substrate to build up an optical coating.

In some aspects, the method comprising depositing an optical coating comprising a nanolaminate comprising ZrO₂ and Al₂O₃. In some aspects, the nanolaminate comprises alternating layers of Al₂O₃ and ZrO₂. In some aspects, the alternating layers of Al₂O₃ and ZrO₂ in the nanolaminate comprise Al₂O₃ layers that are thinner than the ZrO₂ layers. In some aspects, when the nanolaminate is deposited by atomic layer deposition, the method can be expressed as the number of unit cycles employed to form ZrO₂ compared to the number of unit cycles employed to form Al₂O₃. For example, the ratio of ZrO₂ unit cycles to Al₂O₃ unit cycles can be X:1, in which X is 5-15, 5-14, 5-13, 5-12, 5-11, 5-10, 5-9, 5-8, 5-7, 5-6, 6-15, 6-14, 6-13, 6-12, 6-11, 6-10, 6-9, 6-8, 6-7, 7-15, 7-14, 7-13, 7-12, 7-11, 7-10, 7-9, 7-8, 8-15, 8-14, 8-13, 8-12, 8-11, 8-10, 8-9, 9-15, 9-14, 9-13, 9-12, 9-11, 9-10, 10-15, 10-14, 10-13, 10-12, 10-11, 11-15, 11-14, 11-13, 11-12, 12-15, 12-14, 12-13, 13-15, 13-14, or 14-15. The number of unit cycles for forming layers of each of ZrO₂ and Al₂O₃ in a nanolaminate can also be expressed as an absolute number of unit cycles, such as 20-2000 unit cycles for forming ZrO₂ and 2-200 unit cycles for forming Al₂O₃, or any ranges therebetween. The number unit cycles determines the overall physical thickness of the nanolaminate, as well as the physical thicknesses of each sublayer of ZrO₂ and each sublayer of Al₂O₃. For example, the absolute number of unit cycles for forming ZrO₂ can be at least 20, at least 25, at least 30, at least 40, at least 50, at least 60, at least 70, at least 80, at least 90, at least 100, at least 110, at least 120, at least 130, at least 140, at least 150, at least 180, at least 200, at least 300, at least 400, at least 500, at least 750, at least 1000, at least 1250, at least 1500, at least 1750, 2000 or less, 1750 or less, 1500 or less, 1250 or less, 1000 or less, 750 or less, 500 or less, 400 or less, 300 or less, 200 or less, 180 or less, 150 or less, 140 or less, 130 or less, 120 or less, 110 or less, 100 or less, 90 or less, 80 or less, 70 or less, 60 or less, 50 or less, 40 or less, 30 or less, 25 or less, or any range formed from any two of the foregoing endpoints, such as 25-200, 40-200, 50-150, 70-100, and so forth. And, for example, the absolute number of unit cycles for forming Al₂O₃ can be at least 1, at least 2, at least 3, at least 4, at least 5, at least 6, at least 7, at least 8, at least 9, at least 10, at least 15, at least 20, at least 25, at least 30, at least 40, at least 50, at least 75, at least 100, at least 125, at least 150, at least 175, 200 or less, 175 or less, 150 or less, 125 or less, 100 or less, 75 or less, 50 or less, 40 or less, 30 or less, 25 or less, 20 or less, 15 or less, 10 or less, 9 or less, 8 or less, 7 or less, 6 or less, 5 or less, 4 or less, 3 or less, 2 or less, or any range formed from any two of the foregoing endpoints, such as 1-25, 1-50, 3-15, 5-10, 5-7, and so forth. In aspects, each unit cycle deposits about 0.1 nm of physical thickness of a material. In some aspects, the method of forming the nanolaminate, or the nanolaminate itself, can be characterized by the ratio of ZrO₂ unit cycles to the sum of Al₂O₃+ZrO₂ unit cycles, and such ratio can be X:1 in which X is 0.5-1, 0.5-0.9, 0.5-0.8, 0.5-0.7, 0.5-0.6, 0.6-1, 0.6-0.9, 0.6-0.8, 0.6-0.7, 0.7-1, 0.7-0.9, 0.7-0.8, 0.8-1, 0.8-0.9, 0.9-1, or 1:1. The maximum this ratio can be is 1:1 since when 100% ZrO₂ cycles are employed and there are no Al₂O₃ cycles, the ratio is 1:1. As a specific example, for a 50 nm total physical thickness nanolaminate of ZrO₂ and Al₂O₃, the unit cycles for forming ZrO₂ and Al₂O₃ can be 50 and 5, 70 and 7, or 100 and 10, respectively (i.e., ratios of 10:1 of ZrO₂:Al₂O₃, and a ratio of ZrO₂:(Al₂O₃+ZrO₂) of 0.9:1. As used herein, a “unit cycle” means a series of four ALD deposition steps consisting of (1) precursor pulse, (2) precursor purge, (3) reactant pule, and (4) reactant purge, as would be understood in the art.

In some aspects, the nanolaminate comprises sublayers of Al₂O₃ each having a physical thickness of, for example, 0.1-5 nm, and sublayers of ZrO₂ each having a physical thickness of, for example, 5-100 nm. For example, in some aspects, the physical thickness (nm) of Al₂O₃ sublayers can be 0.1-5, 0.1-4.5, 0.1-4, 0.1-3.5, 0.1-3, 0.1-2.5, 0.1-2, 0.1-1.5, 0.1-1, 0.1-0.8, 0.1-0.6, 0.1-0.4, 0.1-0.2, 0.2-5, 0.2-4.5, 0.2-4, 0.2-3.5, 0.2-3, 0.2-2.5, 0.2-2, 0.2-1.5, 0.2-1, 0.2-0.8, 0.2-0.6, 0.2-0.4, 0.4-5, 0.4-4.5, 0.4-4, 0.4-3.5, 0.4-3, 0.4-2.5, 0.4-2, 0.4-1.5, 0.4-1, 0.4-0.8, 0.4-0.6, 0.6-5, 0.6-4.5, 0.6-4, 0.6-3.5, 0.6-3, 0.6-2.5, 0.6-2, 0.6-1.5, 0.6-1, 0.6-0.8, 0.8-5, 0.8-4.5, 0.8-4, 0.8-3.5, 0.8-3, 0.8-2.5, 0.8-2, 0.8-1.5, 0.8-1, 1-5, 1-4.5, 1-4, 1-3.5, 1-3, 1-2.5, 1-2, 1-1.5, 1.5-5, 1.5-4.5, 1.5-4, 1.5-3.5, 1.5-3, 1.5-2.5, 1.5-2, 2-5, 2-4.5, 2-4, 2-3.5, 2-3, 2-2.5, 2.5-5, 2.5-4.5, 2.5-4, 2.5-3.5, 2.5-3, 3-5, 3-4.5, 3-4, 3-3.5, 3.5-5, 3.5-4.5, 3.5-4, 4-5, 4-4.5, or 4.5-5. For example, in some aspects, the physical thickness (nm) of ZrO₂ sublayers can be 5-100, 5-90, 5-80, 5-70, 5-60, 5-50, 5-40, 5-30, 5-20, 5-10, 10-100, 10-90, 10-80, 10-70, 10-60, 10-50, 10-40, 10-30, 10-20, 20-100, 20-90, 20-80, 20-70, 20-60, 20-50, 20-40, 20-30, 30-100, 30-90, 30-80, 30-70, 30-60, 30-50, 30-40, 40-100, 40-90, 40-80, 40-70, 40-60, 40-50, 50-100, 50-90, 50-80, 50-70, 50-60, 60-100, 60-90, 60-80, 60-70, 70-100, 70-90, 70-80, 80-100, 80-90, or 90-100. In aspects, the physical thickness of each Al₂O₃ sublayer is relatively thinner than each ZrO₂ sublayer. In aspects, the ZrO₂ and Al₂O₃ are in amorphous form. In aspects, the nanolaminate is substantially free of ZrO₂ crystallites.

In some aspects, a typical line-of-sight coating method, such as sputtering (e.g., reactive sputtering), physical vapor deposition, solution dipping, and so forth, may additionally or alternatively be employed under conditions that do not significantly result in a non-uniform physical thickness (e.g., by specifically controlling substrate orientation, substrate movement during process, coating source movement during process, coating time, coating temperature, and so forth).

Various aspects are contemplated herein, several of which are set forth in the paragraphs below. It is explicitly contemplated that any aspect or portion thereof can be combined to form a combination. The phrase “any other aspect herein” means any numbered aspect herein, or any aspect or aspects disclosed elsewhere herein.

Aspect 1. A coated article, comprising:
a substrate having a major surface, the major surface comprising a first portion and a second portion, wherein a first axis that is normal to the first portion of the major surface is not equal to a second axis that is normal to the second portion of the major surface, and the angle between the first axis and the second axis is at least 40 degrees; and
an optical coating disposed on at least the first portion and the second portion of the major surface, the optical coating having an inner surface facing the substrate and an outer surface opposite the inner surface;
wherein:
the optical coating at the first and second portions has a physical thickness uniformity of less than 10%, the physical thickness uniformity calculated as [(t_max−t_min)/(t_max+t_min)]×100, wherein t_max is a maximum physical thickness of the optical coating measured at the first and second portions along the first and second axes, respectively, and t_min is a minimum physical thickness of the optical coating measured at the first and second portions along the first and second axes, respectively;
the coated article at the first and second portions has a first single side light reflectance and a second single side light reflectance, respectively, as measured from the outer surface of the optical coating at an incident angle of 5 degrees relative to the first and second axes, respectively, that are less than 1% at all wavelengths between 500 nm and 800 nm; and
the coated article at least one of the first and second portions has a hardness of at least 7 GPa at indentation depths of 50-250 nm as measured from the outer surface of the optical coating at the first and second portions along the first and second axes, respectively, by a Berkovich Indenter Hardness Test.

Aspect 2. The coated article of any preceding aspect, or any other aspect herein, wherein the physical thickness uniformity at the first and second portions is less than 5%.

Aspect 3. The coated article of any preceding aspect, or any other aspect herein, wherein the coated article has at least one of:
a hardness of at least 9 GPa at an indentation depth of 100 nm as measured from the outer surface of the optical coating at the first and second portions along the first and second axes, respectively, by a Berkovich Indenter Hardness Test;
a hardness of at least 8 GPa at an indentation depth of 500 nm as measured from the outer surface of the optical coating at the first and second portions along the first and second axes, respectively, by a Berkovich Indenter Hardness Test.

Aspect 4. The coated article of any preceding aspect, or any other aspect herein, wherein the first single side light reflectance and the second single side light reflectance are less than 0.5% at all wavelengths between 500 nm and 800 nm.

Aspect 5. The coated article of any preceding aspect, or any other aspect herein, comprising at least one of:
the outer surfaces of the optical coating at the first and second axes have an average surface roughness Ra value of less than 3 nm;
the outer surfaces of the optical coating at the first and second axes have an average surface roughness Rq value of less than 3 nm.

Aspect 6. The coated article of any preceding aspect, or any other aspect herein, wherein, after subjecting the outer surface of the optical coating to an abrasion test at positions where the first and second axes intersect with the outer surface of the optical coating, the outer surface at the positions has a water contact angle of at least 90 degrees, wherein the abrasion test comprises subjecting the outer surface at the positions to steel wool comprising a 1000 g load, 15 mm stroke length, 60 cycles/min, and 3500 cycles.

Aspect 7. The coated article of any preceding aspect, or any other aspect herein, wherein, after subjecting the outer surface of the optical coating to CS-8 abrasion test at positions where the first and second axes intersect with the outer surface of the optical coating, the outer surface at the positions has a ASCE of less than 0.1%, wherein the CS-8 abrasion test comprises subjecting the outer surface at the positions to steel wool comprising a 350 g load, 50 mm stroke length, 60 cycles/min, and 1500 cycles.

Aspect 8. The coated article of any preceding aspect, or any other aspect herein, wherein the angle between the first axis and the second axis is at least at least 75 degrees.

Aspect 9. The coated article of any preceding aspect, or any other aspect herein, wherein the angle between the first axis and the second axis is 180 degrees or less.

Aspect 10. The coated article of any preceding aspect, or any other aspect herein, wherein the second portion comprises a concave portion of the major surface.

Aspect 11. The coated article of any preceding aspect, or any other aspect herein, wherein the second portion comprises a convex portion of the major surface.

Aspect 12. The coated article of any preceding aspect, or any other aspect herein, wherein:
the major surface further comprises a third portion, the optical coating is disposed on the third portion, a third axis that is normal to the third portion of the major surface is not equal to the first or second axes, and the angle between the third axis and the first axis is at least 60 degrees; and
at least one of the following is satisfied:
   the optical coating at the first, second, and third portions has a physical thickness uniformity of less than 25%, the physical thickness uniformity calculated as [(t_max−t_min)/(t_max+t_min)]×100, wherein t_max is a maximum physical thickness of the optical coating measured at the first, second, and third portions along the first, second, and third axes, respectively, and t_min is a minimum physical thickness of the optical coating measured at the first, second, and third portions along the first, second, and third axes, respectively;
   the coated article at the third portion has a third single side light reflectance as measured from the outer surface of the optical coating at an incident angle of 5 degrees relative to the third axis that is less than 1% at all wavelengths between 500 nm and 800 nm;
   the coated article at the third portion has a hardness of at least 7 GPa at indentation depths of 50-250 nm as measured from the outer surface of the optical coating at the third portion along the third axis by a Berkovich Indenter Hardness Test.

Aspect 13. The coated article of aspect 12, or any other aspect herein, wherein at least one of the following is satisfied:
the coated article at the third portion has a hardness of at least 9 GPa at an indentation depth of 100 nm as measured from the outer surface of the optical coating at the third portion along the third axis by a Berkovich Indenter Hardness Test;
the coated article at the third portion has a hardness of at least 8 GPa at an indentation depth of 500 nm as measured from the outer surface of the optical coating at the third portion along the third axis by a Berkovich Indenter Hardness Test

Aspect 14. The coated article of any preceding aspect, or any other aspect herein, wherein the optical coating comprises at least one high refractive index (RI) layer and at least one low RI layer.

Aspect 15. The coated article of aspect 14, or any other aspect herein, wherein a high RI layer in the at least one high RI layer and a low RI layer in the at least one low RI layer are adjacent and define a period N, wherein N is from 2 to 12.

Aspect 16. The coated article of aspect 14 or 15, or any other aspect herein, wherein the at least one high RI layer comprises SiᵤAlᵥOₓN_{y}, Ta₂O₅, Nb₂O₅, AlN, Si₃N₄, AlOₓN_{y}, SiOₓN_{y}, HfO₂, TiO₂, ZrO₂, Y₂O₃, Al₂O₃, MoO₃, diamond-like carbon, or any combination thereof, wherein subscripts “u,” “v,” “x,” and “y” are independently selected from 0 to 1.

Aspect 17. The coated article of any one of aspects 14-16, or any other aspect herein, wherein the at least one low RI layer comprises SiO₂, Al₂O₃, GeO₂, SiO, AlOₓN_{y}, SiOₓNᵤ, SiAlₓO_{y}, SiᵤAlᵥOₓN_{y}, MgO, MgAl₂O₄, MgF₂, BaF₂, CaF₂, DyF₃, YbF₃, CeF₃, AlF₃, or any combination thereof, wherein subscripts “u,” “v,” “x,” and “y” are independently selected from 0 to 1.

Aspect 18. The coated article of any one of aspects 14-17, or any other aspect herein, wherein the at least one high RI layer comprises ZrO₂, and the at least one low RI layer comprises SiO₂.

Aspect 19. The coated article of any one of aspects 14-18, or any other aspect herein, wherein the at least one high RI layer comprises ZrO₂ and Al₂O₃, and the at least one low RI layer comprises SiO₂.

Aspect 20. The coated article of any one of aspects 14-19, or any other aspect herein, wherein the at least one high RI layer comprises a nanolaminate comprising ZrO₂ and Al₂O₃, wherein the nanolaminate comprises alternating layers of Al₂O₃ and ZrO₂, and the Al₂O₃ layers in the nanolaminate are thinner than the ZrO₂ layers in the nanolaminate.

Aspect 21. The coated article of any one of aspects 14-20, or any other aspect herein, wherein the optical coating comprises one or more high RI layers having a physical thickness of 5 nm to 150 nm, and/or one or more low RI layers having a physical thickness of 5 nm to 150 nm.

Aspect 22. The coated article of any one of aspects 14-21, or any other aspect herein, wherein the optical coating comprises alternating layers of a high refractive index (RI) layer and a low RI layer.

Aspect 23. The coated article of any preceding aspect, or any other aspect herein, wherein the optical coating has a physical thickness of 100 nm to 1000 nm.

Aspect 24. The coated article of any one of aspects 20-23, or any other aspect herein, wherein the optical coating comprises SiO₂ and the nanolaminate, and a combined physical thickness of SiO₂ is 100 nm to 300 nm, and a total physical thickness of the nanolaminate is 75 nm to 200 nm.

Aspect 25. The coated article of any preceding aspect, or any other aspect herein, further comprising a surface-modifying layer disposed on the outer surface of the optical coating.

Aspect 26. The coated article of any preceding aspect, or any other aspect herein, wherein the coated article is a cover glass or a lens.

Aspect 27. A consumer electronic product, comprising:
a housing having a front surface, a back surface and side surfaces;
electrical components provided at least partially within the housing, the electrical components including at least a controller, a memory, and a display, the display being provided at or adjacent the front surface of the housing; and
wherein the front surface, the back surface, the display, or any combination thereof comprises one or more of the coated articles of any preceding aspect, or any other aspect herein.

Aspect 28. A method of making the coated article of any preceding aspect, or any other aspect herein, the method comprising:
depositing the optical coating on the major surface of the substrate.

Aspect 29. The method of aspect 28, or any other aspect herein, wherein the depositing comprises atomic layer deposition, chemical vapor deposition, or a combination thereof.

Aspect 30. The method of aspect 28 or 29, or any other aspect herein, wherein the depositing comprises atomic layer deposition comprising capacitively coupled plasma type plasma enhanced atomic layer deposition (PEALD).

Aspect 31. The method of any one of aspects 28-30, or any other aspect herein, wherein the depositing comprises gaseous precursors comprising diisopropylamino trisilylamine, tetrakis(ethylmethylamido)zirconium(IV), trimethylamine, bis-diethylamino silane, tris(dimethylamino)silane, di-isopropylamino silane, bis(tertiarybutylamino) silane, tetraethyl orthosilicate, tetrakis(ethylmethylamino) zirconium, cyclopentadienyl tris(dimethylamino) zirconium, tri-methyl aluminum, or any combination thereof.

Aspect 32. The method of aspect 31, or any other aspect herein, wherein the gaseous precursors are introduced using a carrier gas comprising nitrogen gas.

Aspect 33. The method of any one of aspects 28-32, or any other aspect herein, wherein the depositing comprises plasma, optionally wherein the plasma comprises oxygen plasma.

Aspect 34. The method of aspect 32 or 33, or any other aspect herein, wherein the depositing comprises oxygen plasma, and the carrier gas comprising nitrogen gas is paused during an oxygen plasma pulse.

Aspect 35. The method of aspect 33 or 34, or any other aspect herein, wherein the plasma is directed through a metal mesh prior to contacting the major surface and/or the optical coating during formation thereof.

Aspect 36. The method of any one of aspects 28-35, or any other aspect herein, wherein the depositing is performed at a temperature of 300° C. or less.

Aspect 37. The method of any one of aspects 28-36, or any other aspect herein, wherein the depositing comprises alternately depositing at least one high refractive index (RI) layer and at least one low RI layer on the major surface.

Aspect 38. The method of any one of aspects 28-37, or any other aspect herein, wherein:
the optical coating comprises a nanolaminate comprising ZrO₂ and Al₂O₃;
the nanolaminate comprises alternating layers of Al₂O₃ and ZrO₂, wherein the Al₂O₃ layers in the nanolaminate are thinner than the ZrO₂ layers in the nanolaminate.

Aspect 39. The method of aspect 38, or any other aspect herein, wherein:
deposition of ZrO₂ comprises 25-200 cycles using atomic layer deposition; and
deposition of Al₂O₃ comprises 1-50 cycles using atomic layer deposition.

Aspect 40. The method of aspect 39, or any other aspect herein, wherein a ratio of ZrO₂ cycles to Al₂O₃+ZrO₂ cycles is 0.7:1 to 1:1.

Aspect 41. The method of any one of aspects 38-40, or any other aspect herein, wherein each Al₂O₃ layer in the nanolaminate is 0.11-5 nm thick.

Aspect 42. A coated article, comprising:
a substrate having a major surface, the major surface comprising a first portion and a second portion, wherein a first axis that is normal to the first portion of the major surface is not equal to a second axis that is normal to the second portion of the major surface, and the angle between the first axis and the second axis is at least 40 degrees; and
an optical coating disposed on at least the first portion and the second portion of the major surface, the optical coating having an inner surface facing the substrate and an outer surface opposite the inner surface;
wherein:
the optical coating at the first and second portions has a physical thickness uniformity of less than 10%, the physical thickness uniformity calculated as [(t_max−t_min)/(t_max+t_min)]×100, wherein t_max is a maximum physical thickness of the optical coating measured at the first and second portions along the first and second axes, respectively, and t_min is a minimum physical thickness of the optical coating measured at the first and second portions along the first and second axes, respectively;
the optical coating at the first and second portions has a physical thickness of 100 nm to 1000 nm;
the optical coating comprises alternating layers of at least one high refractive index (RI) layer and at least one low RI layer;
the at least one high RI layer comprises SiᵤAlᵥOₓN_{y}, Ta₂O₅, Nb₂O₅, AlN, Si₃N₄, AlOₓN_{y}, SiOₓN_{y}, HfO₂, TiO₂, ZrO₂, Y₂O₃, Al₂O₃, MoO₃, diamond-like carbon, or any combination thereof, wherein subscripts “u,” “v,” “x,” and “y” are independently selected from 0 to 1; and
the at least one low RI layer comprises SiO₂, Al₂O₃, GeO₂, SiO, AlOₓN_{y}, SiOₓNᵤ, SiAlₓO_{y}, SiᵤAlᵥOₓN_{y}, MgO, MgAl₂O₄, MgF₂, BaF₂, CaF₂, DyF₃, YbF₃, CeF₃, AlF₃, or any combination thereof, wherein subscripts “u,” “v,” “x,” and “y” are independently selected from 0 to 1.

Aspect 43. The coated article of aspect 42, or any other aspect herein, comprising at least one of:
the outer surfaces of the optical coating at the first and second axes have an average surface roughness Ra value of less than 3 nm;
the outer surfaces of the optical coating at the first and second axes have an average surface roughness Rq value of less than 3 nm.

Aspect 44. The coated article of aspect 42 or 43, or any other aspect herein, wherein the at least one high RI layer comprises ZrO₂, and the at least one low RI layer comprises SiO₂.

Aspect 45. The coated article of any one of aspects 42-44, or any other aspect herein, wherein the at least one high RI layer comprises ZrO₂ and Al₂O₃, and the at least one low RI layer comprises SiO₂.

Aspect 46. The coated article of any one of aspects 42-45, or any other aspect herein, wherein the at least one high RI layer comprises a nanolaminate comprising ZrO₂ and Al₂O₃, wherein the nanolaminate comprises alternating layers of Al₂O₃ and ZrO₂, and the Al₂O₃ layers in the nanolaminate are thinner than the ZrO₂ layers in the nanolaminate.

Aspect 47. The coated article of any one of aspects 42-46, or any other aspect herein, wherein the optical coating comprises one or more high RI layers having a physical thickness of 5 nm to 150 nm, and/or one or more low RI layers having a physical thickness of 5 nm to 150 nm.

Aspect 48. The coated article of any one of aspects 42-47, or any other aspect herein, wherein the angle between the first axis and the second axis is at least at least 75 degrees.

Aspect 49: A combination of any two or more preceding aspects or any portion(s) thereof.

### EXAMPLES

The following examples illustrate non-limiting aspects of the disclosure and are not intended to be limiting on the scope of the disclosure or claims.

Example 1: This example demonstrates the preparation and resulting properties of coated articles in accordance with the disclosures herein, which generally have excellent physical thickness uniformities and other desirable properties such as high hardness and low reflectance, as compared to comparative articles prepared via a PVD process that do not have good physical thickness uniformities or other desired properties.

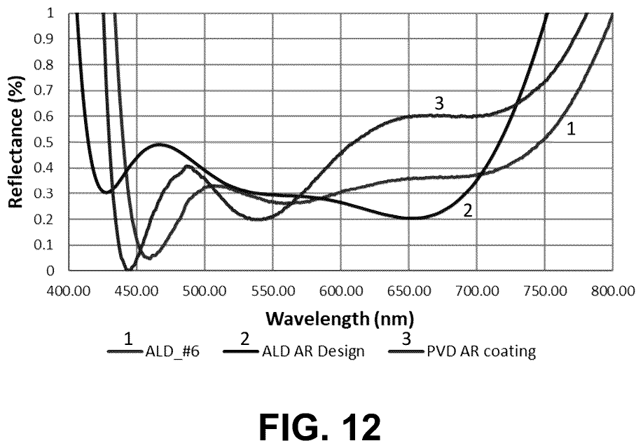

Coated articles schematically shown below in Table 1 and Table 2 represent target structures for preparation by ALD (TFS-500, Beneq, Table 1) and PVD (mid-frequency (MF) magnetron sputtering, Table 2). For the ALD target structure, FIG. 12 shows the calculated reflectance for the Table 1 design (“ALD AR Design”), whereas “ALD_#6” is the structure actually prepared by ALD that had the closest optical properties relative to the target structure of Table 1, as discussed elsewhere herein. Layers were to be deposited on a glass substrate. ZrO₂ was chosen as a high index material and SiO₂ chosen as the low index material. In the nanolaminate, thin (˜0.1-5 nm) amorphous layers of Al₂O₃ were interspersed between thicker ZrO₂ layers to act as a blocking layer to prevent crystalline growth of the ZrO₂ layers. In Table 2. Nb₂O₅ was employed as the high index layer and SiO₂ as the low index layer.

TABLE 1
Schematic depiction of coated article prepared using ALD

| Layer # | Material | Thickness (nm) |
|---|---|---|
| 7 | SiO₂ | 95.2 |
| 6 | ZrO₂ + Al₂O₃ Nanolaminate | 55.5 |
| 5 | SiO₂ | 10.3 |
| 4 | ZrO₂ + Al₂O₃ Nanolaminate | 52.4 |
| 3 | SiO₂ | 42.2 |
| 2 | ZrO₂ + Al₂O₃ Nanolaminate | 14.1 |
| 1 | SiO₂ | 25 |

SUBSTRATE

TABLE 2
Schematic depiction of coated article prepared using PVD

| Layer # | Material | Thickness (nm) |
|---|---|---|
| 7 | SiO₂ | 104 |
| 6 | Nb₂O₅ | 31.8 |
| 5 | SiO₂ | 29.7 |
| 4 | Nb₂O₅ | 35.1 |
| 3 | SiO₂ | 48.9 |
| 2 | Nb₂O₅ | 12.1 |
| 1 | SiO₂ | 25 |

SUBSTRATE

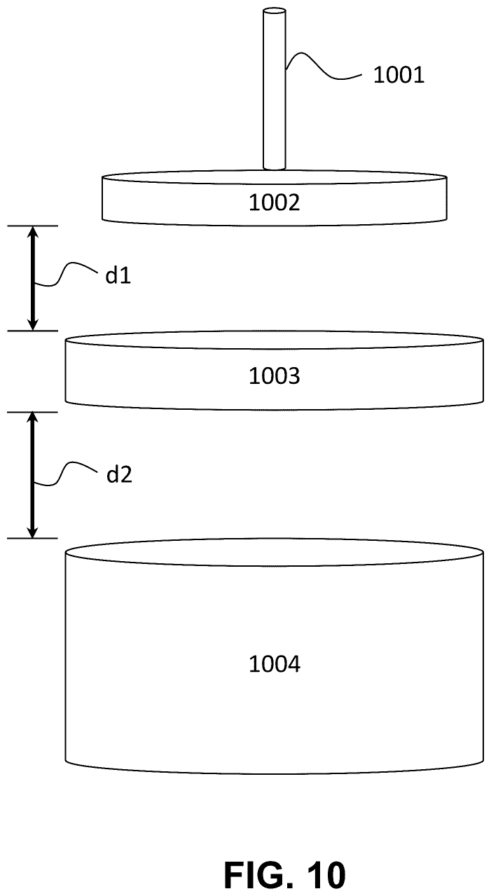

The ALD process employed capacitively coupled plasma (CCP) type plasma enhanced ALD (PEALD), which can provide a coating at relatively low temperature compared with thermal type ALD processes. In the case of certain substrates, such as certain glass substrates, issues such as loss of intrinsic properties can occur when the coating process is performed at high temperature. As a result, it is desirable in some cases to employ a coating process at a relatively low temperature such that intrinsic properties of the substrate are not lost or undesirably reduced as a result of the high temperature. PEALD allows a greater variety of substrates to be used because relatively low temperature (<300° C.) are employed. A schematic diagram of ALD is shown in FIG. 10, in which plasma is fed through inlet 1001 and dispersed through showerhead 1002. The plasma continues through mesh 1003, which can be a metal mesh, and which prevents plasma from being directly applied to substrates (not shown) that are set on substrate holder 1004. Such a mesh 1003 helps protect the coatings on the coated articles from damage. The distance d1 between showerhead and mesh 1003 can be, for example, 15-35 mm, 20-30 mm, or about 25 mm, and the distance d2 between mesh and the surface of holder 1004 can be, for example, 10-30 mm, 15-25 mm, or about 18 mm. The dimensions of substrates can be any suitable dimensions, such as a hemispherical rod with a radius of, for example, 1-40 mm, 1-10 mm, or about 5 mm, or a flat substrate having a thickness of, for example, 0.2-4 mm, 0.3-2 mm, or 0.4-0.6 mm (e.g., about 0.55 mm).

For the high refractive index ZrO₂+Al₂O₃ nanolaminate coating, TEMAZr and O₂ plasma were used to coat ZrO₂, and TMA and O₂ plasma were used for Al₂O₃ coating as described elsewhere herein. Low refractive index SiO₂ was coated using diisopropylamino trisilylamine (ORTHUS, available from Air Liquide) and O₂ plasma.

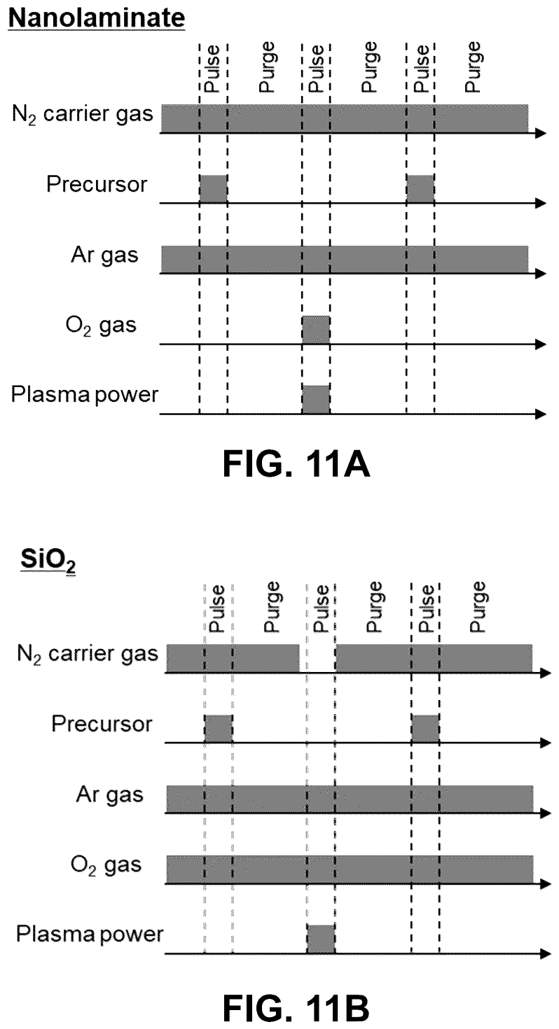

Experimental conditions employed in the examples herein are shown in Table 3, with the pulse/purge cycling shown schematically in FIG. 11A and FIG. 11B. In particular, FIG. 11A depicts the pulse/purse cycling to produce a layer of the ZrO₂+Al₂O₃ nanolaminate, and FIG. 11B depicts the pulse/purge cycling to produce a layer of SiO₂, so as to produce the coated article depicted in Table 1.

TABLE 3

| | | | | N₂ gas flow rate | | | | Plasma |
|---|---|---|---|---|---|---|---|---|
| Coating | Precursor | | | A | B | Chamber | Reactor | Power |
| Material | Name | Temp.(° C.) | Reactant | (SCCM) | (SCCM) | (SCCM) | (SCCM) | (W) |
| ZrO₂ | TEMAZr | 90 | O₂ plasma | 200 | 50 | 400 | 50 | 250 |
| Al₂O₃ | TMA | 20 | O₂ plasma | 50 | 100 | 400 | 50 | 250 |
| SiO₂ | Orthrus | 80 | O₂ plasma | 100 | 100 | 200 | 200 | 250 |

| | Plasma gas | | Process | Cycle time | | | | Reactor |
|---|---|---|---|---|---|---|---|---|
| Coating | Ar | O₂ | Temp. | Precursor | Purge | Reactant | Purge | pressure |
| Material | (SCCM) | (SCCM) | (° C.) | pulse (s) | (s) | pulse (s) | (s) | (mbar) |
| ZrO₂ | 50 | 20 | 250 | 1.0 | 10.0 | 5.0 | 10.0 | 1.15 |
| Al₂O₃ | 40 | 20 | 250 | 0.2 | 3.0 | 2.0 | 3.0 | 1.10 |
| SiO₂ | 40 | 20 | 250 | 2.0 | 3.0 | 7.0 | 10 | 1.13 |

The ALD processes to produce the layer of ZrO₂+Al₂O₃ nanolaminate and the layer of SiO₂ were different. During the nanolaminate processes, oxygen gas was only pulsed during plasma stage. For the SiO₂ process, N₂ carrier gas was not injected during plasma stage so as to avoid inclusion of nitrogen atoms in the SiO₂ layer, which also has a benefit of providing increased hardness.

A PVD AR film was used as a comparative reference. In the case of MF magnetron sputtering, like other magnetron sputtering PVD processes, the deposition rate is higher than ALD, and the impurity content is low due to coating process in high vacuum. The PVD coating process was performed on the same substrates as ALD. The experimental conditions of PVD process were shown in Table 4.

TABLE 4

| | | | | | | Base | Working |
|---|---|---|---|---|---|---|---|
| | | Power | Freq. | O₂ | Ar | Pressure | Pressure |
| Coating | Target | (kW) | (kHz) | (sccm) | (sccm) | (Torr) | (Torr) |
| SiO₂ | SiB target | 5 | 35 | 220 | 1000 | 1.33e−06 | 4.65e−03 |
| Nb₂O₅ | NbOₓ target | 5 | 60 | 55 | 1000 | 1.33e−06 | 4.65e−03 |

For the 3D substrates, a hemisphere (i.e., a flat bottom with a hemispherical upper surface) with a diameter of 10 mm, and a half quartz rod (i.e., hemispherical quartz rod, which is effectively an elongated hemisphere) with a diameter of 10 mm and a length of 30 mm were employed. Other contemplated substrates include any 3D substrate, such as a curved phone cover glass and an eyeglass lens, for example. In addition, a flat glass substrate was also coated and tested for optical and mechanical property analysis, the flat glass substrate comprised 64-70 mol. % SiO₂, 2-6 mol. % B₂O₃, 10-15 mol. % Al₂O₃, 10-15 mol. % Na₂O, 0-5 mol. % K₂O, and 1-6 mol. % MgO; however, other substrates can be suitably employed, such as ceramics, glass-ceramics, different glass compositions, etc.

Reflectance on the curved surface of the half quartz rod and the hemisphere was measured by micro-spot reflectometer with a rotational jig. Since it is sometimes challenging to conduct surface analysis and mechanical tests on curved surfaces, flat substrates were used for surface roughness measurement by AFM, hardness by nanoindenter, delamination test, CS-8 abrasion test (load 350 g, stroke length 50 mm, stroke speed 60 cycles/min, abrasion cycles 1500), and steel wool abrasion (load 1000 g, stroke length 15 mm, stroke speed 60 cycles/min, abrasion cycles 3500). All analyses, except for reflectance measurement, were performed after depositing an easy-to-clean (ETC) or anti-fingerprint coating. Water contact angles (WCAs) were then measured before and after rubbing with steel wool as described herein.

By controlling the ALD cycles of each layer, AR films were coated onto curved substrates. As shown in Table 5, eight experiments were conducted to obtain optical coatings, with a goal of achieving the target structure shown in Table 1. Total thickness shown in Table 5 is an estimated thickness from optical properties. Experiment #6 was closest to the target Table 1 structure in terms of optical properties and was therefore employed for testing.

TABLE 5

| | #1 | #2 | #3 | #4 | #5 | #6 | #7 | #8 |
|---|---|---|---|---|---|---|---|---|
| Layer | Cycle | Cycle | Cycle | Cycle | Cycle | Cycle | Cycle | Cycle |
| 7. SiO₂ | 462 | 463 | 472 | 474 | 468 | 438 | 430 | 438 |
| 6. Nanolaminate | 601 | 618 | 646 | 618 | 618 | 618 | 604 | 618 |
| 5. SiO₂ | 50 | 56 | 36 | 56 | 56 | 56 | 52 | 56 |
| 4. Nanolaminate | 571 | 612 | 654 | 612 | 612 | 612 | 597 | 612 |
| 3. SiO₂ | 205 | 214 | 197 | 214 | 214 | 214 | 204 | 214 |
| 2. Nanolaminate | 153 | 179 | 180 | 179 | 179 | 179 | 171 | 179 |
| 1. SiO₂ | 121 | 121 | 121 | 121 | 121 | 121 | 121 | 121 |
| Total Thickness (nm) | 284.2 | 296.3 | 298.5 | 311.5 | 316.4 | 316.1 | 302.1 | 286.6 |

FIG. 12 shows single side reflectance for ALD coating #6 from Table 5, and a PVD AR coating that targeted the structure of Table 2. The “ALD AR Design” is the modeled reflectance of the target coating configuration (i.e., Table 1) (modeling was performed using commercially available Essential Macleod software known in the art). Unless otherwise specified herein, ALD condition #6 in Table 5 was employed to coat various types of substrates described below, such as the half quartz rod, hemisphere, and flat substrate.

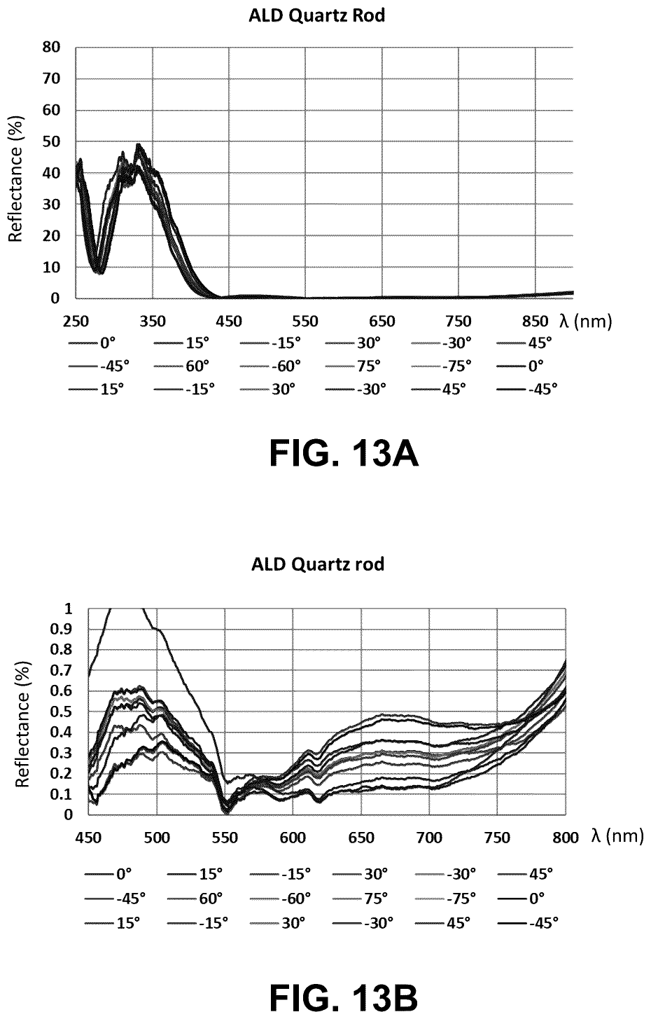

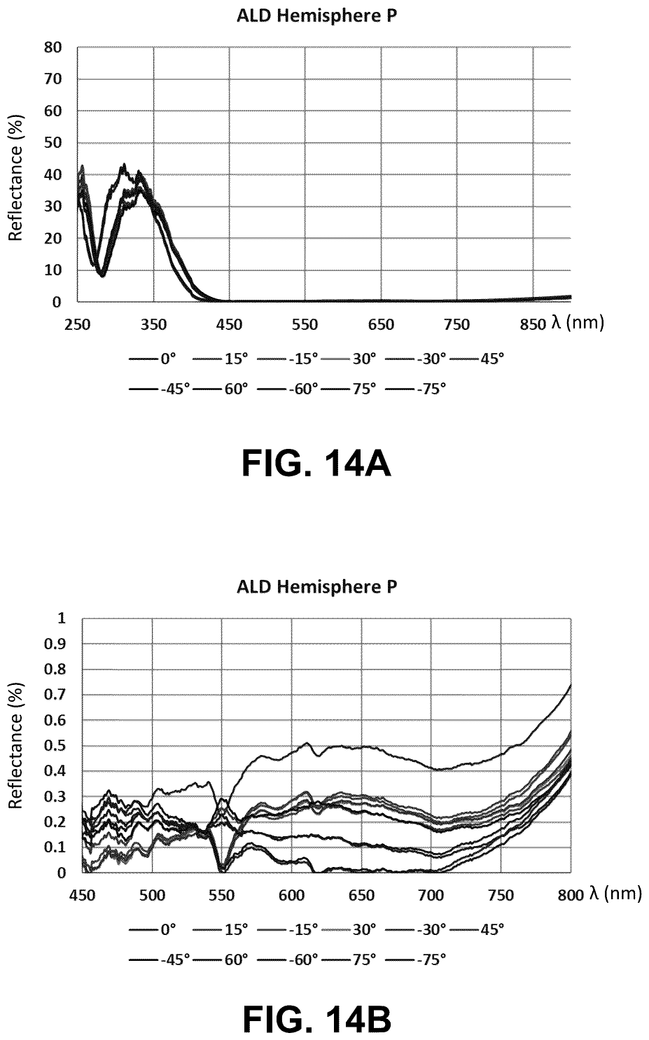

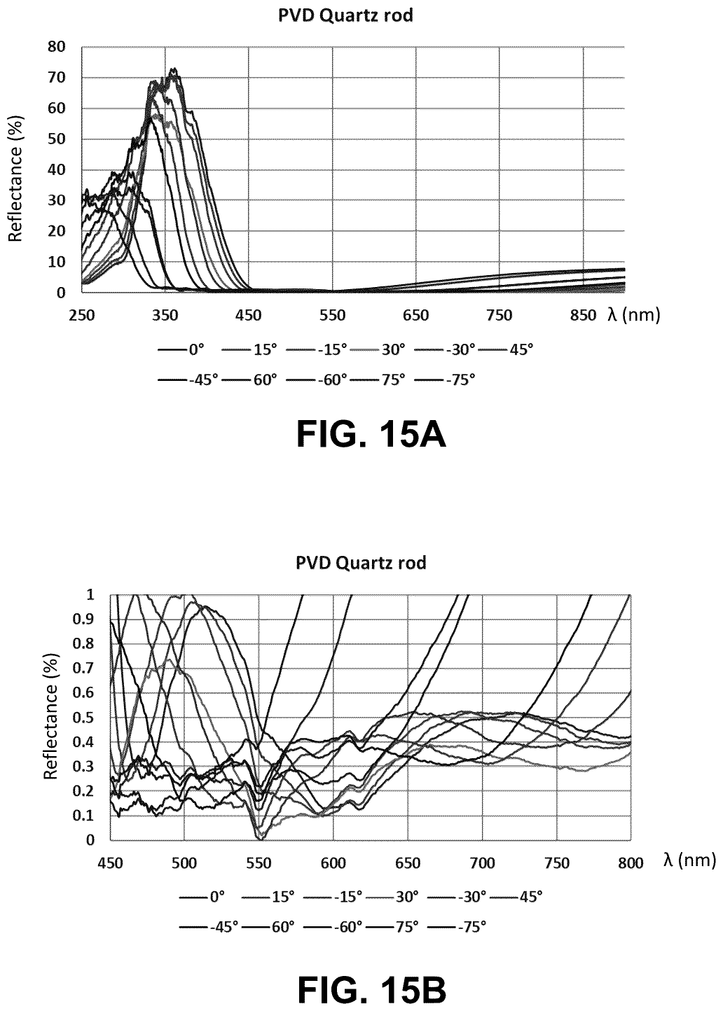

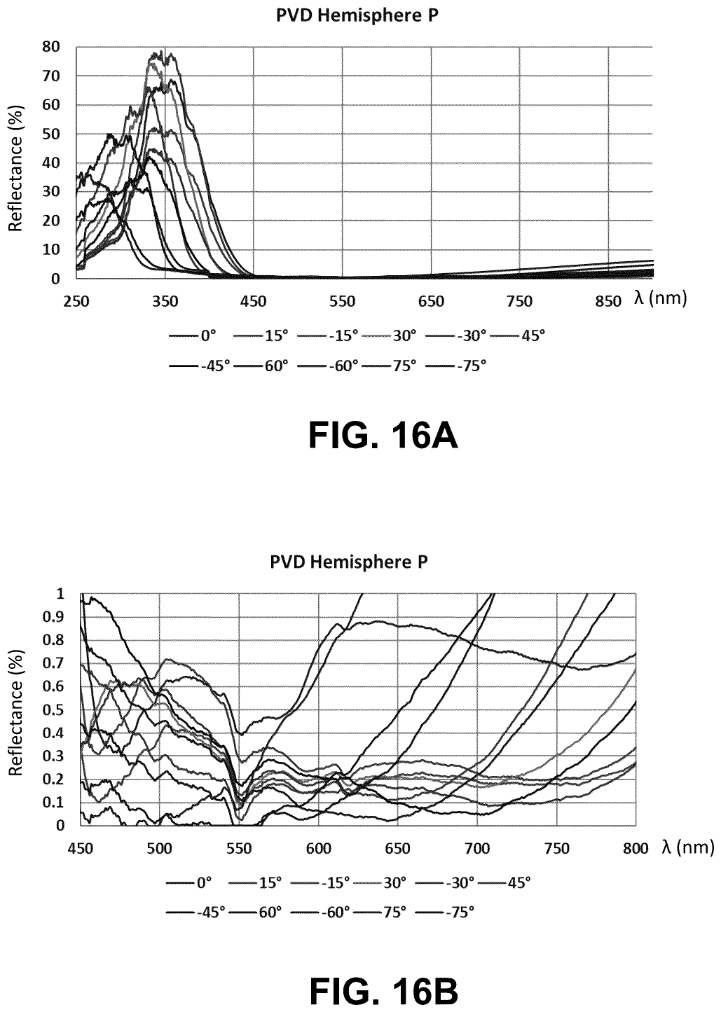

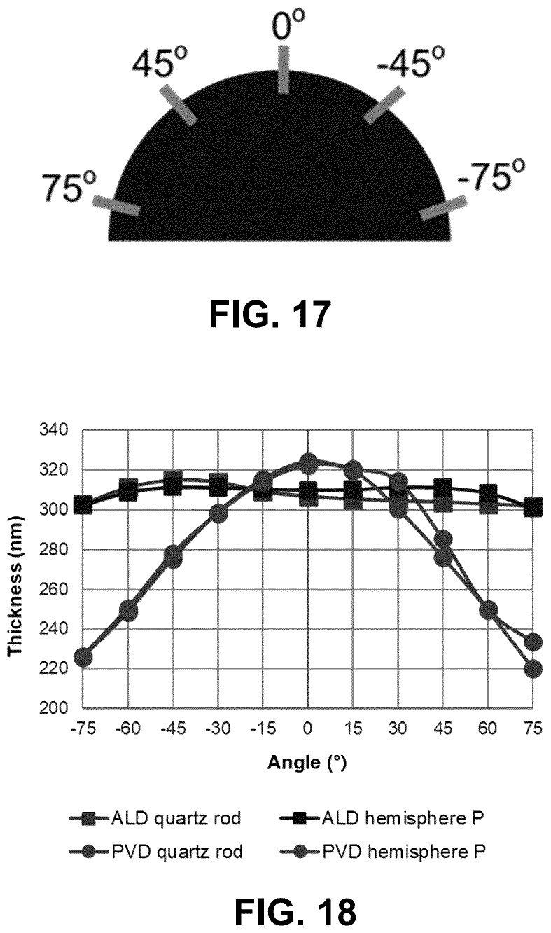

For the half quartz rod and hemisphere (10 mm diameters) coated using ALD and PVD, a micro-spot reflectometer was used to measure single side light reflectance with an incident angle of 5 degrees relative to the axes normal (e.g., first and second axes as defined herein) to the underlying substrate at each measurement location, with the results shown in FIGS. 13-16. Note that the “P” in “hemisphere P” in the figures means the substrate is oriented parallel to the flow of precursor. Single side reflectance was measured at various angles (between from −75 degrees to +75 degrees) on such curved substrates, as depicted schematically in FIG. 17 (note that these angles are an example of the angle between axes, such as between the first and second axes, described elsewhere herein, in which the first axis is at 0 degrees). In particular, FIGS. 13-16 are reflectance measurements at angles between from −75 degrees to +75 degrees (i.e., angles between the first and second axes) for a coated article comprising an optical coating disposed on an underlying quartz rod (FIGS. 13 and 15) or hemisphere (FIGS. 14 and 16), in which the coating method was ALD (FIGS. 13-14) or PVD (FIGS. 15-16). Each of FIGS. 13B, 14B, 15B, and 16B focuses in on the reflectance region of 0-1% and the wavelength region of 450-800 nm of FIGS. 13A, 14A, 15A, and 16A, respectively, to show how the reflectance varies depending on angle of measurement.

Comparing reflectance measurements for the coated articles produced by ALD shown in FIGS. 13A and 14A, with the reflectance measurements for the coated articles produced by PVD shown in FIGS. 15A and 16A, the ALD-produced articles have much more uniform reflectances at all measurement angles (i.e., at angles between the first and second axes, or any other two axes), especially at wavelengths around 650 nm and greater and below about 450 nm. Focusing in on the reflectance regions of 0-1% and the wavelength regions of 450-800 nm as shown in FIGS. 13B, 14B, 15B, and 16B, it is clear that there is much more uniformity of reflectance values for the ALD-produced articles compared to the PVD articles at the various measurement angles. These non-uniform reflectances at various measurement angles for the PVD-produced coated articles is most likely due to physical thickness non-uniformities of the PVD coating method, which has line-of-sight deposition. In contrast, the coated articles with uniform physical thicknesses as produced by ALD have more much uniform reflectances across various angles of measurement. Importantly, the ALD-produced coated articles of have first and second single side light reflectances that are less than 1% at all wavelengths between 500 nm and 800 nm when the angle between the first and second axes is between −75 degrees to +75 degrees.

To provide more detail for FIG. 13B: the line at about 500 nm having the highest reflectance is measured at 75 degrees; at 640 nm, the reflectances from highest to lowest for the following angles are: −30, −45, 0, −60, 30, 45, 15, 60, −75 (note not all angles are necessarily reported in this paragraph given overlap in the figure).

To provide more detail for FIG. 14B: at 640 nm, the reflectances from highest to lowest for the following angles are: 0, 15, −15, −30, 30, −45, 45, 60, −60, −75, 75 (note not all angles are necessarily reported in this paragraph given overlap in the figure).

To provide more detail for FIG. 15B: to identify at least some of the lines in the graph, for a reflectance of 0.6% at wavelengths greater than 550 nm (i.e., to the right in the graph) the lines are for the following angles for increasing wavelengths: −75, 75, −60, 60, −45, 45, −30. At 800 nm for reflectances of 0.5% or less, the lines from highest to lowest reflectance are 0, 15, −15, 30.

To provide more detail for FIG. 16B: to identify at least some of the lines in the graph, for a reflectance of 0.5% at wavelengths greater than 550 nm (i.e., to the right in the graph) the lines are for the following angles for increasing wavelengths: 0, 75, −75, 60, 45, −60, 30, −45. At 775 nm for reflectances of 0.3% or less, the lines from highest to lowest reflectance are 15, −15, −30.

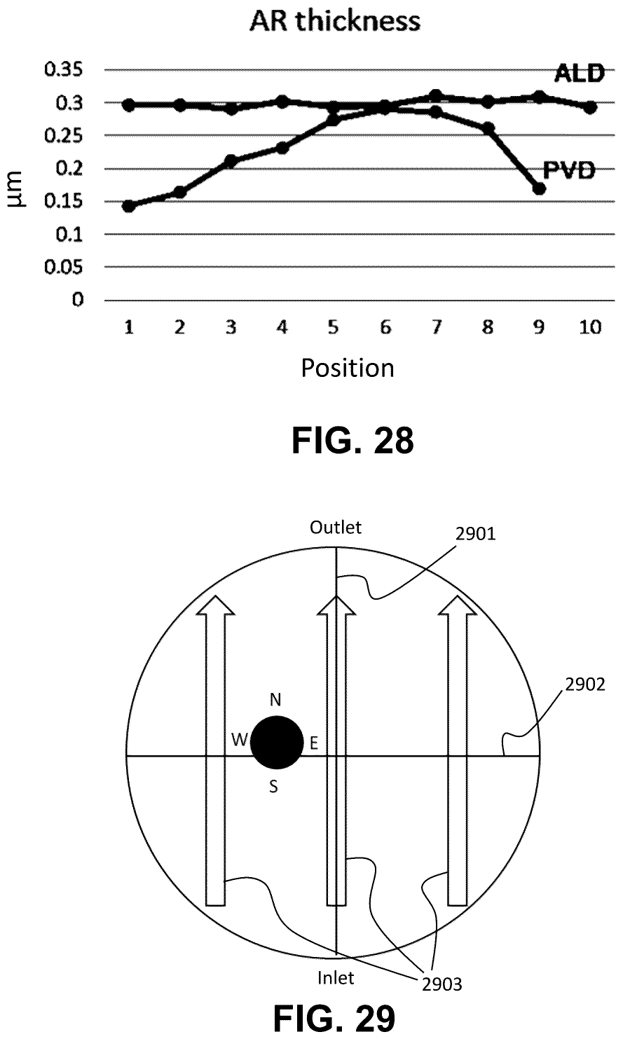

Using commercially available Essential Macleod software known in the art, physical thickness was calculated using the peak positions and slopes of the reflectance measurements of FIGS. 13-16 in the 230-400 nm wavelength range. The results are shown in FIG. 18. These physical thickness values were then used to calculate the physical thickness uniformity among angles from 0-45 degrees, 0-60 degrees, and 0-75 degrees, with the results set forth in Table 6A. Table 6B and FIG. 28 show physical thickness distribution on the round surface of a half quartz rod substrate as measured from cross-sectional analysis of SEM images. Table 6C shows physical thickness uniformity for ALD coatings and PVD coatings at angles of 20, 40, 60, and 80 degree angles between first and second axes for the SEM physical thickness distribution of Table 6B.

TABLE 6A
Physical Thickness Uniformity

| | | 0-45° | 0-60° | 0-75° |
|---|---|---|---|---|
| ALD | Quartz Rod | 1.64% | 1.79% | 1.93% |
| | Hemisphere | 0.23% | 0.47% | 1.71% |
| PVD | Quartz Rod | 8.16% | 13.2% | 17.9% |
| | Hemisphere | 7.71% | 12.7% | 18.9% |

TABLE 6B
Physical Thickness Distribution by SEM

| Position | 1 | 2 | 3 | 4 | 5 | 6 | 7 | 8 | 9 | 10 |
|---|---|---|---|---|---|---|---|---|---|---|
| ALD | 0.297 | 0.297 | 0.291 | 0.303 | 0.293 | 0.295 | 0.310 | 0.301 | 0.309 | 0.293 |
| PVD | 0.143 | 0.163 | 0.211 | 0.232 | 0.274 | 0.291 | 0.285 | 0.261 | 0.170S | |

TABLE 6C
Physical Thickness Uniformity

| | 20° | 40° | 60° | 80° |
|---|---|---|---|---|
| ALD | 2.83% | 2.83% | 3.23% | 3.23% |
| PVD | 2.99% | 11.3% | 28.0% | 34.2% |

As shown in FIG. 18 and Tables 6A-6C, the uniformity of anti-reflective (AR) coating using ALD was much better than that of the AR coating using PVD. The ALD results showed good physical thickness uniformities for the half quartz rod and hemispheres of 1.93% and 1.71%, respectively, for all angle ranges from 0-75° (Table 6A). Conversely, the PVD results showed poor physical thickness uniformities even among the 0-45° and 0-60° ranges, but especially at the angle range of 0-75° with 17.9% and 18.9% physical thickness uniformities for the quartz rod and hemisphere, respectively (Table 6A calculated using reflectance data). Similar results are shown for physical thickness uniformity measurements at the specific angles shown in Table 6C by SEM measurement. Without wishing to be bound by theory, it is believed that these results may be related to the deposition characteristics of ALD and PVD. PVD coating shows excellent uniformity and deposition rate on a flat surface, but because of low step coverage poor uniformity results on curved surfaces or 3D structures. In contrast, ALD coats uniformly without any line-of-sight effects.

Surface roughness of the ALD and PVD coated articles (flat substrate) was measured by atomic force microscopy (AFM) and the Ra and Rq values in nm calculated using the standard AFM instrument software. The results are shown in Table 7, which shows that AR coatings from both ALD and PVD have relatively smooth surface roughness values. Three measurements were performed for each sample on a 2×2 μm square area of the surface.

TABLE 7

| | |
|---|---|
| ALD | PVD |

| | Ra (nm) | Rq (nm) | Ra (nm) | Rq (nm) |
|---|---|---|---|---|
| #1 | 1.81 | 2.28 | 1.38 | 1.73 |
| #2 | 1.76 | 2.23 | 1.33 | 1.68 |
| #3 | 1.78 | 2.23 | 1.41 | 1.78 |
| Average | 1.78 | 2.24 | 1.37 | 1.73 |
| Std Dev | 0.025 | 0.028 | 0.040 | 0.050 |

After an ETC coating was applied to the coated articles via a spray coater, other mechanical properties were measured. Tables 8A and 8B show hardness and modulus of AR films, showing that the hardness of ALD AR films are higher than PVD AR films.

TABLE 8A
Hardness measurements for ALD and PVD coatings

| | Hardness (Gpa) | | | | Modulus |
|---|---|---|---|---|---|
| Sample ID | 100 nm | 500 nm | 500_avg450~550 | Max | Max |
| ALD_1 | 9.3 | 8.4 | 8.4 | 9.5 | 84.4 |
| ALD_2 | 9.5 | 8.4 | 8.5 | 9.8 | 86.2 |
| ALD_3 | 9.3 | 8.6 | 8.5 | 9.6 | 86.7 |
| ALD_4 | 9.2 | 8.5 | 8.5 | 9.5 | 85.7 |
| Inline PVD_1 | 5.9 | 7.4 | 7.4 | 7.8 | 75.4 |
| Inline PVD_2 | 5.9 | 7.4 | 7.4 | 7.9 | 76.0 |
| Inline PVD_3 | 6.0 | 7.5 | 7.5 | 7.9 | 76.1 |
| Inline PVD_4 | 6.2 | 7.5 | 7.5 | 8.0 | 75.6 |

TABLE 8B
Hardness measurements for PVD coatings

| Depth (nm) | Hardness Measurement #1 | Hardness Measurement #2 |
|---|---|---|
| 247 | 6.69 | 6.77 |
| 265 | 6.75 | 6.91 |
| 283 | 6.83 | 7.00 |
| 302 | 6.87 | 7.07 |

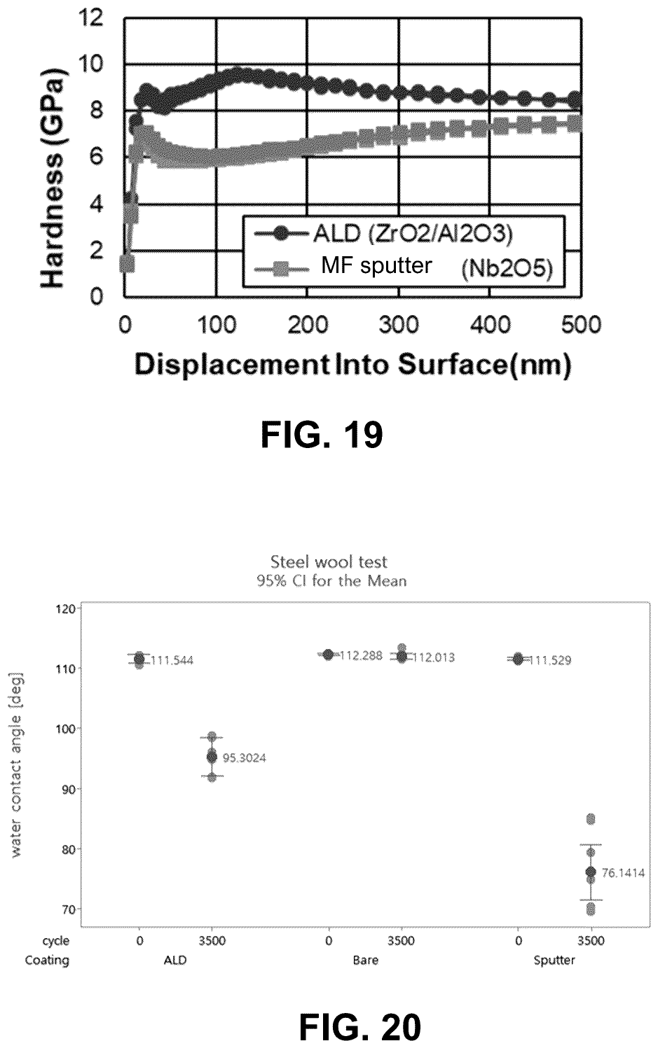

Without wishing to be bound by theory, it is believed this result was due at least in part not only to the differences in the coating methods of each AR film but also the materials of the layer (the ALD coating is that of Table 5, entry #6, and the PVD coating is that of Table 2). The AR film produced using TFS-500 ALD has a layered structure of ZrO₂/+Al₂O₃ nanolaminate and SiO₂ (see Table 1) and the hardness of the ZrO₂/+Al₂O₃ nanolaminate ALD-produced material on its own is ˜12 GPa and the hardness of the SiO₂ ALD-produced material on its own is ˜8.5 GPa. The AR film coated using MF magnetron sputtering PVD has a layered structure of Nb₂O₅ and SiO₂ (see Table 2), and the hardness values of the Nb₂O₅ PVD-produced material on its own is ˜6 Gpa and of the SiO₂ PVD-produced material on its own is ˜5 GPa, which are relatively low compared to ALD. FIG. 19 shows a graph of the hardness vs displacement into surface for the layered structures of Tables 1 and 2, which are referred to in FIG. 19 as “ALD (ZrO₂/Al₂O₃)” and “MF sputter (Nb₂O₅),” respectively (not “MF sputter” refers to MF magnetron sputtering, described elsewhere herein).

Delamination tests were conducted using the following delamination test protocol. A scratch is made on the coated substrate with garnet paper, followed by rubbing the scratched surface with petroleum jelly for 1 min, waiting for 15 min, then rubbing again for 1 min, followed by washing off the petroleum jelly with alcohol. The results indicated that AR films produced by both ALD and PVD did not have delamination.

Abrasion tests using steel wool were performed to evaluate abrasion resistance and reliability on bare glass substrate, the same substrate coated with ALD of Table 1 plus an ETC or anti-fingerprint coating, and the same substrate coated with PVR (sputter, Table 2) plus an ETC or anti-fingerprint coating. The steel wool abrasion test assesses the durability of the ETC or anti-fingerprint coating, with an important parameter in this regard being the water contact angle (WCA), with higher WCA after abrasion meaning that the ETC coating on top of the optical coating has good durability. The abrasion testing employed steel wool. 1000 g load, 15 mm stroke length, 60 cycles/min, and total 3,500 cycles. FIG. 20 shows the comparison results of WCA before rubbing on AR films coated with ETC using steel wool and WCA after rubbing 3500 cycles. Bare glass substrate coupons also having an ETC coating were compared with AR films with ETC coating. Before the test, the WCA was 115.5 to 120.2°. After the abrasion test, ALD AR films had 95.3° WCA, which is higher than AR films coated by PVD.

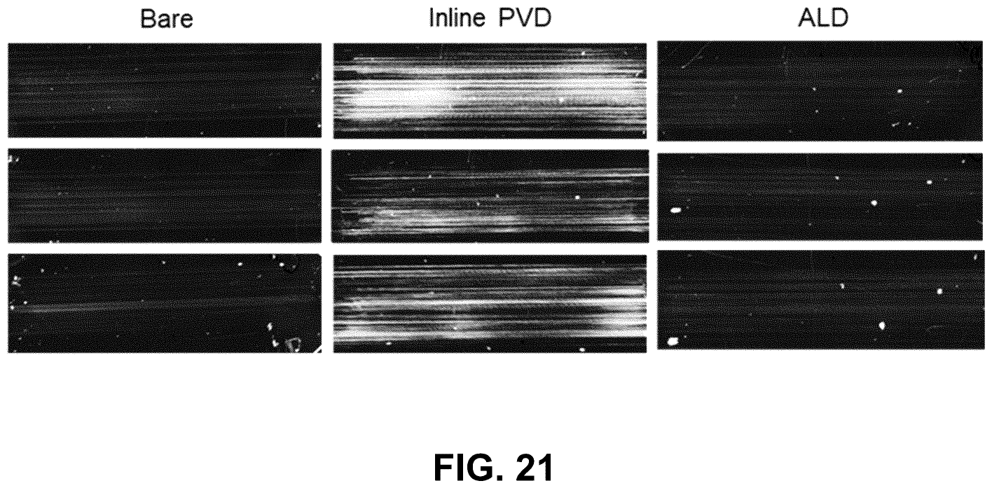

CS-8 abrasion testing was allow performed on bare glass substrate, the same substrate coated with ALD of Table 1, and the same substrate coated with PVR (Table 2). The CS-8 abrasion testing determines durability (scratch resistance) of the optical coating. The CS-8 abrasion testing employed 350 g load, 50 mm stroke length, 60 cycles/min, and total 1,500 cycles. The CS-8 abrasion test results are closely related to steel wool abrasion test results, with the CS-8 results shown in FIG. 21. In the CS-8 abrasion test, the delta specular component excluded (ASCE) for bare substrate averaged 0.100 (over 3 measurements), for inline PVD averaged 0.371 (over 3 measurements), and for ALD averaged 0.059 (over 3 measurements). These CS-8 abrasion results indicate that the AR film is damaged after the CS-8 abrasion test especially for the PVD coating. As with the steel wool abrasion test results, looking at the ASCE values and images from the CS-8 abrasion test results (FIG. 21), it can be confirmed that the AR film coated through ALD has superior properties in abrasion compared to the PVD AR film.

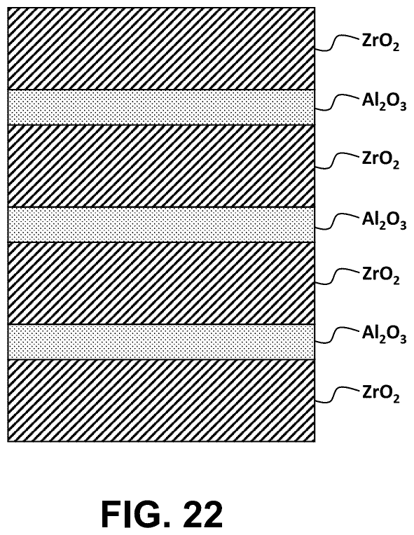

FIG. 22 is a schematic of a layer of an optical coating, in which the layer is a ZrO₂+Al₂O₃ nanolaminate. Thin Al₂O₃ layers are inserted between ZrO₂ layers. Surface roughness of a ZrO₂ layer can be reduced by use of interspersed Al₂O₃ layers, since Al₂O₃ acts as a blocking layer to suppress crystallization and crystal growth of ZrO₂.

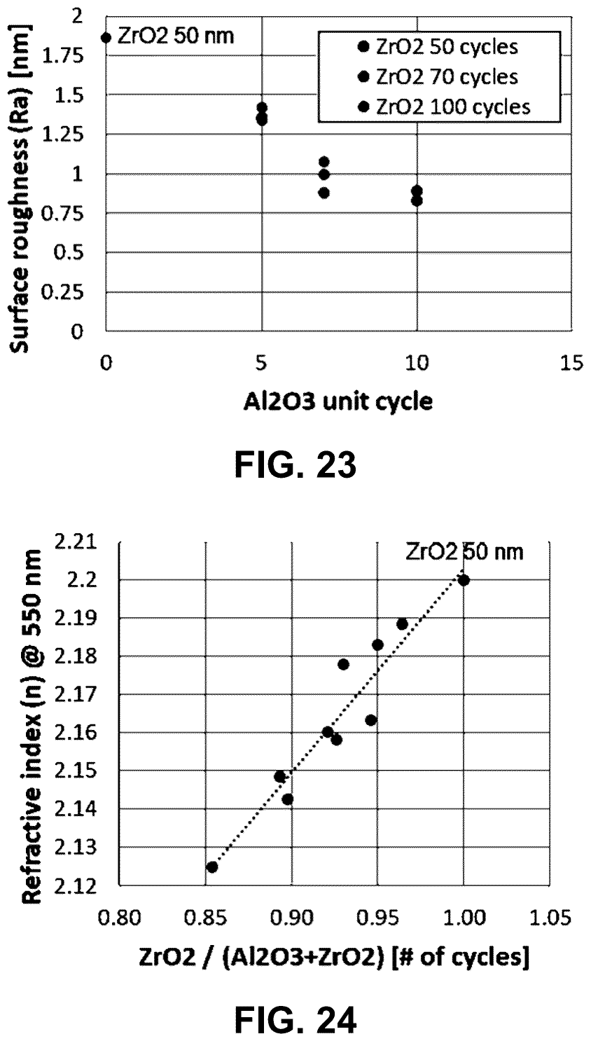

FIG. 23 is a graph depicting surface roughness (Ra) of ZrO₂/Al₂O₃ nanolaminate films with thickness of about 50 nm as a function of Al₂O₃ unit cycle. The unit cycle of ZrO₂ and Al₂O₃ was varied for 50, 70, 100 cycles, and 5, 7, 10 cycles, respectively. Surface roughness (Ra) of the ZrO₂ 50 nm film without any Al₂O₃ was 1.86 nm. By adding in Al₂O₃ interspersed between ZrO₂ layers, the resulting surface roughness of the ZrO₂/Al₂O₃ nanolaminate could be reduced to <0.9 nm with the Al₂O₃ unit cycle being 10 or more.

FIG. 24 is a graph showing refractive index at 550 nm of a ZrO₂/Al₂O₃ nanolaminate as a function of unit cycles of ZrO₂/(Al₂O₃+ZrO₂) (including pure ZrO₂ when ZrO₂/(Al₂O₃+ZrO₂) equals 1.00). The ZrO₂ ratio was calculated with total number of cycles for Al₂O₃ and ZrO₂ in a nanolaminate film. The refractive index of nanolaminate film is linearly decreased as more Al₂O₃ are added, since the refractive index of pure Al₂O₃ is 1.65 and the refractive index of pure ZrO₂ is 2.2.

Shown in Table 9 is a comparison of the certain properties of ZrO₂/Al₂O₃ nanolaminates with different cycles of ZrO₂ and Al₂O₃ as compared to other films, including a film of pure ZrO₂ prepared by ALD and a Nb₂O₅ film prepared by PVD MF magnetron sputtering. All films had a total physical thickness of about 300 nm.

TABLE 9

| | | ZrO₂/Al₂O₃ | ZrO₂/Al₂O₃ | Nb₂O₅ |
|---|---|---|---|---|
| | ZrO₂ | (Cycles: 100/5) | (Cycles: 100/10) | (MF sputter*) |
| n @ 550 nm | ~2.20 | ~2.18-2.19 | ~2.18 | ~2.35 |
| k @ 400 nm | ~1.5-2.0e−3 | ~5.0-7.5e−4 | ~5.0e−4 | ~1.2e−5 |
| Ra (nm) | ~5.6-6.3 | ~2.3-2.4 | ~1.7 | — |
| Hardness | ~11.0-12.5 | ~12.2-13.4 | ~11.6 | ~6.0 |
| @ 100 nm (GPa) | | | | |

n = refractive index
k = extinction coefficient
*MF magnetron sputtering

As shown in Table 9, the surface roughness of the 100/10 nanolaminate was lower than the 100/5 nanolaminate and therefore more desirable for certain applications that benefit from lower surface roughness. The refractive indices of the two nanolaminates were slightly lower than that for the pure ALD ZrO₂ film, but still high enough to be used as a high-index material. Indeed, the refractive indices for the nanolaminates (2.18-2.19) were nearly the same as for pure ZrO₂ (2.20). Surface roughness was much higher than values in FIG. 23 due to thicker film (˜ 300 nm in Table 9 vs. ˜ 50 nm in FIG. 23) for hardness measurements. Hardness of ZrO₂/Al₂O₃ nanolaminate film (˜12.0-13.4 GPa) was higher than that of sputtered Nb₂O₅ (˜6.0 GPa).

In summary, ALD coated articles have excellent physical thickness uniformity when using round and curved substrates, and excellent mechanical and optical properties resulting from such outstanding uniformity. The ZrO₂+Al₂O₃ nanolaminates have high refractive indices and can be paired with low refractive index layers (e.g., SiO₂) to for an optical coating, with the resulting coated articles having excellent physical thickness uniformity, low reflectance, high hardness, and low surface roughness, among various other desirable properties.

Example 2: This example demonstrates the preparation and resulting properties of a coated article in which the coating comprises SiO₂, which generally has excellent physical thickness uniformity and other desirable properties such as high hardness and low reflectance. The substrate was a cylindrical glass substrate having cylinder lengths of 10 or 15 mm and diameters of 12 mm for both cylinders.

Schematics describing supply of gases, precursor, and plasma power for a SiO₂ layer deposition cycle of the ALD process, where the N₂ carrier gas transports the Si precursor into the ALD reactor and the Ar/O₂ plasma gases is for oxidation to form the SiO₂ in this case, is shown in FIG. 11B. In some aspects, N₂ carrier supply may be paused before and/or during each plasma pulse to minimize reactor pressure and/or to avoid deposition of nitrogen atoms, for example, when depositing SiO₂. Low reactor pressure during plasma pulse results in enhanced ion bombardment, which in turn results in denser and harder films.

Si precursors for this example was di-isopropylaminotrisilylamine, but any other Si precursors can additionally or alternatively be used, including BTBAS Bis(tertiary-butylamino)silane, BDEAS (bis(diethylamino)silane), TDMAS (tris(dimethylamino)silane), 1,2-bis(di-iso-propylamino)disilane, 1,2-bis(di-sec-butylamino)disilane, phenylethylaminodisilane, 1-(di-iso-propylamino)-2-(2,6-dimethylpiperidino)disilane, 1,2-bis(2,6-dimethylpiperidino)disilane, 1,2-bis(pyrrolidinodisilane)disilane, or any combination thereof.

CCP (capacitively coupled plasma) source was used for effective densification of film. Plasma gas consisting of Ar and O2 mixture was used to improve ionization density in the O₂ plasma. Ar to O₂ ratio ranged from 0.1:1 to 10:1. The optimized condition was 2:1 (Ar 40 sccm to O₂ 20 sccm) for this example.

ALD cycle time details: Si precursor pulse 0.6 s/purge 3.0 s/waiting time after pausing carrier gas to stabilize reactor pressure 7.0 s/plasma pulse 5.0˜10.0 s/purge+pressure stabilization after turning on carrier gas again 10.0 s. Longer plasma pulse leads to higher film hardness.

Reactor pressure with N₂ carrier gas (Si precursor pulse and purge) is ˜1-1.1 mbar. Pressure without N₂ carrier gas (plasma pulse) reduces to ˜ 0.7-0.8 mbar. The lower pressure during oxygen plasma treatment enhances the packing of film using Ar/O₂ ions. 500 sccm of N₂ was supplied as a carrier gas. Dry pump was used as a vacuum pump. Adding a high-vacuum pump may be helpful to minimize reactor pressure.

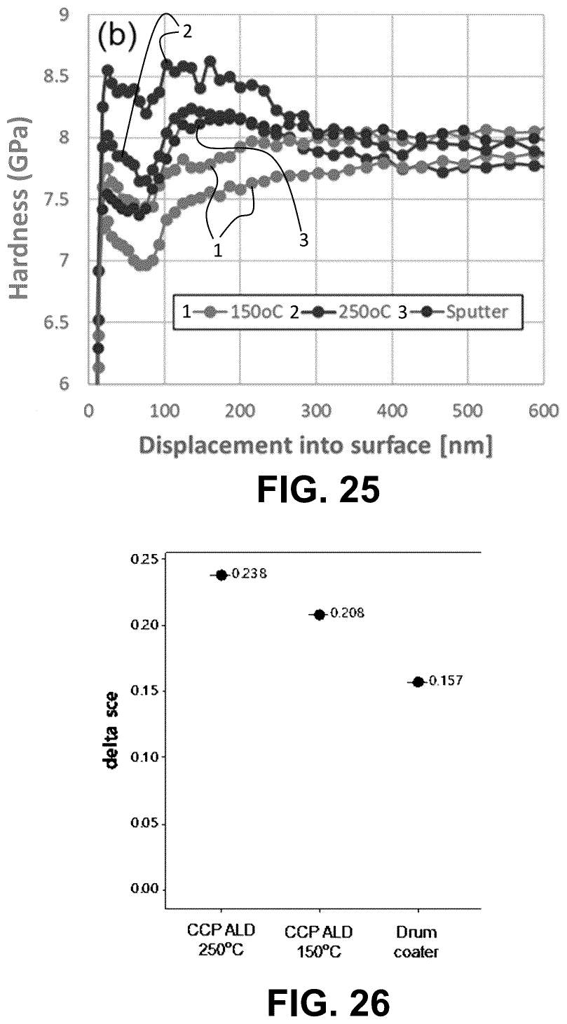

The hardness profile of ALD SiO₂ deposited from the process with purge/pulse cycles as described herein is shown in FIG. 25. ALD SiO₂ showed comparable hardness to sputtered SiO₂ film (˜ 8 GPa at 100 nm depth), but was significantly higher than the typical hardness of ALD SiO₂ film reported in literatures (4˜6 GPa). ALD SiO₂ films prepared using a 250° C. process showed higher hardness than that from 150° C., since film becomes denser under higher process temperature.

The scratch resistance of ALD SiO₂ film and its comparison to sputtered SiO₂ is shown in FIG. 26. The CS-8 abrasion test was employed with the CS8 Jumbo abrasion media, a stroke length of 25 mm, a stroke speed of 60 cycles/min, a load of 350 g, and 1,500 cycles. ASCE (specular component excluded) indicates how it severely damaged by abrasion. ALD SiO₂ film with carrier gas pausing shows comparable scratch resistance to sputtered SiO₂ film.

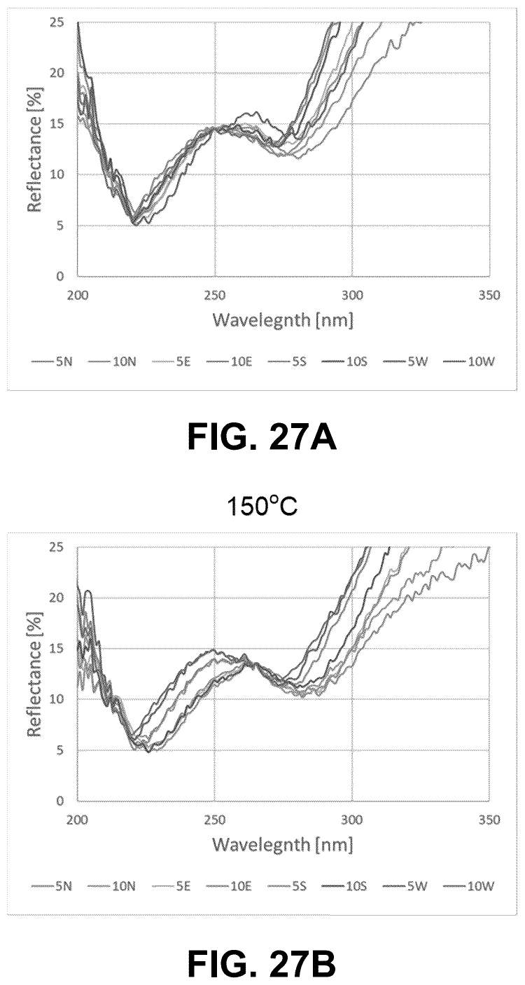

Reflectance curves from ALD SiO₂ film on cylindrical surface are shown in FIGS. 27A-27B. Using the Essential Macleod software, the calculated physical thickness uniformity of the film using the reflectance curve is 2.0-3.0% for both the 150° C. and 250° C. ALD processes. In FIGS. 27A-27B, the labels “5N,” “10N,” “5E,” and so forth can be understood by reference to FIG. 29. FIG. 29 is a schematic representation of a top down view of an ALD chamber. A 3D article (such as a hemisphere, not shown) to be coated by ALD would be placed in the chamber directly in the center at the intersection of lines 2901 and 2902, and gaseous precursors would be flowed through the chamber in the direction of arrows 2903 from the inlet to the outlet. The directions “N,” “S.” “E,” and “W” are shown in FIG. 29 and are aligned relative to the inlet and outlet. The numbers “5” and “10” in FIGS. 27A-27B are measurement heights in millimeters and, paired with the directions “N,” “S,” “E,” and “W.” give a precise location where a reflectance measurement was taken on a coated article. So, for example, “5N” in FIGS. 27A-27B means, by reference to FIG. 29, that a reflectance measurement was taken on the coated article along line 2901, “north” of line 2902, at a height of 5 mm. Similarly, “10E” means that a reflectance measurement was taken on a coated article along line 2902, “cast” of line 2901, at a height of 10 mm. Such concepts can be applied to the other height and direction combinations in the graphs of FIGS. 27A-27B.

Hardness was significantly improved up to ˜ 8.0 GPa by pausing carrier gas (minimize process pressure) during plasma pulsing. The hardness of ALD SiO₂ film from this new process is comparable to that of sputtered SiO₂ film and higher than was predicted based on literature reports. Thickness uniformity of ALD process was achieved (<3.0%).

It will be appreciated that the various disclosed aspects or embodiments may involve particular features, elements or steps that are described in connection with that particular aspect or embodiment. It will also be appreciated that a particular feature, element, or step, although described in relation to one particular aspect or embodiment, may be interchanged or combined with alternate aspects or embodiments in various non-illustrated combinations or permutations.

As used herein, the term “and/or,” when used in a list of two or more items, means that any one of the listed items can be employed by itself, or any combination of two or more of the listed items can be employed. For example, if a composition is described as containing components A. B. and/or C, the composition can contain A alone; B alone; C alone; A and B in combination; A and C in combination; B and C in combination; or A, B, and C in combination.

While various features, elements, or steps of particular aspects or embodiments may be disclosed using the transitional phrase “comprising,” it is to be understood that alternative aspects or embodiments, including those that may be described using the transitional phrases “consisting of” or “consisting essentially of,” are implied. Thus, for example, implied alternative aspects or embodiments to a device that comprises A+B+C include aspects or embodiments where a device consists of A+B+C and aspects or embodiments where a device consists essentially of A+B+C.

References herein to the positions of elements (e.g., “top,” “bottom,” “above,” “below,” “first,” “second,” etc.) are merely used to describe the orientation of various elements in the FIGURES. It should be noted that the orientation of various elements may differ according to other exemplary embodiments, and that such variations are intended to be encompassed by the present disclosure. Moreover, these relational terms are used solely to distinguish one entity or action from another entity or action, without necessarily requiring or implying any actual such relationship or order between such entities or actions.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

As utilized herein, “optional,” “optionally,” or the like are intended to mean that the subsequently described event or circumstance can or cannot occur, and that the description includes instances where the event or circumstance occurs and instances where it does not occur. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Unless otherwise specified, all compositions are expressed in terms of as-batched weight percent (wt. %). As will be understood by those having ordinary skill in the art, various melt constituents (e.g., silicon, alkali- or alkaline-based, boron, etc.) may be subject to different levels of volatilization (e.g., as a function of vapor pressure, melt time and/or melt temperature) during melting of the constituents. As such, the as-batched weight percent values used in relation to such constituents are intended to encompass values within +0.5 wt. % of these constituents in final, as-melted articles. With the forgoing in mind, substantial compositional equivalence between final articles and as-batched compositions is expected.

It will be apparent to those ordinarily skilled in the art that various modifications and variations can be made to the present disclosure without departing from the spirit and scope of the disclosure. Since modifications combinations, sub-combinations, and variations of the disclosed embodiments incorporating the spirit and substance of the disclosure may occur to persons ordinarily skilled in the art, the disclosure should be construed to include everything within the scope of the appended claims and their equivalents.

What is claimed is:

1. A coated article, comprising:
a substrate having a major surface, the major surface comprising a first portion and a second portion, wherein a first axis that is normal to the first portion of the major surface is not equal to a second axis that is normal to the second portion of the major surface, and the angle between the first axis and the second axis is at least 40 degrees; and
an optical coating disposed on at least the first portion and the second portion of the major surface, the optical coating having an inner surface facing the substrate and an outer surface opposite the inner surface;
wherein:
the optical coating at the first and second portions has a physical thickness uniformity of less than 10%, the physical thickness uniformity calculated as [(t_max−t_min)/(t_max+t_min)]×100, wherein t_max is a maximum physical thickness of the optical coating measured at the first and second portions along the first and second axes, respectively, and t_min is a minimum physical thickness of the optical coating measured at the first and second portions along the first and second axes, respectively;
the coated article at the first and second portions has a first single side light reflectance and a second single side light reflectance, respectively, as measured from the outer surface of the optical coating at an incident angle of 5 degrees relative to the first and second axes, respectively, that are less than 1% at all wavelengths between 500 nm and 800 nm; and
the coated article at at least one of the first and second portions has a hardness of at least 7 GPa at indentation depths of 50-250 nm as measured from the outer surface of the optical coating at the first and second portions along the first and second axes, respectively, by a Berkovich Indenter Hardness Test.

2. The coated article of claim 1, wherein the physical thickness uniformity at the first and second portions is less than 5%, and/or the second single side light reflectance are less than 0.5% at all wavelengths between 500 nm and 800 nm.

3. The coated article of claim 1, wherein the coated article has at least one of:
a hardness of at least 9 GPa at an indentation depth of 100 nm as measured from the outer surface of the optical coating at the first and second portions along the first and second axes, respectively, by a Berkovich Indenter Hardness Test;
a hardness of at least 8 GPa at an indentation depth of 500 nm as measured from the outer surface of the optical coating at the first and second portions along the first and second axes, respectively, by a Berkovich Indenter Hardness Test.

4. The coated article of claim 1, comprising at least one of:
the outer surfaces of the optical coating at the first and second axes have an average surface roughness Ra value of less than 3 nm;
the outer surfaces of the optical coating at the first and second axes have an average surface roughness Rq value of less than 3 nm.

5. The coated article of claim 1, wherein the angle between the first axis and the second axis is at least at least 75 degrees.

6. The coated article of claim 1, wherein:
the major surface further comprises a third portion, the optical coating is disposed on the third portion, a third axis that is normal to the third portion of the major surface is not equal to the first or second axes, and the angle between the third axis and the first axis is at least 60 degrees; and
at least one of the following is satisfied:
the optical coating at the first, second, and third portions has a physical thickness uniformity of less than 25%, the physical thickness uniformity calculated as [(t_max−t_min)/(t_max+t_min)]×100, wherein t_max is a maximum physical thickness of the optical coating measured at the first, second, and third portions along the first, second, and third axes, respectively, and t_min is a minimum physical thickness of the optical coating measured at the first, second, and third portions along the first, second, and third axes, respectively;
the coated article at the third portion has a third single side light reflectance as measured from the outer surface of the optical coating at an incident angle of 5 degrees relative to the third axis that is less than 1% at all wavelengths between 500 nm and 800 nm;
the coated article at the third portion has a hardness of at least 7 GPa at indentation depths of 50-250 nm as measured from the outer surface of the optical coating at the third portion along the third axis by a Berkovich Indenter Hardness Test.

7. The coated article of claim 1, wherein the optical coating comprises at least one high refractive index (RI) layer and at least one low RI layer.

8. The coated article of claim 7, wherein:
the at least one high RI layer comprises SiᵤAlᵥOₓN_{y}, Ta₂O₅, Nb₂O₅, AlN, Si₃N₄, AlOₓN_{y}, SiOₓN_{y}, HfO₂, TiO₂, ZrO₂, Y₂O₃, Al₂O₃, MoO₃, diamond-like carbon, or any combination thereof, wherein subscripts “u,” “v,” “x,” and “y” are independently selected from 0 to 1; and
the at least one low RI layer comprises SiO₂, Al₂O₃, GeO₂, SiO, AlOₓN_{y}, SiOₓNᵤ, SiAlₓO_{y}, SiᵤAlᵥOₓN_{y}, MgO, MgAl₂O₄, MgF₂, BaF₂, CaF₂, DyF₃, YbF₃, CeF₃, AlF₃, or any combination thereof, wherein subscripts “u,” “v,” “x,” and “y” are independently selected from 0 to 1.

9. The coated article of claim 7, wherein the at least one high RI layer comprises ZrO₂ and Al₂O₃, and the at least one low RI layer comprises SiO₂.

10. The coated article of claim 7, wherein the at least one high RI layer comprises a nanolaminate comprising ZrO₂ and Al₂O₃, wherein the nanolaminate comprises alternating layers of Al₂O₃ and ZrO₂, and the Al₂O₃ layers in the nanolaminate are thinner than the ZrO₂ layers in the nanolaminate.

11. The coated article of claim 7, wherein the optical coating comprises one or more high RI layers having a physical thickness of 5 nm to 150 nm, and/or one or more low RI layers having a physical thickness of 5 nm to 150 nm.

12. The coated article of claim 7, wherein the optical coating comprises alternating layers of a high refractive index (RI) layer and a low RI layer.

13. The coated article of claim 1, wherein:
the optical coating has a physical thickness of 100 nm to 1000 nm; and/or
the optical coating comprises SiO₂ and the nanolaminate, and a combined physical thickness of SiO₂ is 100 nm to 300 nm, and a total physical thickness of the nanolaminate is 75 nm to 200 nm.

14. A consumer electronic product, comprising:
a housing having a front surface, a back surface and side surfaces;
electrical components provided at least partially within the housing, the electrical components including at least a controller, a memory, and a display, the display being provided at or adjacent the front surface of the housing; and
wherein the front surface, the back surface, the display, or any combination thereof comprises one or more of the coated articles of claim 1.

15. A method of making the coated article of claim 1, the method comprising:
depositing the optical coating on the major surface of the substrate.

16. The method of claim 15, wherein the depositing comprises atomic layer deposition, chemical vapor deposition, or a combination thereof, optionally wherein the depositing is performed at a temperature of 300° C. or less.

17. The method of claim 15, wherein the depositing comprises gaseous precursors comprising diisopropylamino trisilylamine, tetrakis(ethylmethylamido)zirconium(IV), trimethylamine, bis-diethylamino silane, tris(dimethylamino)silane, di-isopropylamino silane, bis(tertiarybutylamino) silane, tetraethyl orthosilicate, tetrakis(ethylmethylamino) zirconium, cyclopentadienyl tris(dimethylamino) zirconium, tri-methyl aluminum, or any combination thereof.

18. The method of claim 15, wherein the depositing comprises alternately depositing at least one high refractive index (RI) layer and at least one low RI layer on the major surface.

19. The method of claim 15, wherein:
the optical coating comprises a nanolaminate comprising ZrO₂ and Al₂O₃;
the nanolaminate comprises alternating layers of Al₂O₃ and ZrO₂, wherein the Al₂O₃ layers in the nanolaminate are thinner than the ZrO₂ layers in the nanolaminate.

20. The method of claim 19, wherein each Al₂O₃ layer in the nanolaminate is 0.11-5 nm thick.
